(19) United States
(12) Patent Application Publication
(10) Pub. No.: US 2026/0340625 A1
(43) Pub. Date: Oct. 29, 2026

(54) CUSTOMIZABLE CRYPTOCURRENCY TRADING

(71) Applicants: Bprotocol Foundation, Zug (CH); Localcoin Ltd., Tel-Aviv (IL)

(72) Inventors: Mark Bentley RICHARDSON, Malvern East, Victoria (AU); Stefan LOESCH, London (GB); Barak MANOS, Kibbutz Yifat (IL); Asaf SHACHAF, Herzliya (IL)

(73) Assignees: Bprotocol Foundation, Zug (CH); Localcoin Ltd., Tel-Aviv (IL)

(21) Appl. No.: 19/121,486

(22) PCT Filed: Oct. 16, 2023
(86) PCT No.: PCT/IL2023/051079

§ 371 Date: Apr. 16, 2025

Related U.S. Application Data
(60) Provisional application No. 63/417,723, filed on Oct. 20, 2022.

(51) Int. Cl. G06Q 20/38; G06Q 20/06

(52) U.S. Cl. CPC G06Q 20/381; G06Q 20/065; G06Q 2220/00

(57) ABSTRACT

A computing device for exchanging tokens by a distributed smart contract executing on a blockchain, comprising: at least one hardware processor of a network connected server executing a code of the distributed smart contract executing on the blockchain, the code for: managing a primary reserve of a plurality of tokens of a primary cryptocurrency, obtaining, from a client terminal in communication with the network connected server, a plurality of values of a plurality of adjustable parameters that define a function for computing an exchange rate for converting between the primary cryptocurrency and a secondary cryptocurrency, and in response to a transaction request for converting between the primary tokens and a secondary token of a secondary cryptocurrency, executing the transaction request using a bonding curve defined by the function with the plurality of values of the plurality of adjustable parameters.

### RELATED APPLICATION

This application claims the benefit of priority of U.S. Provisional Patent Application No. 63/417,723 filed on Oct. 20, 2022, the contents of which are incorporated herein by reference in their entirety.

### BACKGROUND

The present invention, in some embodiments thereof, relates to distributed applications for management of cryptocurrencies and, more specifically, but not exclusively, to systems and methods for distributed applications for customizable cryptocurrency trading.

Advances in blockchain technology provide distributed (i.e., non-centralized approaches) to enable almost any entity to create their own custom cryptocurrencies and/or create their own smart contract that provides cryptocurrency exchange services. Some smart contracts executing on the blockchain are designed to enable users to convert between different types of cryptocurrencies.

### SUMMARY

According to a first aspect, a computing device for exchanging tokens by a distributed smart contract executing on a blockchain, comprises: at least one hardware processor of a network connected server executing a code of the distributed smart contract executing on the blockchain, the code for: managing a primary reserve of a plurality of tokens of a primary cryptocurrency, obtaining, from a client terminal in communication with the network connected server, a plurality of values of a plurality of adjustable parameters that define a function for computing an exchange rate for converting between the primary cryptocurrency and a secondary cryptocurrency, and in response to a transaction request for converting between the primary tokens and a secondary token of a secondary cryptocurrency, executing the transaction request using a bonding curve defined by the function with the plurality of values of the plurality of adjustable parameters.

According to a second aspect, a method of exchanging tokens by a distributed smart contract executing on a blockchain, comprises: managing a primary reserve of a plurality of tokens of a primary cryptocurrency, obtaining, from a client terminal in communication with the network connected server, a plurality of values of a plurality of adjustable parameters that define a function for computing an exchange rate for converting between the primary cryptocurrency and a secondary cryptocurrency, and in response to a transaction request for converting between the primary tokens and a secondary token of a secondary cryptocurrency, executing the transaction request using a bonding curve defined by the function with the plurality of values of the plurality of adjustable parameters.

According to a third aspect, a computing device for exchanging tokens by a distributed smart contract executing on a blockchain, comprises: at least one hardware processor of a network connected server executing a code of the distributed smart contract executing on the blockchain, the code for: managing a primary reserve of a plurality of primary tokens of a primary cryptocurrency and managing a secondary reserve of a plurality of secondary tokens of a secondary cryptocurrency, obtaining a transaction request for converting between the primary token and a secondary token of a secondary cryptocurrency, in response to the transaction request being for converting from the primary token to the secondary token, executing the transaction request using a first bonding curve implicitly defined by a function and a first set of a plurality of values of a plurality of adjustable parameters, and in response to the transaction request being for converting from the secondary token to the primary token, executing the transaction request using a second bonding curve different from the first bonding curve, the second bonding curve implicitly defined by the function and a second set the plurality of values of adjustable parameters that is different from the first set.

In a further implementation form of the first, second, and third aspects, the primary reserve is managed without managing a secondary reserve of secondary tokens of the secondary cryptocurrency.

In a further implementation form of the first, second, and third aspects, the plurality of adjustable parameters are selected for meeting hardware and/or software resource requirements for execution of code of the distributed smart contract.

In a further implementation form of the first, second, and third aspects, further comprising code for dynamically monitoring the execution of the code of the distributed smart contract, and dynamically adapting the plurality of adjustable parameters for meeting the hardware and/or software resource requirements.

In a further implementation form of the first, second, and third aspects, the resource requirements are selected from a group comprising: calculation accuracy in the absence of floating-point arithmetic, overflow, underflow, unsigned integers, computational complexity, storage requirements, and memory requirements.

In a further implementation form of the first, second, and third aspects, the plurality of values of the adjustable parameters are obtained from a user via a user interface running on the client terminal in communication with the network connected server.

In a further implementation form of the first, second, and third aspects, one of the x-axis and the y-axis represents a balances of the primary reserve, and the other axis is non-defined, and the function represents all possible exchange rates for converting between the primary token and the second token.

In a further implementation form of the first, second, and third aspects, the transaction request for exchange using the function with applied parameters is executed on blockchain using fundamental math operations selected from: addition, subtraction, multiplication, and division, and excludes all of: Taylor series, polynomial approximation, and numeric methods of producing a function output.

In a further implementation form of the first, second, and third aspects, at least two of the plurality of adjustable parameters are computed off-blockchain.

In a further implementation form of the first, second, and third aspects, the bonding curve comprises a first bonding curve and further comprising a second bonding curve defined by the function, the first bonding curve defined by a first set of values of the adjustable parameters, the second bonding curve defined by a second set of values of the adjustable parameters, the first bonding curve for converting from the primary cryptocurrency to the secondary cryptocurrency, and the second bonding curve for converting from the secondary cryptocurrency to the primary cryptocurrency, wherein the first bonding curve and the second bonding curve have common adjustable parameters with different values.

In a further implementation form of the first, second, and third aspects, a first exchange rate for converting from the primary cryptocurrency to the secondary cryptocurrency is computed according to the first bonding curve, a second exchange rate for converting from the secondary cryptocurrency to the primary cryptocurrency is computed according to the second bonding curve, wherein the first bonding curve is different than the second bonding curve and the first exchange rate is different than the second exchange rate.

In a further implementation form of the first, second, and third aspects, the transaction comprises receiving secondary tokens, and automatically adding the secondary tokens to a secondary reserve according to the second bonding curve, and automatically withdrawing primary tokens from the primary reserve according to the first bonding curve.

In a further implementation form of the first, second, and third aspects, a transaction performed using the first bonding curve deterministically affects another transaction performed using the second bonding curve.

In a further implementation form of the first, second, and third aspects, further comprising obtaining a strategy from the client terminal, the strategy defining the values of the parameters for the first bonding curve and the second bonding curve.

In a further implementation form of the first, second, and third aspects, the plurality of adjustable parameters include a base set of adjustable parameters, selected from the group comprising:
n,
Pₐ denoting a start value of a range of exchange rates for converting from the primary cryptocurrency to the secondary cryptocurrency,
P_{b} denoting an end value of a range of exchange rates for converting from the primary cryptocurrency to the secondary cryptocurrency,
P denoting a gradient at x=x₀, y=y₀ indicating a geometric mean price,
Q,
R,
S denoting a difference of square roots of the gradients of the intercepts,
yᵢₙₜ denoting a balance of the primary tokens where the marginal exchange rate is equal to Pₐ,
xᵢₙₜ denoting, when the range commences with y=yᵢₙₜ, a balance of secondary tokens that is obtainable if the balance of the primary tokens is driven to zero
x₀ denoting an x-coordinate at the geometric mean price,
y₀ denoting a y-coordinate at the geometric mean price,
x_{asym} denoting an x-asymptote or vertical asymptote,
y_{asym} denoting a y-asymptote or horizontal asymptote, and
geometric and/or algebraic reconstruction of the aforementioned.

In a further implementation form of the first, second, and third aspects, different values are assigned to a same set of the base parameters for different bonding curves implicitly defined by the function.

In a further implementation form of the first, second, and third aspects, a single distributed smart contract executing on the blockchain implements a different set of values for the adjustable parameters for a different instance of the function, and the single distributed contract implements each respective reserve of a certain token and a corresponding bonding curve defined by the function with the different set of values for the adjustable parameter defines a primitive for unidirectional exchange between an external token and the certain token of the respective reserve, wherein multiple primitives are linked to one another for defining unidirectional routes for token exchanges.

In a further implementation form of the first, second, and third aspects, the function is defined with reference to a hyperbola with asymptotes at x=0 and y=0 represented as xy=k where x denotes the primary token and y denotes the secondary token.

In a further implementation form of the first, second, and third aspects, the function includes at least one adjustable asymptote, and a graph of the function shares at least one common point with a constant product bonding curve denoted as xy=k.

In a further implementation form of the first, second, and third aspects, a slope of each at least one bonding curve at the at least one common point is identical with a first derivative of xy=k, wherein each at least one bonding curve is defined to have a point on its implicit curve at coordinates x=x₀ and y=y₀ where a first derivative is equal to that of the constant product bonding curve at the same coordinates.

In a further implementation form of the first, second, and third aspects, the bonding curve is defined as the implicit curve of the invariant function, which is used to enumerate a continuum of exchange rates between a primary cryptocurrency and a secondary cryptocurrency.

In a further implementation form of the first, second, and third aspects, each exchange rate of a plurality of exchange rates for converting between the primary cryptocurrency and the secondary cryptocurrency is represented as a secant line between two points of the function, wherein a first point represents the balance of the primary reserve before the exchange occurred, and a second point represents the balance of the primary reserve after the exchange occurred.

In a further implementation form of the first, second, and third aspects, each parameter is assigned to a set of a plurality of sets, each parameter of each set is mathematically related to other parameters within the set and each parameter is mathematically related between sets of other parameters, sufficient to unambiguously describe a unique invariant function-implicit curve pair.

In a further implementation form of the first, second, and third aspects, a marginal exchange rate for converting between the primary cryptocurrency and the secondary cryptocurrency is computed according to a first derivative of the bonding curve implicitly defined by the function with applied adjustable parameters.

In a further implementation form of the third aspect, the primary reserve and the secondary reserve are linked, wherein when the transaction request includes an amount of secondary tokens, an amount of primary tokens are obtained from the primary reserve according to the first bonding curves, and the secondary tokens are deposited into the secondary reserve according to the second bonding curve.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1a-c are schematics depicting the invariant function characterized as having a point on its implicit curve with coordinates x=x₀, y=y₀, which coincide with the graph of eqns. 1a-c, in accordance with some embodiments of the present invention;

FIGS. 2a-c are schematics where the negated slope of the tangent line (−dy/dx) at this point is P and is equal in both implicit curves of the customizable function and eqns. 1d-e, in accordance with some embodiments of the present invention;

FIGS. 3a-g are schematics where the parameter k is the hyperbola constant of eqns. 1a-c, (i.e. xy=k), and denotes the magnitude of the constant product's implicit curve with which the implicit curve of the novel invariant function shares the coordinates x=x₀, y=y₀, in accordance with some embodiments of the present invention;

FIGS. 4a-1 are schematics where the parameters x_{asym} and y_{asym} denote the “vertical” and “horizontal” asymptotes, respectively, of the novel function's implicit curve, in accordance with some embodiments of the present invention;

FIGS. 5a-g are schematics where the parameters xᵢₙₜ and yᵢₙₜ denote the x- and y-intercepts the novel function's implicit curve, in accordance with some embodiments of the present invention;

FIGS. 6a-f are schematics where the slope of the tangent lines at the y- and x-intercepts of the novel implicit curve, y=yᵢₙₜ and x=xᵢₙₜ, respectively, are denoted by the parameters Pₐ and P_{b}, respectively, in accordance with some embodiments of the present invention;

FIGS. 7a-b are schematics depicting exemplary methods of discovery of the parameters n, u that denote the relative size of two rectangles, in accordance with some embodiments of the present invention;

FIGS. 7c-d are schematics depicting an exemplary method for discovering the parameter Q, which denotes the relative size of two rectangles, in accordance with some embodiments of the present invention;

FIGS. 8a-c are schematics in which eqn. 22 substitutes n for f(x), in accordance with some embodiments of the present invention;

FIGS. 9a-c are schematics in which eqns. 23a-c substitute n for f(a, x, x₀, y, y₀), in accordance with some embodiments of the present invention;

FIG. 10 is a schematic depicting a state before any exchanges are performed, of Alice's pristine strategy, in accordance with some embodiments of the present invention;

FIG. 11 is a schematic depicting the difference in the relative changes to either half of Alice's strategy, in accordance with some embodiments of the present invention;

FIG. 12 is a schematic depicting the difference in the relative changes to either half of Alice's strategy, in accordance with some embodiments of the present invention;

FIG. 13a is a schematic depicting accumulation of additional USD_{TKN} at the current price point that fills its cognate bonding curve from the bottom-up, slowly moving the reaccumulation target back towards the upper boundary, in accordance with some embodiments of the present invention;

FIG. 13b includes graphs indicating the first case where Alice's balance of USD_{TKN} exceeds the yᵢₙₜ on its own curve, in accordance with some embodiments of the present invention;

FIG. 14, which is a diagram of components of a system for performing transactions of cryptocurrencies using one or more bonding curves with values for adjustable parameters of a function, in accordance with some embodiments of the present invention;

FIG. 15, which is a flowchart of a method for performing transactions of cryptocurrencies using one or more bonding curves with values for adjustable parameters of a function, in accordance with some embodiments of the present invention

FIG. 16, which is a sequence diagram for creation of a strategy of two or more bonding curves for converting cryptocurrencies, in accordance with some embodiments of the present invention;

FIG. 17 is a sequence diagram for depositing funds using the strategy, in accordance with some embodiments of the present invention;

FIG. 18 is a sequence diagram for withdrawing funds using the strategy, in accordance with some embodiments of the present invention; and

FIG. 19 is a sequence diagram for trading using the strategy, in accordance with some embodiments of the present invention.

### DETAILED DESCRIPTION

The present invention, in some embodiments thereof, relates to distributed applications for management of cryptocurrencies and, more specifically, but not exclusively, to systems and methods for distributed applications for customizable cryptocurrency trading.

As used herein, the terms bonding curve, function, invariant function, novel invariant function, customizable function, and customizable invariant function, and the like, are used interchangeably. The bonding curve may refer to the function with values for the adjustable parameters, as described herein. For example, a first bonding curve and a second bonding curve may refer to the same function with same adjustable parameters, having different sets of values assigned to the adjustable parameters. The first bonding curve may be defined by a first set of values assigned to the adjustable parameters of the function. The second bonding curve may be defined by a second set of values assigned to the adjustable parameters of the function.

The terms primary token and secondary token are sometimes used interchangeably. The terms primary and secondary token may be used arbitrarily, as any one of two tokens and/or reserves and/or pool tokens may be referred to as primary, with the other referred to as secondary. The terms primary and secondary are used for convention and clarity of explanation. In most cases, the terms primary and secondary refer to tokens of which the smart contract is unable to mint and/or burn, since both tokens are controlled by another external unrelated smart contract, for example, cryptocurrencies that are bought and sold on the open market, for example, bitcoin, ethereum, and the like.

As used herein, the term cryptocurrency and token are interchangeable. A token may be created for different purposes and/or uses, for example, representing money, club member points, frequent flyer points, reward points, as part of a game, and the like. Tokens may be customized cryptocurrencies issued and based upon another cryptocurrency such as provided by the Ethereum Network, Lisk, RootStock, and other Networks.

An aspect of some embodiments of the present invention relates to systems, methods, computing devices, and/or code instructions (stored on a data storage device and executable by one or more processors) for exchanging tokens by a distributed smart contract executing on a blockchain using a bonding curve, optionally an asymmetrical curve, with selectable and/or adaptable values of adjustable parameters. A processor manages a primary reserve of tokens of a primary cryptocurrency. Values of the adjustable parameters that define a function for computing an exchange rate for converting between the primary cryptocurrency and a secondary cryptocurrency are obtained, optionally from a client terminal (e.g., used by a user). The values may be customizable, for example, selected and/or adapted by the client terminal. In response to a transaction request for converting between the primary tokens and a secondary token of a secondary cryptocurrency, the processor executes the transaction request using a bonding curve defined by the function with the values of the plurality of adjustable parameters.

The bonding curve may be asymmetrical. The first bonding curve may provide primary tokens in response to receiving secondary tokens, thereby converting from the secondary tokens to the primary tokens. A second bonding curve with different values for the adjustable parameters may be defined for providing secondary tokens in response to receiving primary tokens, thereby converting from the primary tokens to the secondary tokens. Different exchange rates may apply for different directions (i.e. TO, FROM), even for the same amounts being exchanges, according to the first and second bonding curves.

Optionally, multiple reserves of different types of cryptocurrencies are managed. Each reserve may be associated with one or more bonding curves, that define the exchange between another cryptocurrency and the respective cryptocurrency being managed. Each reserve and bonding curve may be considered as a primitive defining a specific exchange in a unilateral direction between two types of cryptocurrencies. The multiple primitives may be used to define a set of customizable unilateral token exchanges. For exchange, to exchange from a token A to a token C, the following may be defined token A→token B→token C, i.e., no direct exchange from token A to token C exists. To exchange token A to token C, token A must first be exchanged for token B, and then token B is exchanged for token C. In another example, a single primitive may be used on its own, for example, to define a specific directional conversion from one type of cryptocurrency to another type of cryptocurrency, such as token A→B. When the single primitive is used on its own, no trade can be done from token B to token A.

At least some implementations of the systems, methods, apparatus, and/or code instructions described herein address technical problems related to smart contracts managing cryptocurrencies executing on a blockchain, and/or improve the technology of smart contracts managing cryptocurrencies executing on a blockchain, and/or improve on prior approaches of smart contracts managing cryptocurrencies executing on a blockchain.

At least some implementations described herein address the technical problem of improving utilization of computational and/or processing resources executing the smart contract managing cryptocurrencies on the blockchain, for example, reducing processor utilization, reducing processing time, reducing the amount of used memory, and/or reducing the amount of storage space. Using standard approaches, in which smart contracts managing cryptocurrencies are bound by fixed rules, does not differentiate between smart contracts that require additional processing and/or computational resources and smart contracts that require fewer processing and/or computational resources. At least some implementations described herein address the aforementioned technical problem by enabling customization of the smart contract according to target processing and/or computational resources. The customization provided by some embodiments enables smart contracts that require additional processing and/or computational resources to obtain the additional resources, while in contrast using standard approaches those smart contracts would not be allocated additional resources and/or would experience increased costs for obtaining the additional resources. The customization provided by some embodiments enables smart contracts that are able to operate with fewer processing and/or computational resources to be allocated less processing resources. This frees up those resources which would have been unnecessarily tied up, for use by other smart contracts.

At least some implementations of the systems, methods, apparatus, and/or code instructions described herein improve computational efficiency of a computing device executing the smart code on the blockchain, by reducing computational resources that would otherwise be required for executing the smart code, for example, reduced processor utilization, reduced processing time, and/or reduced allocated memory. The customizable parameters of the function seed by the smart contract may be selected for using reduced computational resources, for example, in comparison to the resources that would be used by standard smart contracts operating under standard fixed non-customizable rules.

At least some implementations described herein address the technical problem of fixed rules of the smart contract managing cryptocurrencies. Users are bound by the rules defined by the smart contracts. All users are bound by the same rules. The fixed rules apply to all users limit the user experience. At least some implementations described herein address the aforementioned technical problem by enabling customization of the smart contract by each user. Different users may define different customizations for their respective smart contracts. The ability to customize the smart contract provides an enhanced user experience to users of the smart contracts. Different users may define primitives using different values for the adjustable parameters of the function to create different bonding curves, where each bonding curve defines a specific conversion is a specific direction, from a first cryptocurrency to a second cryptocurrency. A set of primitives may be defined to provide conversions amongst different cryptocurrencies, for example, according to the user's selection. The option to define a single primitive on its own, for unidirectional trade and no trade in the other direction, is in contrast to prior approaches that provide symmetrical trading between two cryptocurrencies. The option to link multiple primitives to provide a set of unidirectional trades of cryptocurrencies, each with its own bonding curve, is in contrast to prior approaches that provide symmetrical trading between two cryptocurrencies.

At least some implementations described herein address the technical problem of the same rules applied to the buying and to the selling of cryptocurrencies. Users are bound by the same exchange rates, which are equally applied to the buying and to the selling. At least some implementations described herein address the aforementioned technical problem by enabling different rules for the buying and selling. Users may define a first set of rules for buying, and a second set of rules for selling. The ability to define different rules for the buying and for the selling provides an enhanced user experience to users of the smart contracts.

Examples of prior approaches for smart contracts managing cryptocurrencies executing on a blockchain are described, for example, with reference to U.S. Pat. No. 11,188,896 “SMART CONTRACT OF A BLOCKCHAIN FOR MANAGEMENT OF CRYPTOCURRENCIES” (referred to herein as Patent '896), and/or U.S. Pat. No. 11,574,291 “Methods for Exchanging and Evaluating Virtual Currency”, (referred to herein as Patent '923) filed on Jan. 8, 2018, incorporated herein by reference in their entirety, which includes at least one common inventor as the instant application.

At least some implementations described herein improve the technology of exchange of tokens between different participants within a distributed application environment, such as a blockchain, and/or improve a smart contract implementation thereof.

At least some embodiments described herein improve the technology of Decentralized finance (DeFi) applications, which are a distributed system of applications built on public blockchains that fulfill the need for economic and/or financial primitives for cryptocurrency. Decentralized exchanges (DEXes) are protocols that allow for cryptocurrency tokens to be exchanged between users in a permissionless manner. The prototypical example is a smart contract (“liquidity pool”) that collects crowd-sourced capital from users (“liquidity providers”) and issues a receipt token (“pool token”) in return. The pool token represents the liquidity provider's pro-rata share of the liquidity pool as a whole; therefore, any proportion of the pool token supply is redeemable for the same proportion of the liquidity pool. The composition of the liquidity pool may change over time as users (“traders”) exchange their own tokens for those inside the liquidity pool. DeFi applications use an invariant function DEX, where exchange rates are determined by equations which force the composition of the liquidity pool to adhere to a predefined profile (termed “bonding curve”). Preeminent examples are constant product, and constant sum; however, more elaborate variations of these concepts have appeared which have fine-tuned the behavior of their protocols and cognate liquidity pools. The “value” function, and the “stableswap” function are noteworthy modifications of common archetypes.

At least some embodiments described herein address the technical problem experienced by liquidity providers on DEXes, which are beholden to parameters of the liquidity pool to which they contribute their tokens. Thus, the agency of an individual liquidity provider to decide their own exchange rates and execute precise trading strategies is suppressed in favor of a prescribed, generic interpretation of their intentions. At least some embodiments described herein address the aforementioned technical problem, and/or improve the aforementioned technology, by providing a mechanism of liquidity provision whereby users can exercise their personal trading preferences. This is made possible by a customizable invariant function that encompasses an infinite set of bonding curves, the elements of which may include constant sum and/or constant product models. Each liquidity provider therefore owns their own liquidity pool, for which they may be the only participant. Moreover, each liquidity pool may be governed by a set of bonding curves, instead of just one, which allows for the tokens to be deployed asymmetrically. In contrast to existing approaches where tokens sold by a liquidity pool are assumed to be purchased back by the pool at the same exchange rate, the asymmetry paradigm described herein allows for the sale and repurchase rates, as well as their relative acceleration, to be independent of each other.

In the common vernacular, some embodiments caters to a “buy low, sell high” trading mentality, and allow its liquidity providers to determine their own unique pool characteristics, supported by an infinitely customizable bonding curve and associated smart contract infrastructure. Each pool and its contents can variably be the sole property of its creator, or, alternatively, be open for community participation through the issuance of its own pool tokens. The latter describes a novel type of subscriber trading product and represents a decentralized counterpart to copy trading on conventional, centralized exchanges.

Taken together, the improvements offered by at least one embodiments described herein address technical challenges that have greatly limited the scope of application for DEX protocols.

At least some embodiments described herein address the aforementioned technical problem, and/or improve the aforementioned technology, by an invariant function and/or infinite set of associated bonding curves, and/or an asymmetric liquidity pool design employing one or more instances of these bonding curves supporting arbitrary trading strategies across any number of cryptocurrency tokens within the same pool.

At least some embodiments described herein address the aforementioned technical problem, and/or improve the aforementioned technology, by the invariant function that is employed with adjustable parameters that allow for users to determine the behavior of its associated liquidity pool with respect to exchange rates and price acceleration for all liquidity contained therein. In contrast to prior approaches, the function described herein is customizable (optionally infinitely). The customizable function may be limited in scope, accuracy, and/or resolution by the virtual machine of the distributed ledger system it is deployed on.

At least some embodiments described herein address the aforementioned technical problem, and/or improve the aforementioned technology, by the asymmetric liquidity pool described herein, which is designed to use a plethora of bonding curves simultaneously to achieve an explicit trading profile, concordant with the objectives and bias of its creator. In contrast to prior approaches, asymmetric liquidity pools allow for decisive actions by liquidity providers. The asymmetric liquidity pools enable executing premeditated plans, while maintaining liquidity for the cryptocurrency token economy.

Different subsets of adjustable parameters may be defined (e.g., over-parameterization), from which specific forms of the invariant function can be explicitly derived. The subsets are of a much larger collection of possible groupings of curve parameters and associated rearrangements of the general formula. Such flexibility allows for application-specific considerations to be addressed, including but not necessarily limited to: calculation accuracy in the absence of floating-point arithmetic, overflow and underflow, unsigned integers, computational complexity, storage and memory requirements, or other limitation imposed either directly or indirectly by the hardware or software on which the outputs of the function are determined.

At least some embodiments described herein improve upon prior approaches. For example, the status quo in DeFi protocols employing concentrated liquidity models is that exchanges are reversible; users who have contributed tokens to the smart contract system exchange tokens in both directions concordant with the system state. This manifests as a symmetric exchange profile, save for a nominal fee, whereby users of these protocols are forced to accept the reverse exchange at the same rate as the forwards direction. In contrast, at least some embodiments described herein, improve upon such prior approaches by designating the forwards and reverse exchange rates as separate, and optionally entirely under the control of the user. Therefore, and in contrast to conventional AMMs, users' positions are described by two or more bonding curves, simultaneously. From this arrangement a technical capability of DeFi smart contract systems can emerge, which is a technical improvement over existing approaches. The asymmetric liquidity pool construction, in addition to a formal limit order functionality, offers what may best be described as support for automated trading strategies. The term “user strategy” is used herein to refer to a specific analogue of liquidity provision. It is helpful to interpret each strategy as its own unique liquidity pool vis-à-vis the entrenched meaning of the term. However, apart from both being smart contract systems that contain cryptocurrency tokens for the explicit purpose of performing exchange, the behavior of the strategies described herein are a profound shift from the standard DeFi archetypes.

Moreover, after the initial calculations of B and S, as described herein, during the creation of a strategy, which can be performed with the assistance of off-chain resources, all on-chain calculations performed during swaps use (optionally only) the fundamental math operations addition, subtraction, multiplication, and division. This is true of equations described herein relating to the computation of marginal exchange rates and swaps, thus precluding the need for Taylor series and/or other polynomial approximations, and/or numeric methods of producing a function output. The freedom of choice to select appropriate parameters, and/or customized equation sets to fit the virtual machine on which the decentralized application is running addresses the technical problem of reducing use of computation resources for executing the smart contract.

Additional details of using embodiments described herein for improving computational efficiency of a computing device (e.g., processor) running a smart contract on a blockchain, and/or other distributed application, are now described.

Mathematical computations over a size-limited fixed-point infrastructure, bare a fundamental trade-off between Accuracy and Valid Input Range. Within any computation, the only type of operation which can reduce the accuracy of the output is division. The typical solution is to rearrange the computation such that division takes place only as the very last step. Subsequently, intermediate results of the computation become more likely to overflow and revert the entire transaction. This means that rearranging the computation will effectively reduce the range of input which can be handled successfully. For example, consider the following expression:

$$\frac{a}{b} + \frac{c}{d}$$

where a=100, b=51, c=1, d=25, and a size-limit of 8 bits (maximum value being 255). The true value of this expression is 100/51+1/25=2.00078 . . . , so ideally on a fixed-point infrastructure, we would want our implementation to yield 2. The straightforward implementation a/b+c/d is very inaccurate. It yields the output 100/51+1/25=1+0=1, which reflects an inaccuracy of more than 50% compared with the true value. However, rearranging it such that division takes place as the very last step using:

$$\frac{a d + b c}{b d}$$

reverts the transaction. It yields the intermediate computation of a×d=100×25, which overflows the given size-limit.

In the following, these concepts are elaborated with a view to distinguish between mathematically redundant, but computationally distinct, versions of the invariant function described in the disclosure. First, two different implementations of the invariant function, one using the constants x₀, y₀ and n, and the other using the constants S, B, and yᵢₙₜ, are discussed relative to each other. Then, a short discussion is provided comparing the implementation flexibility of implementations described herein versus other concentrated liquidity industry standards, Uniswap V3 and Kyber DMM, which are based on embodiments described with reference to Patents '896 and/or '923.

Some embodiments of the disclosure relate to an asymmetric liquidity system that includes (so-called concentrated liquidity) bonding curves. Each bonding curve may be described with respect to a collection of parameters which define its characteristic pricing behaviour. As each parameter may be expressed in terms of other parameters, it is possible to present to the user an intuitive selection and then process their input so as to preserve its meaning, while affording a more computationally tractable translation of the same data. From a product perspective, the user may need only make decisions as to the specific price intervals through which their liquidity will be available to the market, and the quantity of tokens they wish to include in said interval. It is noted that the user choices presented here are accurate but simplified. The local discussion herein is not to explore the full scope of possible applications, but rather to demonstrate the flexibility of implementations of some embodiments with respect to constraints of the computer environment that the implementation will run on. These user-facing parameters are defined in more detail herein; a truncated version appears below and features just the parameters a user would be presented with, prior to further processing.

TABLE S1
User-facing parameters. This table is a heavily truncated and
simplified version of that which appear herein.

| Variable | Meaning |
|---|---|
| y | Token balance |
| Pₐ | Exchange rate at high-bound |
| P_{b} | Exchange rate at low-bound |
| yᵢₙₜ | Curve size. |

Consider that with these inputs, any of the terms discussed herein can be accessed using the formulae contained therein. For example, the parameters n, y₀ and x₀ can be computed using eqns. 11b, 11d, and 13n described herein.

$$n = 1 - \sqrt[4]{\frac{{P}_{b}}{{P}_{a}}} \qquad eqn . 11 d$$

$$\sqrt{{P}_{a} {P}_{b}} = \frac{{y}_{0}}{{x}_{0}} \qquad eqn . 11 b$$

$${y}_{0} = \frac{{y}_{int} ( 1 - n )}{2 - n} \qquad eqn . 13 n$$

Such processing would allow for the invariant functions eqns. 2d-h described herein to be used by the protocol. For clarity, each of these forms may be redundant with each other; they may be different algebraic representations of the same fundamental relationships between the constants n, y₀ and x₀ and the points (x, y) that satisfy these relationships.

xy=(1−n)(x−x₀)(v−y₀)+x₀y₀ eqn. 2h

The x and y coordinates may be defined in terms of each other using eqns. 3-4e described herein. The marginal price formulae are defined by eqns. 5-6e described herein. The token swap formulae, and swap-dependent pricing formulae are defined by eqns 7-10e described herein. To further assist with the present discussion, a rearrangement of eqn. 8e to make Δx the subject is included as eqn. S1. Equation 8e is a generic swap equation, where −Δy denotes the quantity of target tokens received by the trader in exchange for Δx source tokens, appropriate for when the trader nominates Δx and measures −Δy. Equation S1 is the reverse swap equation, appropriate for when the trader requests to receive −Δy of the target token and measures the trade amount Δx required to achieve such a result

$$- Δ y = \frac{Δ {x ( ny + {y}_{0} ( 1 - n ) )}^{2}}{Δ xn ( ny + {y}_{0} ( 1 - n ) ) + {x}_{0} {y}_{0}} \qquad eqn . 8 e$$

$$Δ x = \frac{( - Δ y ) {x}_{0} {y}_{0}}{( yn + {y}_{0} ( 1 - n ) ) ( yn + {y}_{0} ( 1 - n ) - ( - Δ y ) n )} \qquad eqn . S1$$

Note that Pₐ and P_{b} may be expected to remain constant until the user changes their values, whereas yᵢₙₜ may change as a result of normal protocol activity. Some information may be pre-calculated before runtime (i.e., in advance). The precalculated information may be found during runtime to:
Improve accuracy (reduce precision loss)
Improve performance (reduce the gas cost)

For example, the following may be pre-calculated:

$$n = 1 - \sqrt[4]{{P}_{b} / {P}_{a}}$$

$$( 1 - n ) / ( 2 - n )$$

$$\sqrt{{P}_{a} {P}_{b}}$$

In a fixed-point infrastructure such as Ethereum (and other blockchains), each of the constants must be subjected to a scaling factor to remove the fractional component, and then use just the integer part of each one of the results. The runtime computation itself will need to account for each one of these scaling factors, and possibly descale intermediate results accordingly. The scaling of each constant value needs to be high enough to make precision-loss negligible, but at the same time, it should not be high to the point of bringing the size of valid input range (where certain inputs lead to arithmetic overflow) below system requirements.

An alternative approach based on at least some embodiments described herein is now described. Parameters S and B (eqns 20a-c) described herein, may also be computed directly from the user inputs listed in Table S1.

S=\sqrt{Pₐ}−\sqrt{P_{b}} eqn. 20a

B²=P_{b} eqn. 20c

Processing via this method grants access to the invariant function eqn. 21a described herein. The x and y coordinates can be defined in terms of each other using eqns. 21b-c described herein. The marginal price formulae are defined by eqns. 21d-e described herein. The token swap formulae, and swap-dependent pricing formulae are defined by eqns. 21f-i described herein. To further assist with the present discussion, a rearrangement of eqn. 21g¹ to make Δx the subject is included as eqn. S2. Equation 21g is a generic swap equation, where −Δy denotes the quantity of target tokens received by the trader in exchange for Δx source tokens, appropriate for when the trader nominates Δx and measures −Δy. Equation S2 is the reverse swap equation, appropriate for when the trader requests to receive −Δy of the target token and measures the trade amount Δx required to achieve such a result.

$$y ( x ( BS + {S}^{2} ) + {y}_{int} ) = {y}_{int} ( {y}_{int} - x ( BS + {B}^{2} ) ) \qquad eqn . 21 a$$

$$- Δ y = \frac{Δ {x ( {By}_{int} + Sy )}^{2}}{S Δ x ( {By}_{int} + Sy ) + {y}_{int}^{2}} \qquad eqn . 21 g$$

$$Δ x = \frac{( - Δ y ) {y}_{int}^{2}}{( Sy + {By}_{int} ) ( Sy + {By}_{int} - S ( - Δ y ) )} \qquad eqn . S2$$

A comparison of two different implementations of the theory elaborated herein, derived from representations of the invariant function eqn. 2h (which uses the constants x₀, y₀, and n) and 21a (which uses the constants S, B, and yᵢₙₜ). In both cases there is a need to maintain three constant values in addition to the token balance, y. However, the latter implementation benefits from a reduction in:
The overall number of operations (e.g., gas cost).
The overall number of division operations (e.g., precision-loss).
The overall magnitude of intermediate results (e.g., potential overflows).

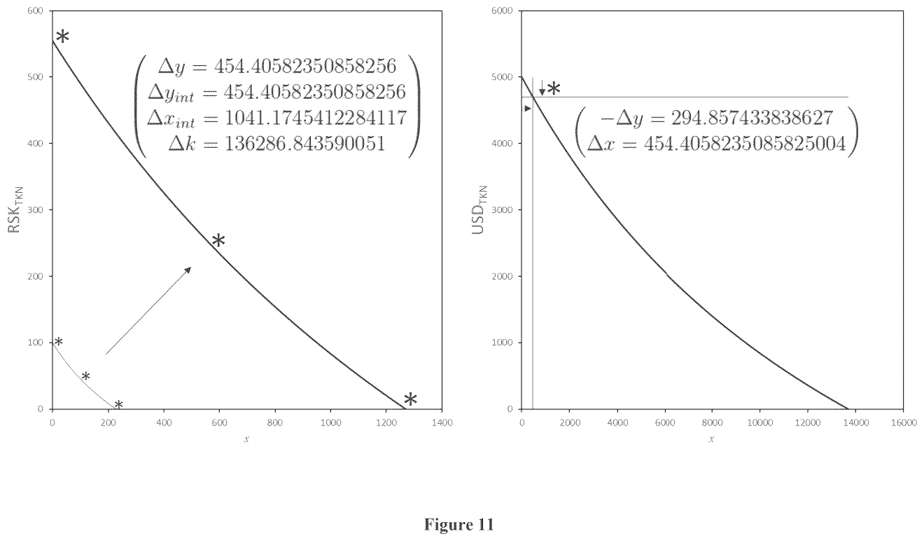

Since yᵢₙₜ is used directly as its own constant in the implementation employing S and B, there is no precision loss associated with its processing after receiving it as an input from the user. It is noted that yᵢₙₜ is adjusted dynamically by the protocol during regular operation as required to maintain the user's liquidity within their nominated price bounds Pₐ and P_{b}. This aspect of the disclosure is described herein; examples of updates to this parameter are described, for example, in Table 5, Table 7, and Table 11. Using yᵢₙₜ directly also has ongoing operational advantages. During certain conditions, it is necessary to update the size of the user's curve, as depicted in FIG. 11 and described herein.

During such an event, both constants x₀ and y₀ would require an update, whereas the implementation using yᵢₙₜ as its own constant requires that it be updated. Moreover, direct update of yᵢₙₜ requires no mathematical operations whatsoever. These updates occur when the token balance y surpasses the value of yᵢₙₜ, at which point yᵢₙₜ is updated to be equal to y. The Boolean operations required to compare two numbers, and update one to be equal to the other, is computationally trivial. Whereas the implementation involving x₀ and y₀ is rather complex. First, this conditional statement requires yᵢₙₜ to be reconstituted from the stored constants y₀ and n, prior to the Boolean operation. Then, if an update is required, the new yᵢₙₜ value is then be decomposed back into x₀ and y₀, further burdening the computational overhead and introducing additional precision issues. Addressing optimal scaling factors for the values of S and B, as alluded to previously:
Each scaling factor is to be high enough to make precision-loss negligible.
Each scaling factor is not be high to the point of causing runtime overflows.

An additional consideration is the overall size required for storing these values in the contract on a blockchain for example, Ethereum. As on-chain storage read/write operations are typically amongst the most gas-consuming ones, it is preferable to maintain all 4 values (y, yᵢₙₜ, S, B) using as little storage as possible.

At least some implementations based on embodiments described include entities referred to herein as Strategies. Each strategy may include two or more entities sometimes referred to herein as Orders. Each order may include the 4 values described above. Hence each strategy includes 2 sets of these 4 values. Strategies may be created, for example, by market makers (i.e., liquidity providers) and/or traded against by market takers (i.e. traders). Each strategy may be traded independently of all other strategies. When traded against, the following storage-access operations may be executed:

TABLE S2
Storage-access operations in the implementation
which utilizes the constants S, B, and yᵢₙₜ.

| | read from storage | | write into storage | |
|---|---|---|---|---|
| source order | y | always | y | always |
| | yᵢₙₜ | always | yᵢₙₜ | sometimes |
| | S | never | S | never |
| | B | never | B | never |
| target order | y | always | y | always |
| | yᵢₙₜ | always | yᵢₙₜ | never |
| | S | always | S | never |
| | B | always | B | never |

The source order may refer to the component of the maker's (e.g., liquidity provider's) strategy that has a token balance with the same identity as that which the taker (e.g., trader) is sending into the protocol. For example, if the trader is sending TKN1 into the protocol and receiving TKN2, then the maker's order with a balance of TKN1 is the source order.

The target order may refer to the opposite of the source order. Using the example above, the maker's order with a balance of TKN2 is the target order.

In an exemplary implementation, the value of y (e.g., current token balance/liquidity) typically requires no more than 112 bits, allowing for an amount of approximately 5×10³³ (i.e., the number 5 followed by 33 zeros), which is more than enough for representing any reasonable token-decimal value, including high token decimal contracts. For example:
A token with 18 decimals, it allows for up to 5×10¹⁵ (5 million billion) tokens.
A token with 22 decimals, it allows for up to 5×10¹¹ (500 billion) tokens.
A token with 24 decimals, it allows for up to 5×10⁹ (5 billion) tokens.

The same number of bits is required for the value of yᵢₙₜ, since it is derived directly from the value of y.

The value of B, which stores the square root of the lowest exchange rate, may need to be scaled up to some integer value large enough to maintain most of the information. Allocating 64 bits for it and scaling it up by a factor of 2³² may allow it to attain values between 1/2³² and 2³², at a resolution of 1/2³². This may yield effective rates between 1/2⁶⁴ and 2⁶⁴, at an average resolution of 1/2¹⁶.

Similarly for the value of S, which stores the difference between the square root of the highest exchange rate and the square root of the lowest exchange rate, allocating 64 bits for it and scaling it up by a factor of 2³² may allow it to attain values between 1/2³² and 2³², at a resolution of 1/2³². This may yield effective rates between 1/2⁶⁴ and 2⁶⁴, at an average resolution of 1/2¹⁶.

Therefore, each strategy requires 2×(112+112+64+64)=704 bits. It is important to note here that unpredictable token decimality (a property of a cryptocurrency token that refers to its smallest, indivisible unit) necessitates relatively high storage allocation, whereas the rate constants S and B are relatively insensitive and can be satisfactorily implemented with lower storage requirements. With reference to Table 2, the following exemplary layout of these values in storage may be:

The following exemplary layout of these values in storage may be:
Slot #1: y (source), y (target)
Slot #2: yᵢₙₜ (source), S (source), B (source)
Slot #3: yᵢₙₜ (target), S (target), B (target)

Will yield for every trade on a given strategy:
Exactly 3 slot-read operations.
Either 1 or 2 slot-write operations.

### Encoding/Decoding

With:
L=order's lowest rate
H=order's highest rate
M=order's marginal rate

Given:
min=floor(2³²×sqrt(L))
max=floor(2³²×sqrt(H))
mid=floor(2³²×sqrt(M))

The order maintains:
y=current liquidity
yᵢₙₜ=current liquidity*(max−min)/(mid−min)
S=max−min
B=min

The order reflects:
L=(B/2³²)²
H=((B+S)/2³²)²
M=((B+S*y/yᵢₙₜ)/2³²)²

### Trade Computation

```
ONE = 2 ** 32
MAX = 2 ** 112 - 1
getTradeTargetAmount (Dx, y, yint, S, B):
  temp1 = y * S + yint * B # 177 bits at most; cannot overflow
  temp2 = temp1 * Dx / ONE # 224 bits at most; can overflow
  temp3 = temp2 * S + yint * yint * ONE # 256 bits at most; can overflow
  res = mulDiv(temp1, temp2, temp3)
  assert res <= MAX
  return res
getTradeSourceAmount (Dx, y, yint, S, B):
  temp1 = yint * ONE # 144 bits at most; cannot overflow
  temp2 = y * S + yint * B # 177 bits at most; cannot overflow
  temp3 = temp2 - Dx * S # 177 bits at most; can underflow
  res = mulDiv(Dx * temp1, temp1, temp2 * temp3)
  assert res <= MAX
  return res
```

Function mulDiv(m, n, d) returns the value of m×n/d, while allowing the intermediate value of m×n to exceed 256 bits; the function overflows (reverts) only if the final result exceeds 256 bits.

It may be observed that:
In function getTradeTargetAmount:
   Transaction-revert may occur due to overflow.
   Precision-loss may occur due to two division operations.
In function getTradeSourceAmount:
   Transaction-revert may occur due to overflow or underflow.
   Precision-loss may occur due to one division operation.

Nevertheless, overflows and underflows are expected to be extremely rare, occurring under highly unlikely combinations of input value (Δx) and system state (y and yᵢₙₜ). And due to the very small number of division operations executed in each function, the loss of precision is also expected to remain minimal.

Some examples of industry Standard comparisons are now provided.

Two close industry analogues exist, to which the implementation considerations discussed here may be compared. One example is Uniswap V3, which is described in its whitepaper, Uniswap v3 Core (Adams, H.; Zinsmeister, N.; Salem, M.; Keefer, R.; Robinson, D. 2021). The authors introduce an invariant function of the form eqn. S3, which is redundant with the virtually amplified token reserves described with reference to Patent '896. For clarity of explanation, here, the constants Pₐ and P_{b} are displayed for consistency with their meaning in the disclosure; the meaning of these two parameters is reversed in the whitepaper. The constant L can be expressed in terms of x₀, y₀, and n, as shown in eqn. S4. This deduction is not featured in the article by Adams et al, but provided herein for explanatory purposes.

$$( \frac{L}{\sqrt{{P}_{a}}} + x ) ( L \sqrt{{P}_{b}} + y ) = {L}^{2} \qquad eqn . S3$$

$$L = \frac{\sqrt{{x}_{0} {y}_{0}}}{n} = \frac{{x}_{0} \sqrt[4]{{P}_{a} {P}_{b}}}{n} = \frac{{y}_{0}}{n \sqrt[4]{{P}_{a} {P}_{b}}} \qquad eqn . S4$$

Since L is redundant with x₀, y₀ and n, it suffers from the same drawbacks as the implementation using these constants, discussed above.

In another example, The Kyber DMM whitepaper, Dynamic Automated Market Making (Nguyen, A.; Luu, L.; Ng, M. 2021), presents a rudimentary derivation of the constants x₀ and y₀, and introduces an amplification term a, which is equivalent to the reciprocal of n (i.e. the term u of the present disclosure), which is redundant with the virtually amplified token reserves described in Patent '896. Unlike the Uniswap paper, the paper by Nguyen et al. does not contain a new invariant function; rather, it invokes virtualized token balances belonging to a simulated, larger bonding curve (Excerpt S1).

Excerpt S1: Description of the virtual token balances, simulating a larger
constant-product AMM, as used by the Kyber DMM implementation.
3.1.1 Technical details
We define liquidity providers' initial contribution to the pool as x₀ and y₀,
and x₀ · y₀ = k. The initial virtual balances are defined as x′₀ = x₀ · a and
y′₀ = y₀ · a, in which a is the amplification factor and a > 1.
In the beginning, the real and virtual balances of the two assets
(x, y) = (x₀, y₀), (x′, y′) = (x′₀, y′₀) respectively.
Instead of using the simple constant-product function x · y = k, the pool
with Dynamic pricing curve model will maintain a constant product in
virtual balances by using the new inventory function:
x′ · y′ = k′

The Kyber DMM implementation manages four token balances, two real and two virtual. While the total number of parameters required to describe a concentrated liquidity profile is identical, this method of using both real and virtual token balances requires that all four parameters are read from and written to storage with every trade. How to apply this method to an asymmetric system is not entirely clear; however, it is certain that at least two additional virtual balances would be required. As alluded to in earlier discussion, token balances can require significant storage allocation to account for the long integers necessary to achieve reasonable accuracy, making this a formidable challenge vis-à-vis gas consumption and overall network overhead. Adjusting the size of the curve (i.e. the equivalent of yᵢₙₜ) would entail changes to at least three of these token balances simultaneously. Given the prohibitively large integers required to support such an implementation, it is likely that all three updates could require individual read/write actions to discrete memory slots in the Ethereum Virtual Machine. Lastly, high amplification values will result in ostensibly absurd virtualized token balances. For example, implementation described herein an S value of zero—which is easily supported—would require an infinite virtual token balance in the system described by Nguyen et al.

It should be stressed that neither Uniswap V3 or Kyber DMM discuss asymmetric liquidity, and both systems are redundant with the virtually amplified token reserves described in Patent '896, and their systems must contend with additional implementation challenges, unrelated to the embodiments described herein. The aspect of handling of the invariant function described herein improves computational performance of a computer and/or processor executing the smart contract, blockchain, and/or other distributed application, afforded by its overparameterization, over existing approaches.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

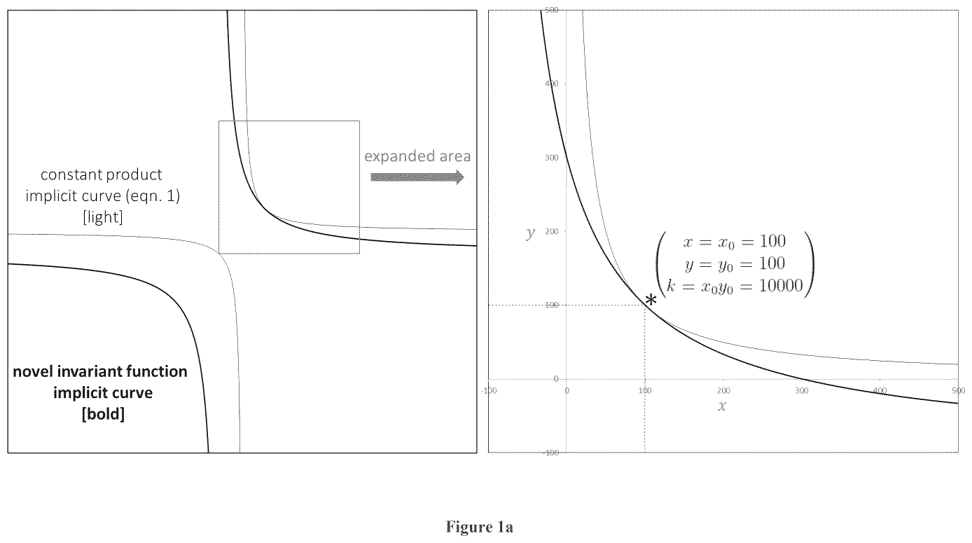

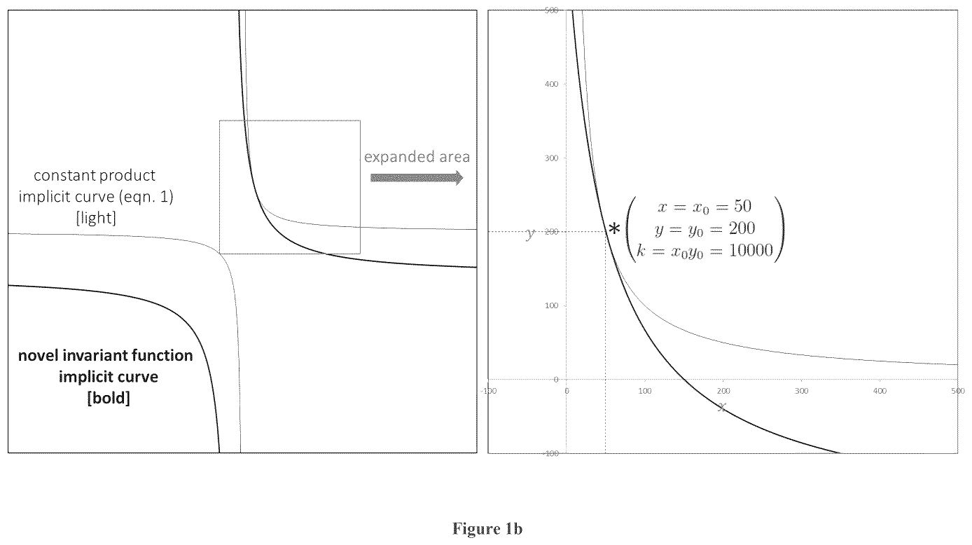

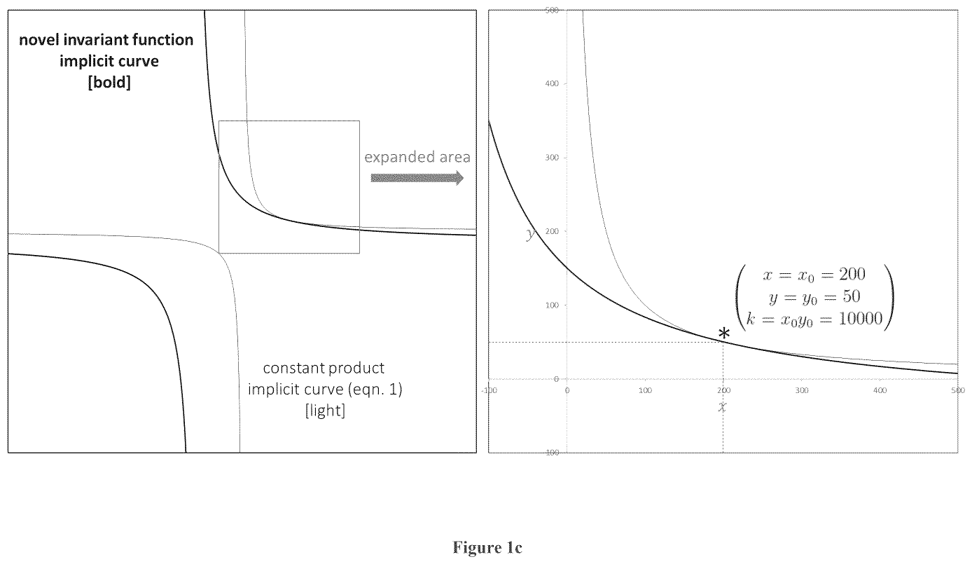

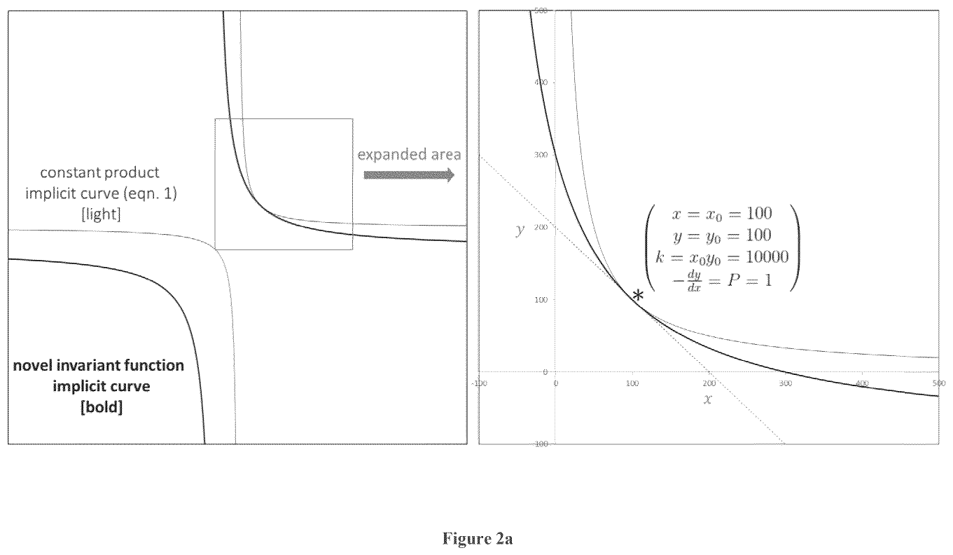

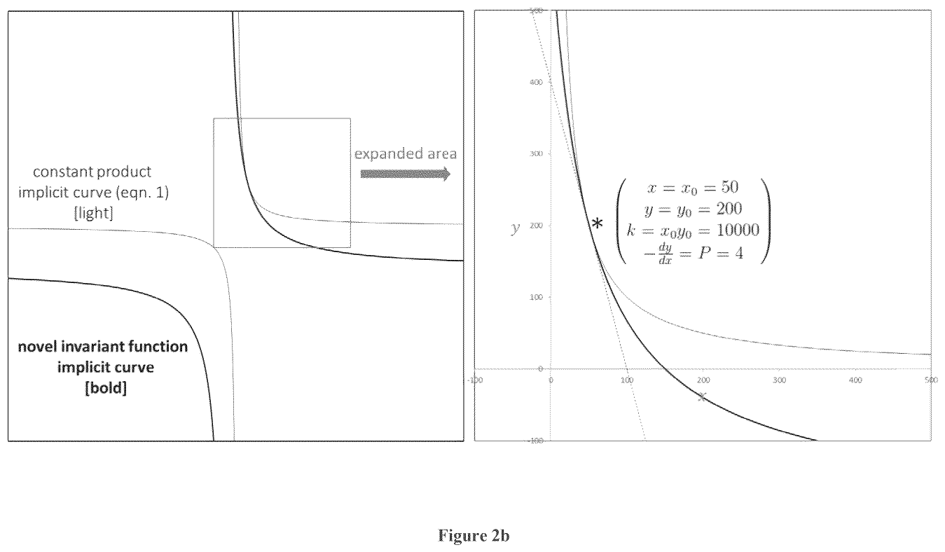

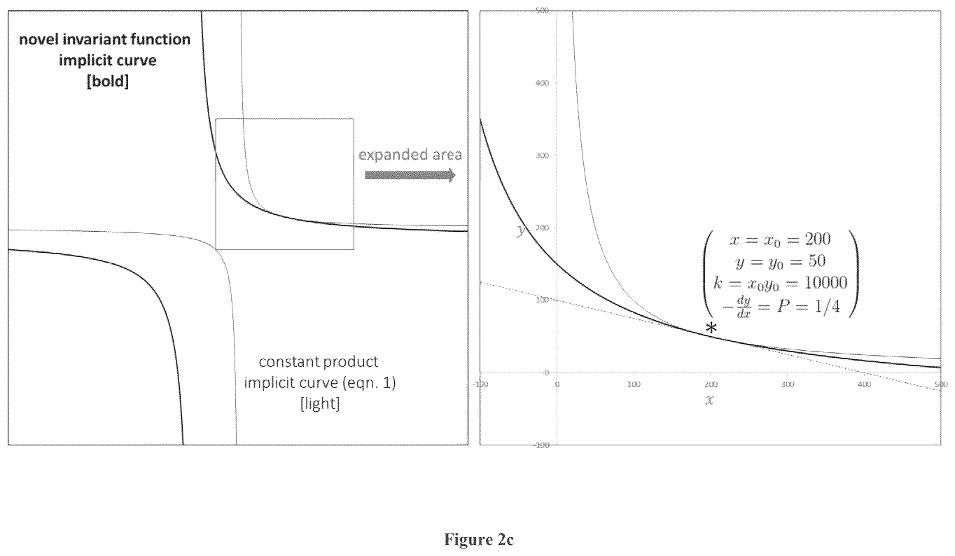

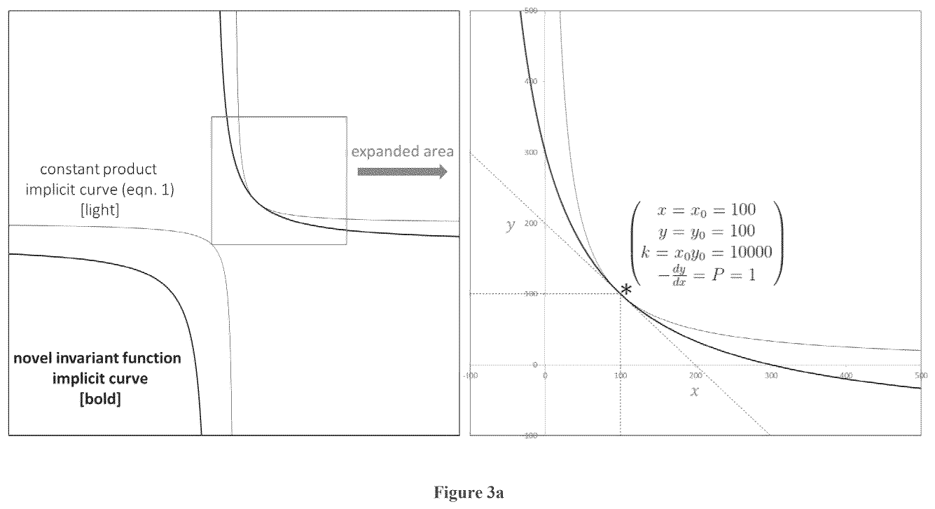

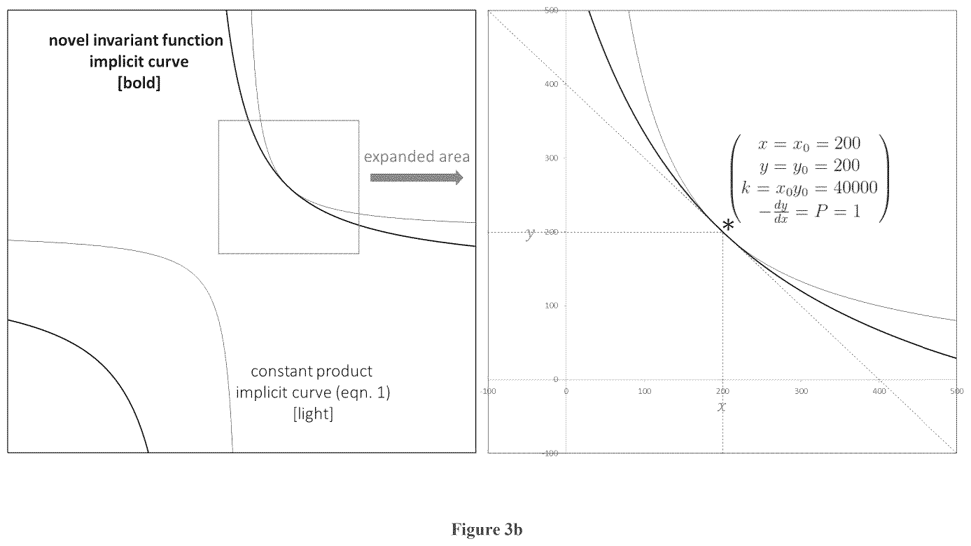

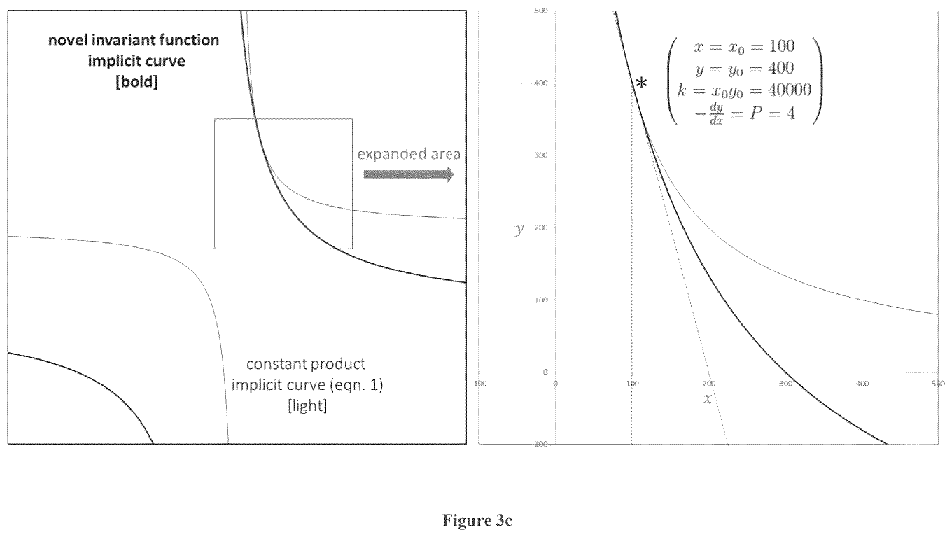

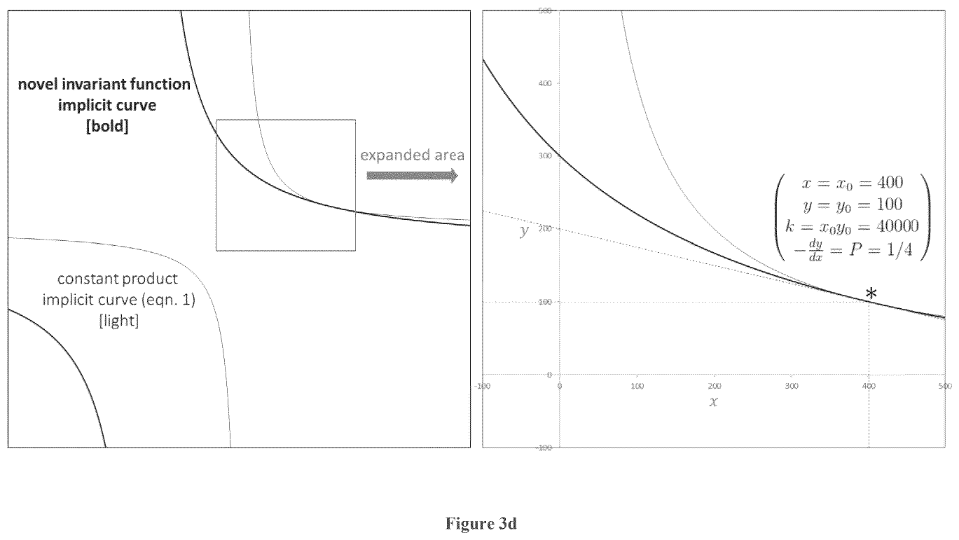

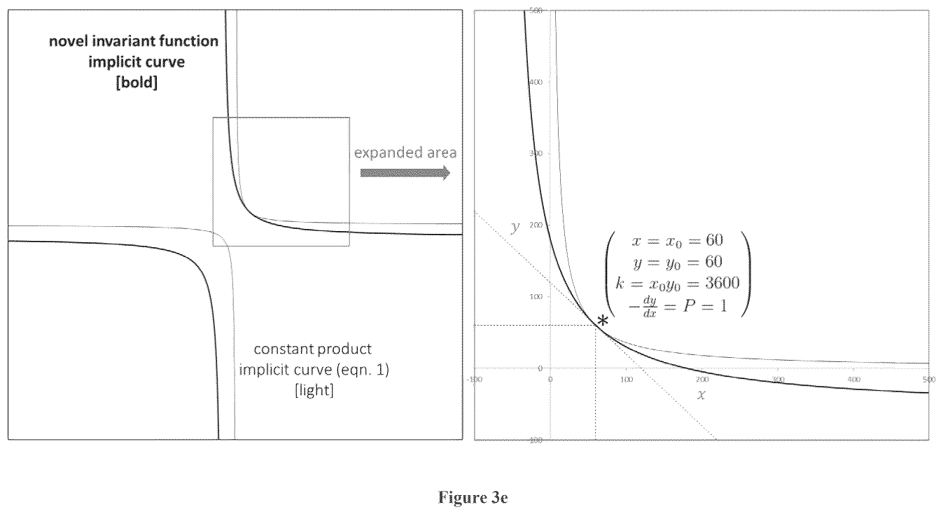

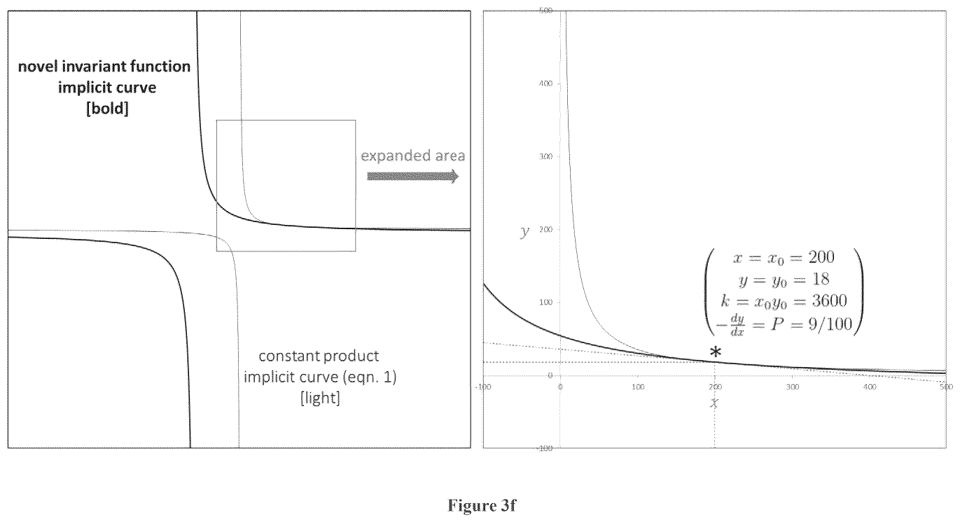

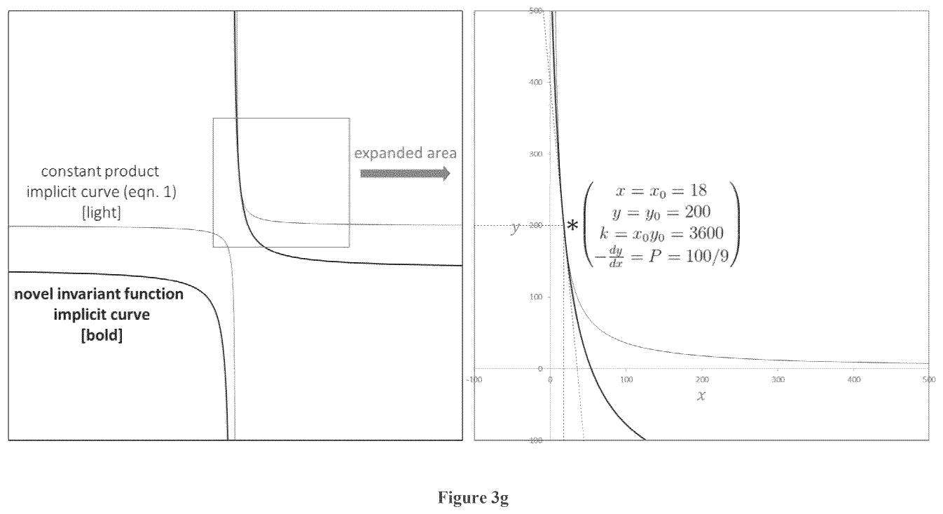

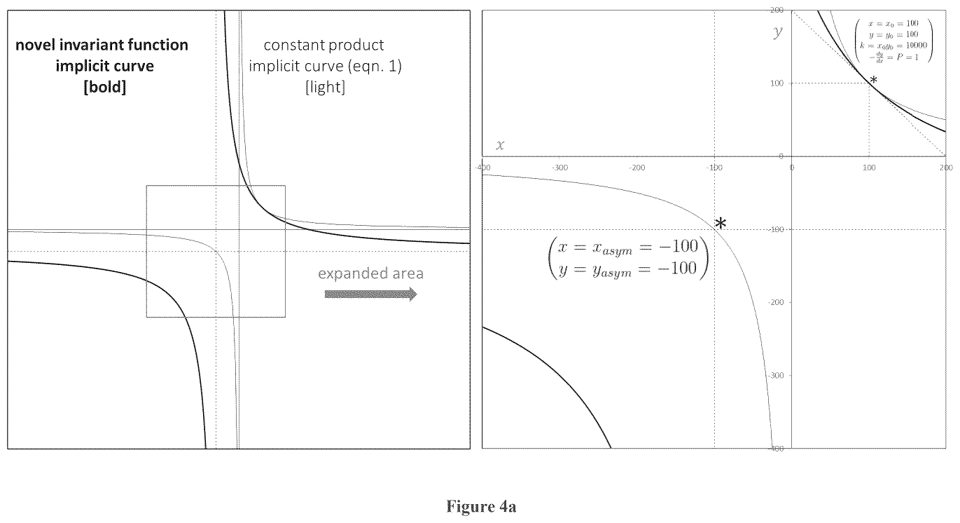

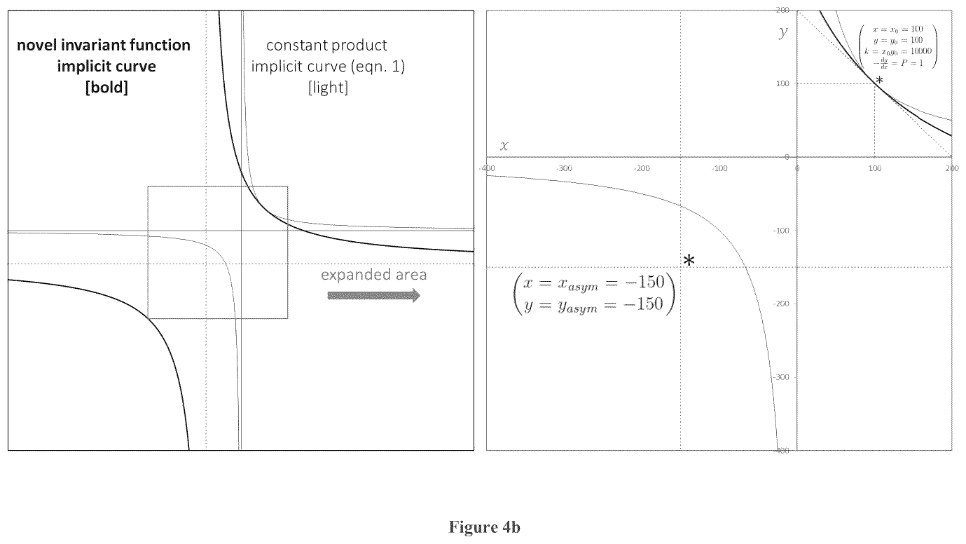

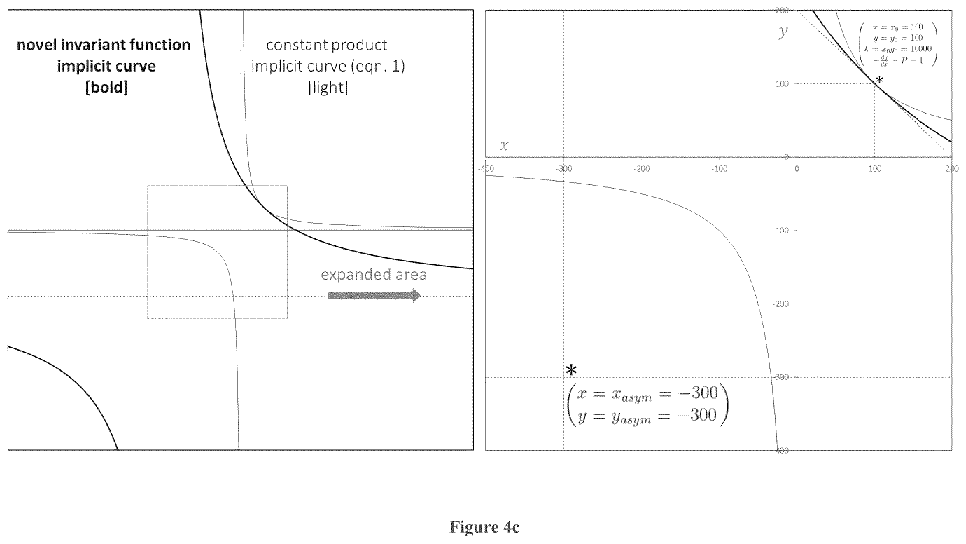

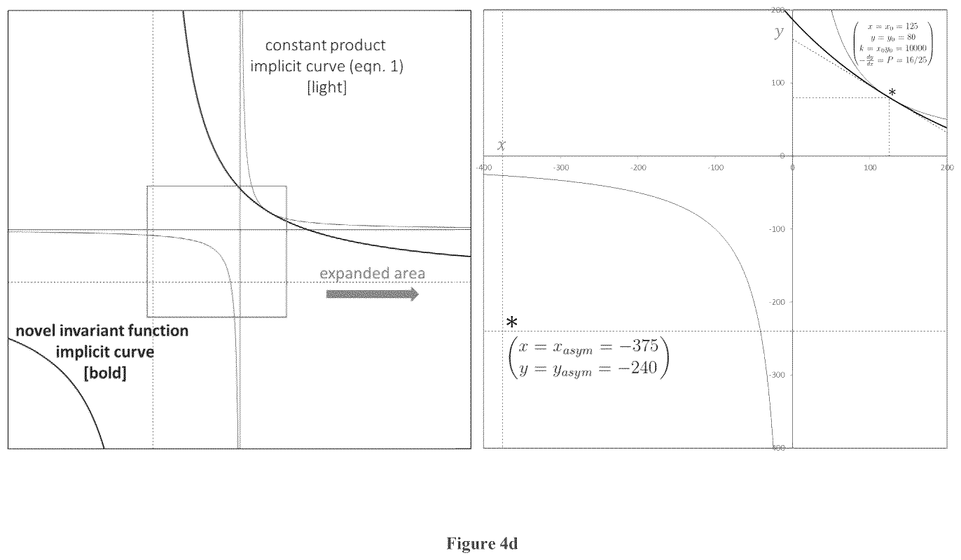

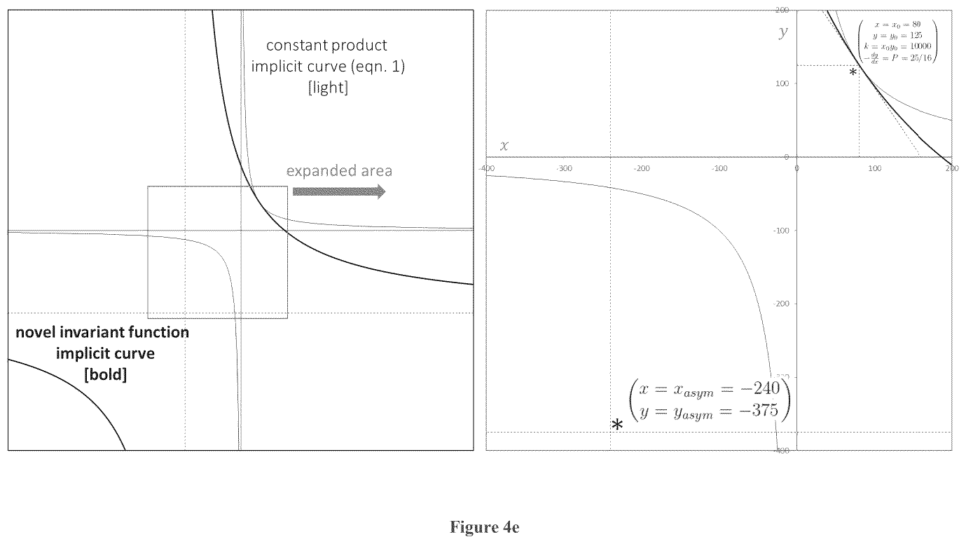

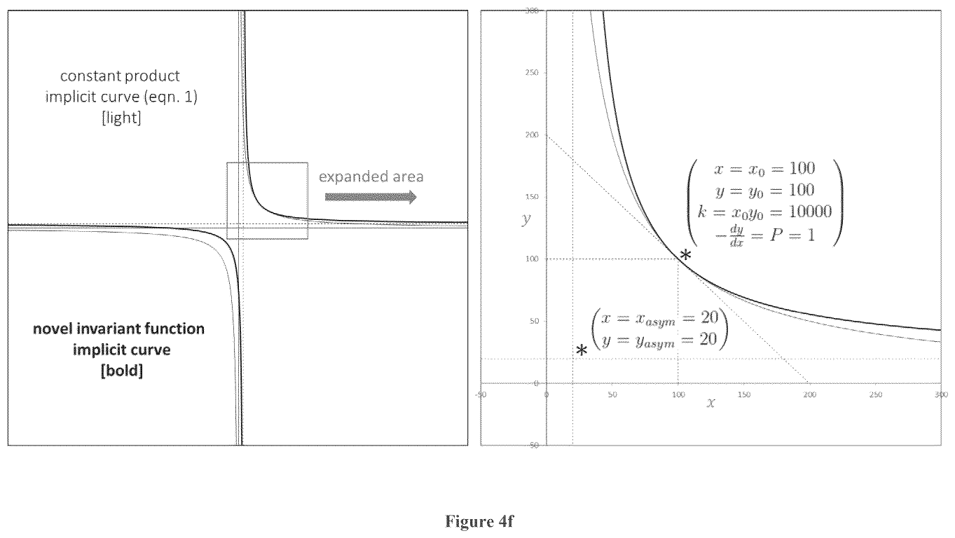

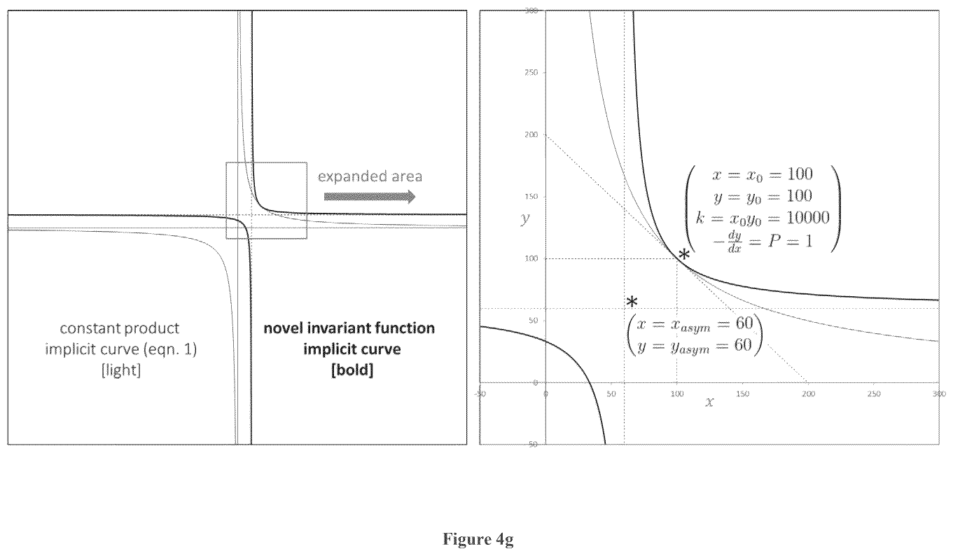

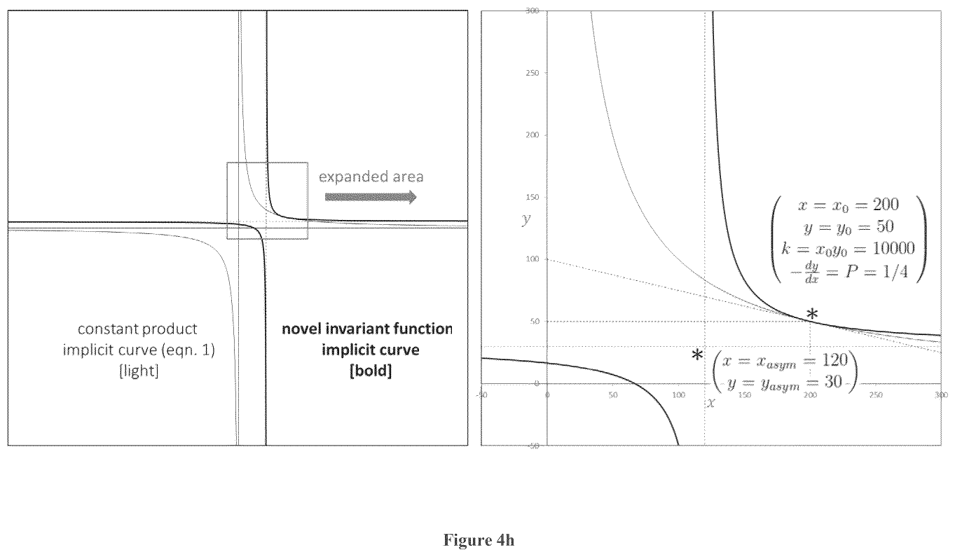

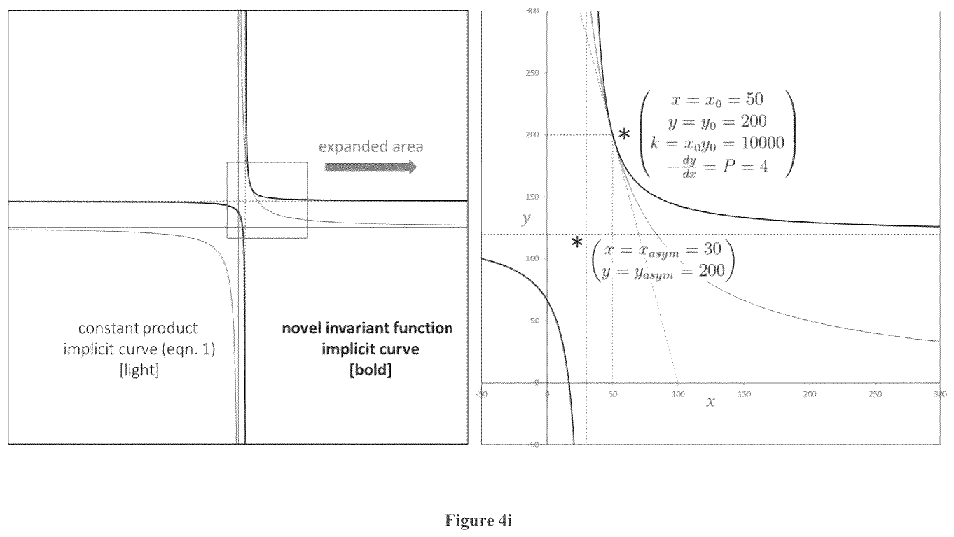

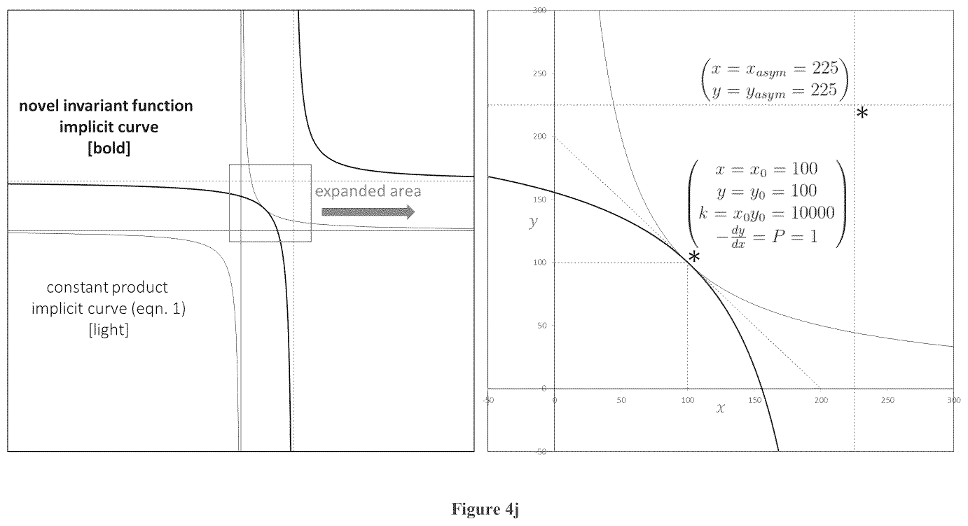

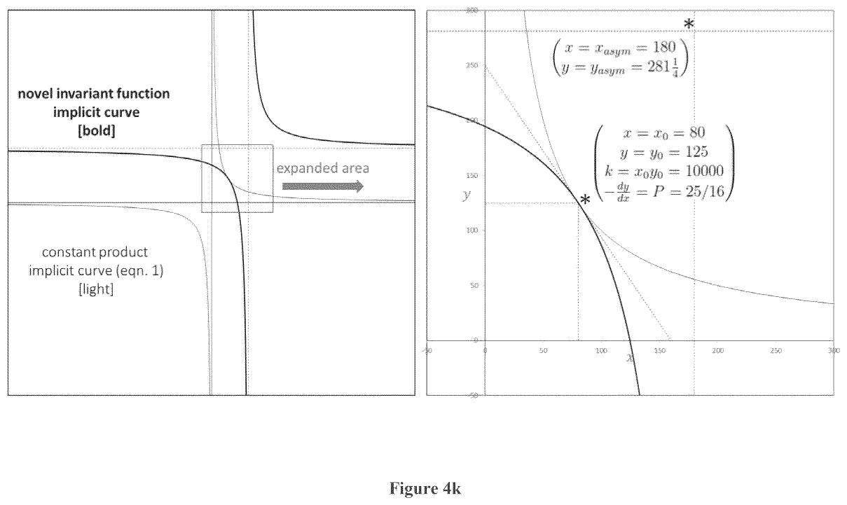

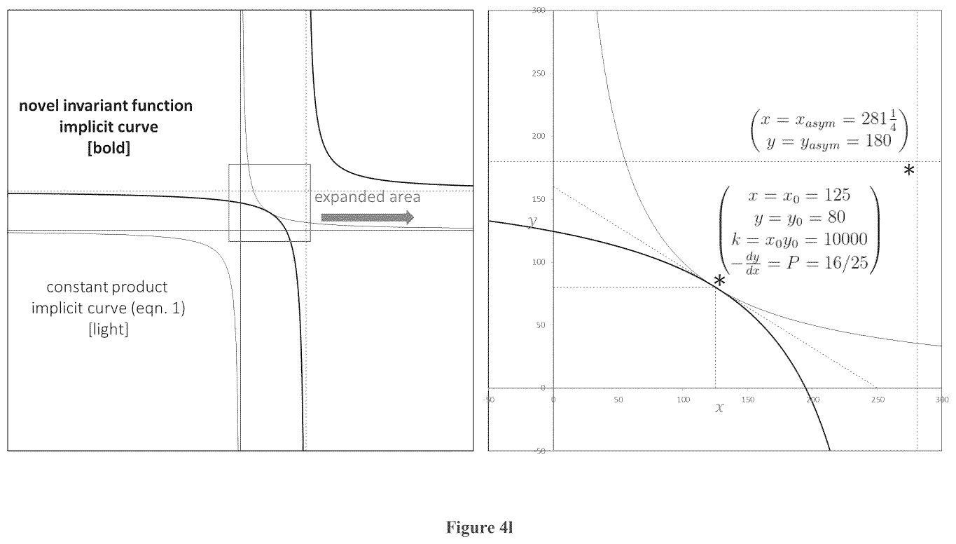

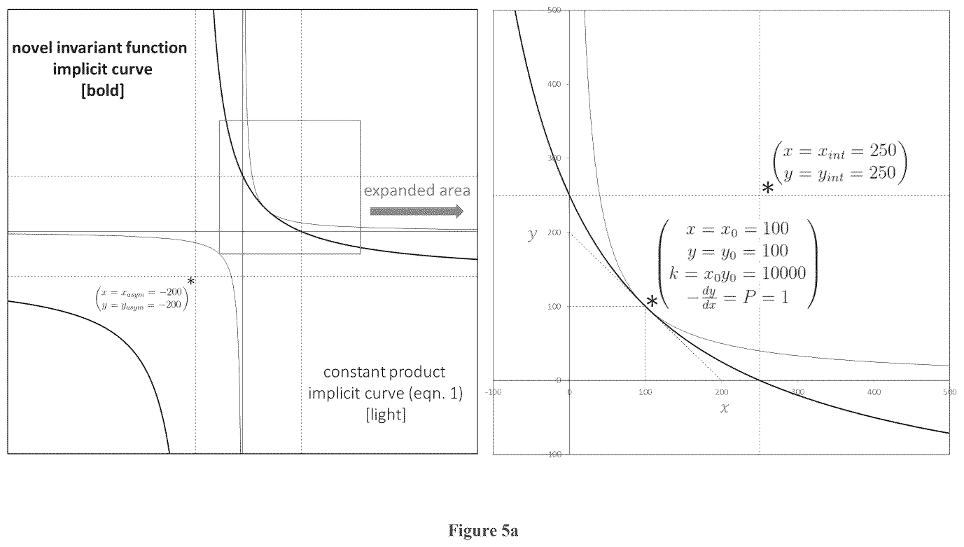

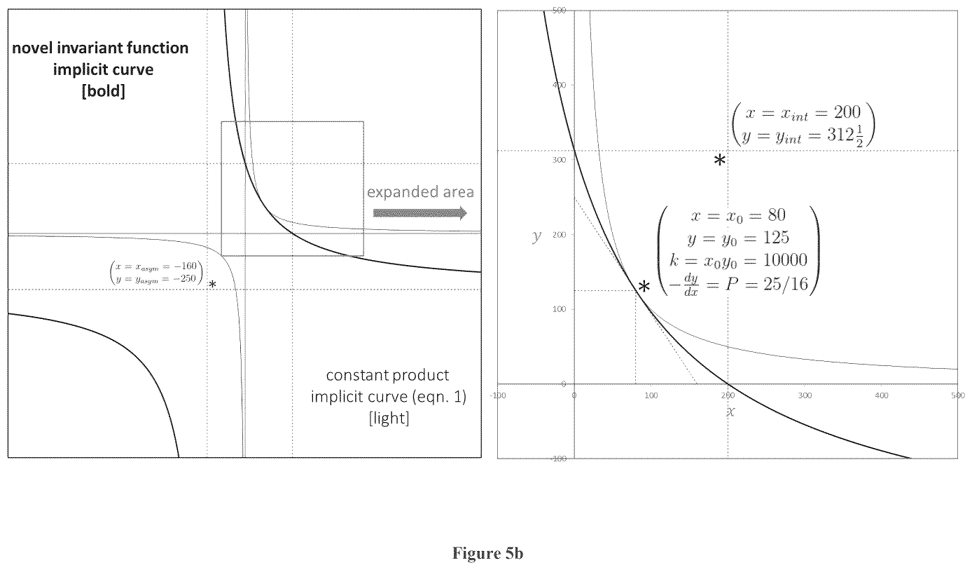

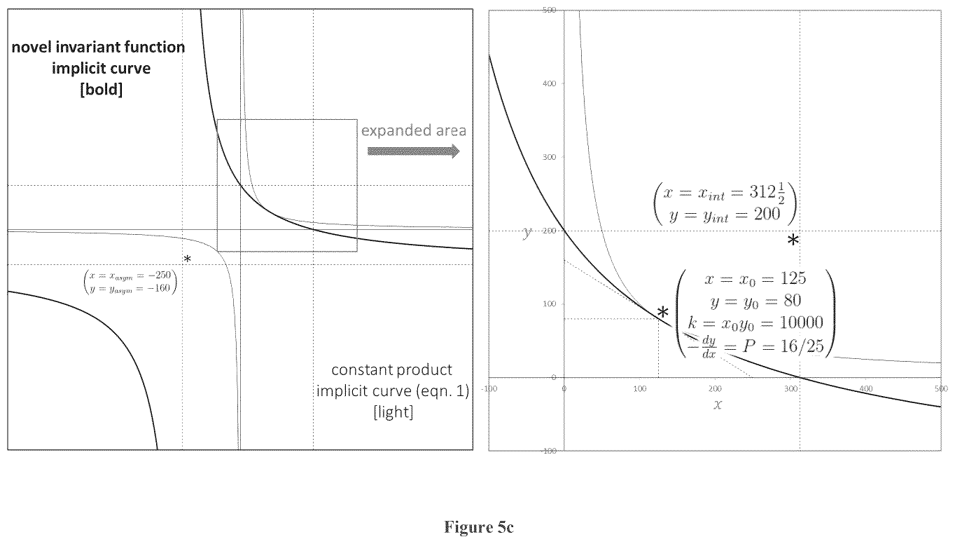

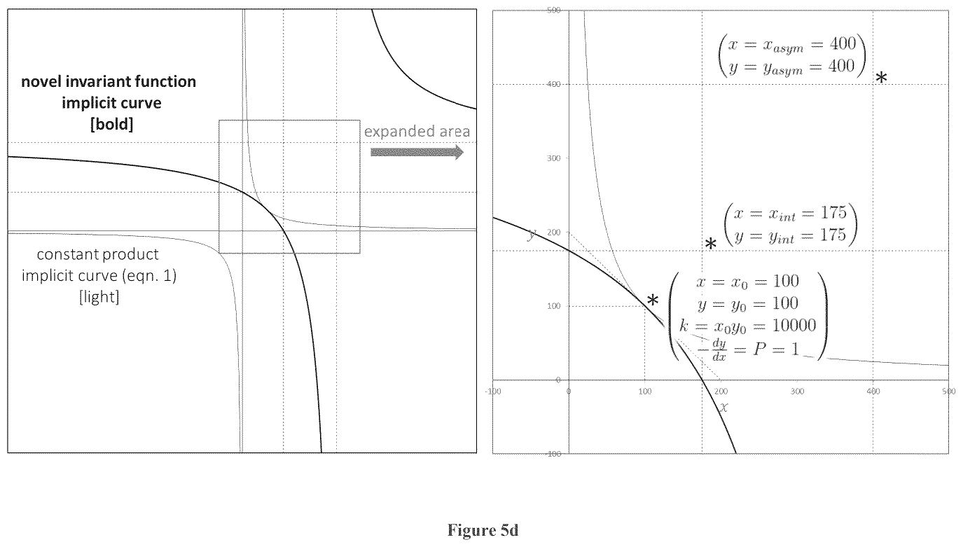

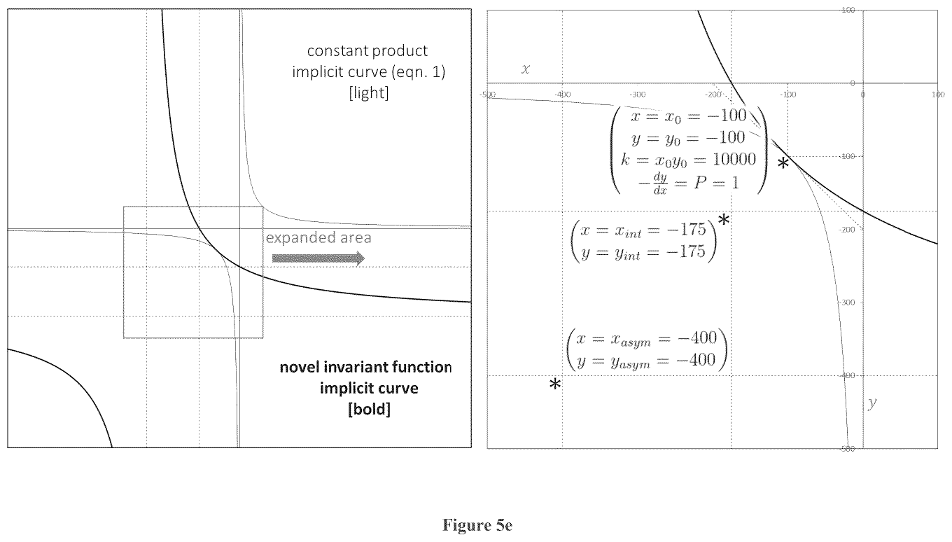

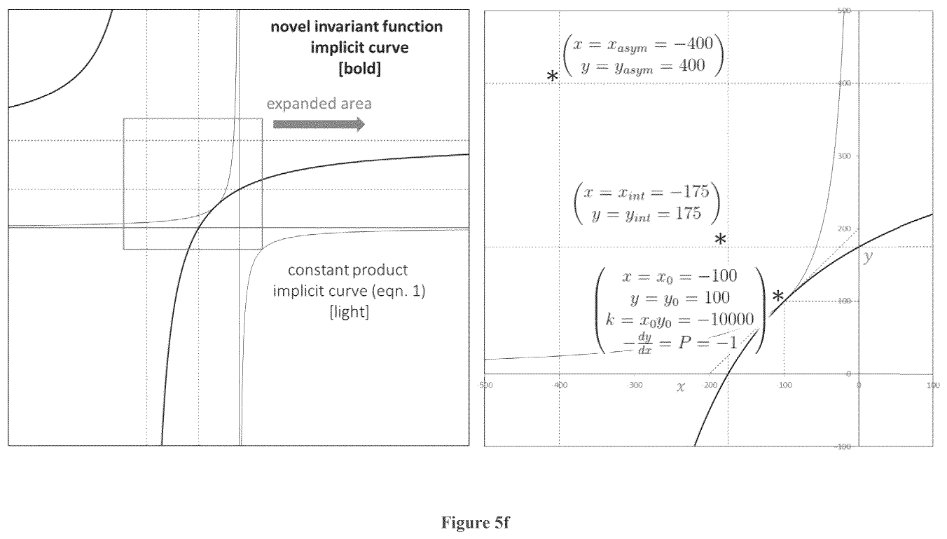

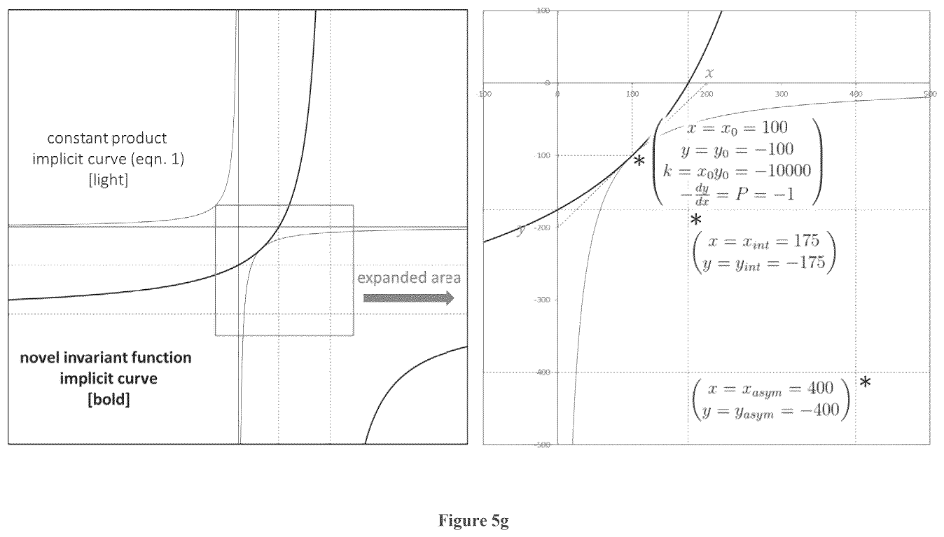

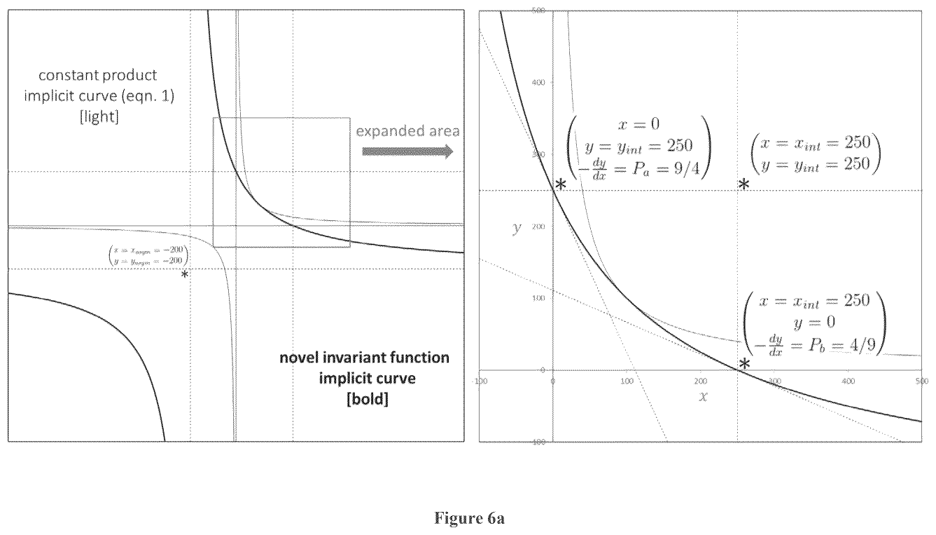

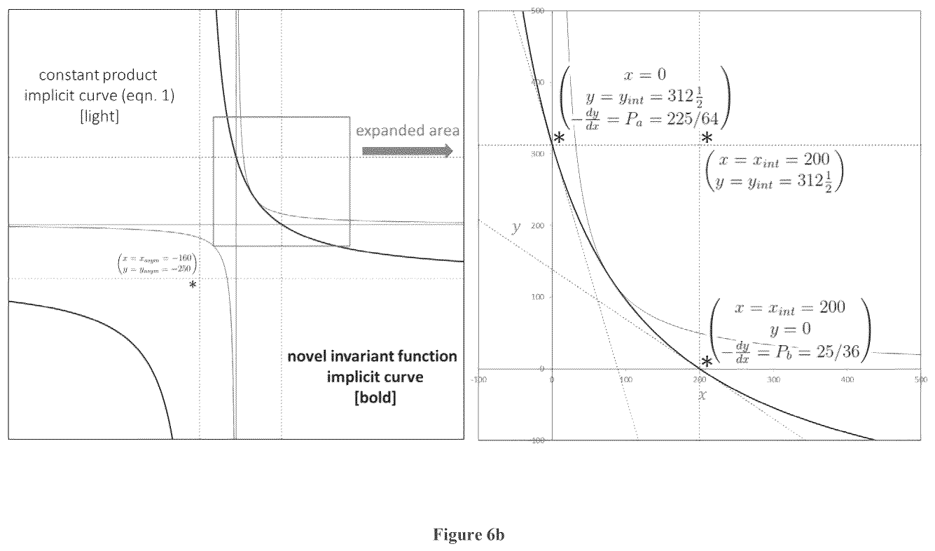

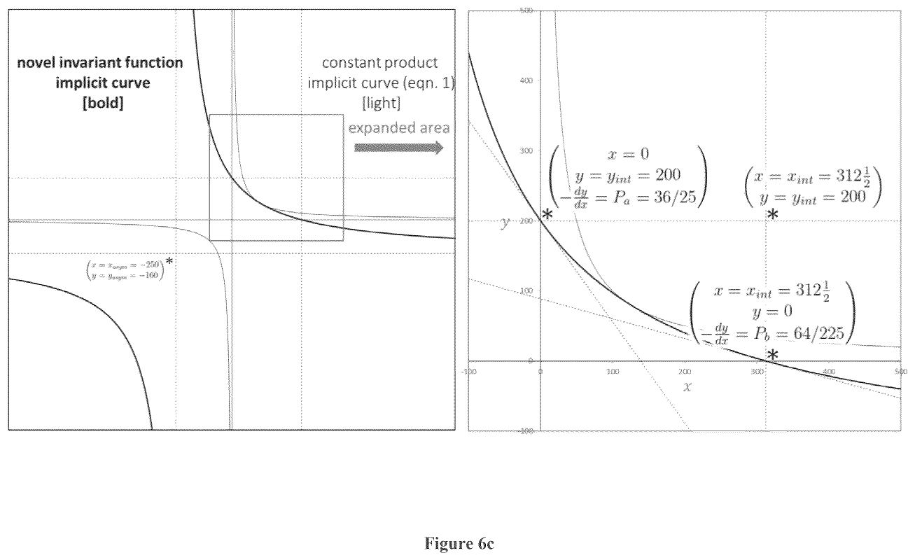

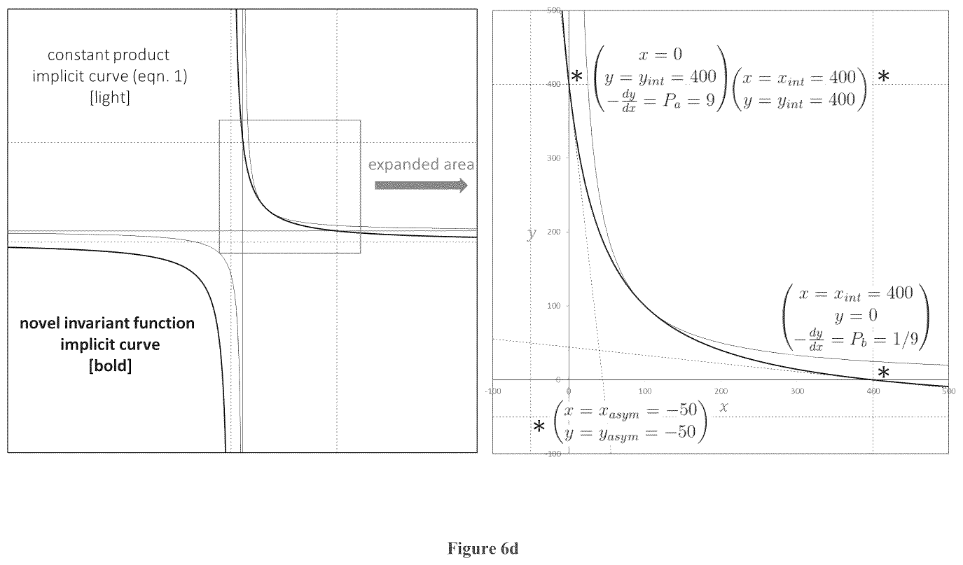

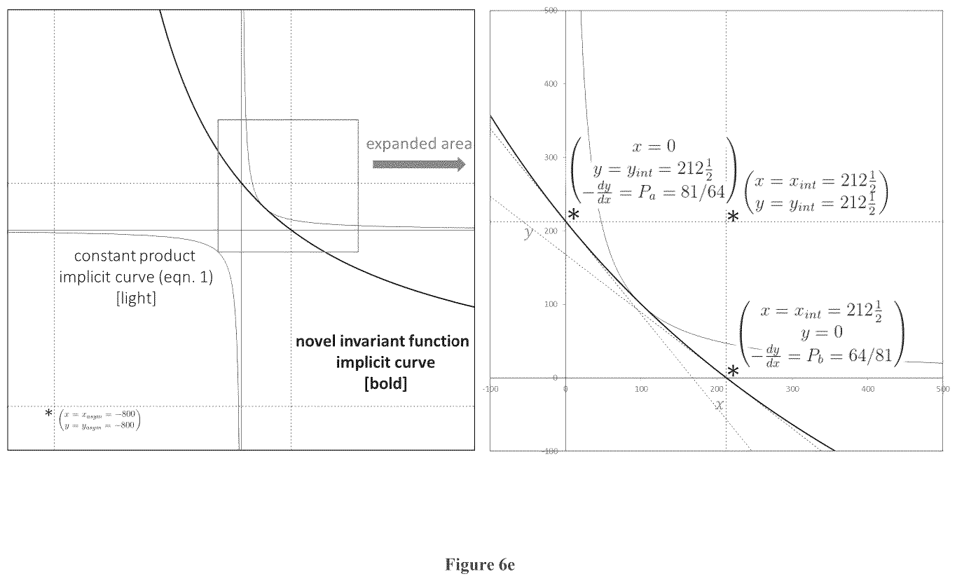

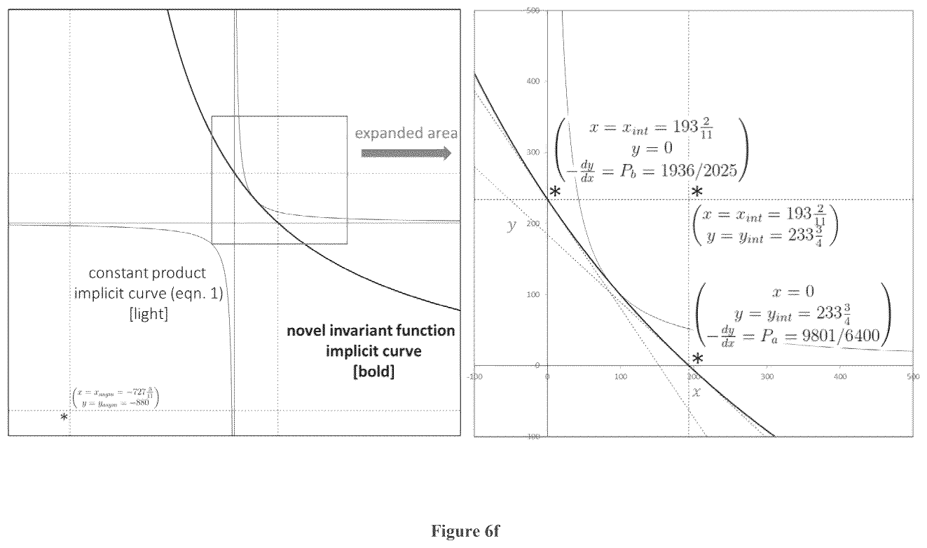

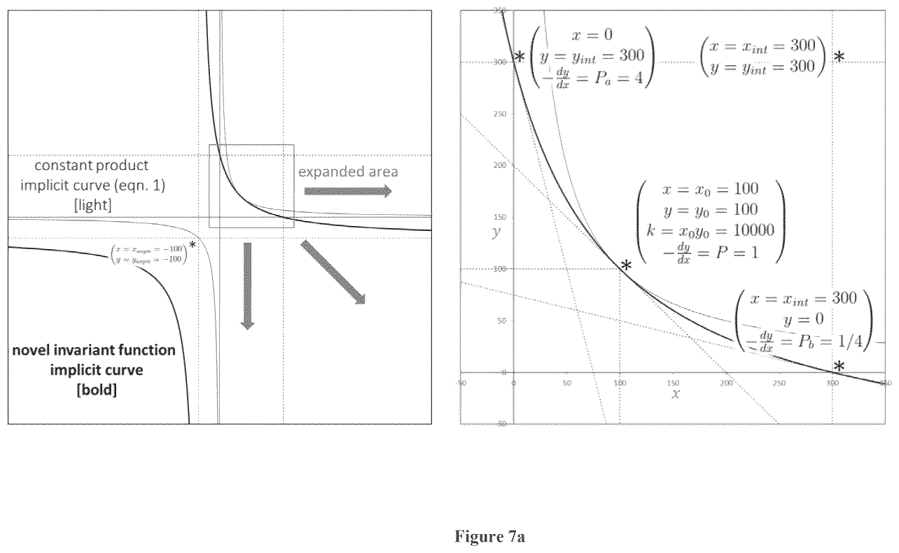

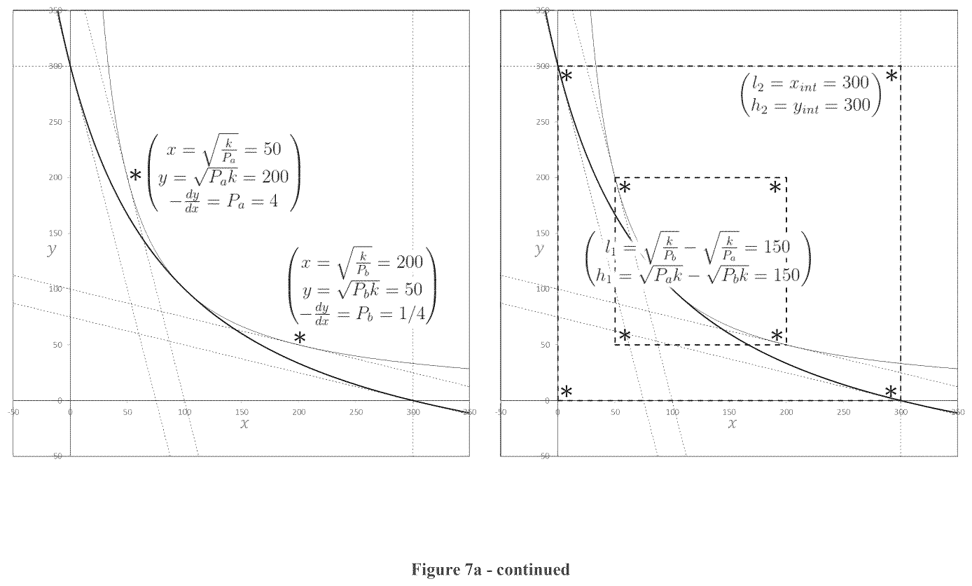

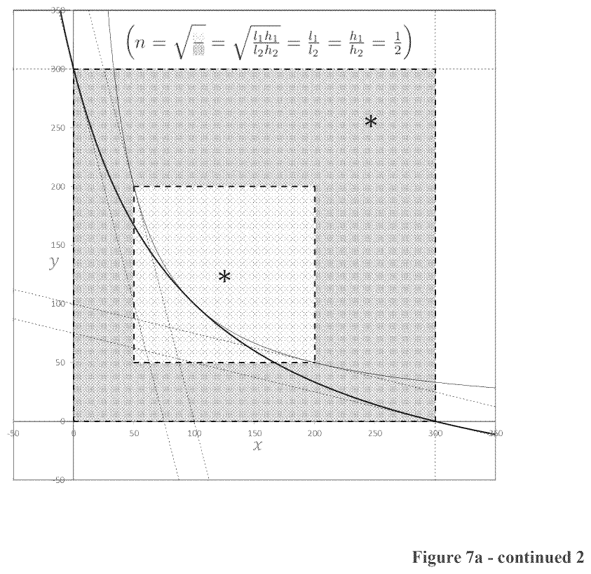

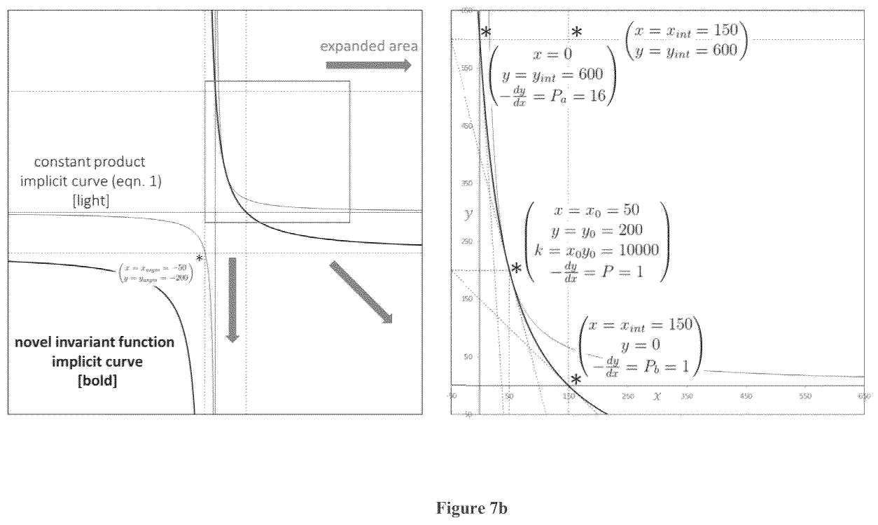

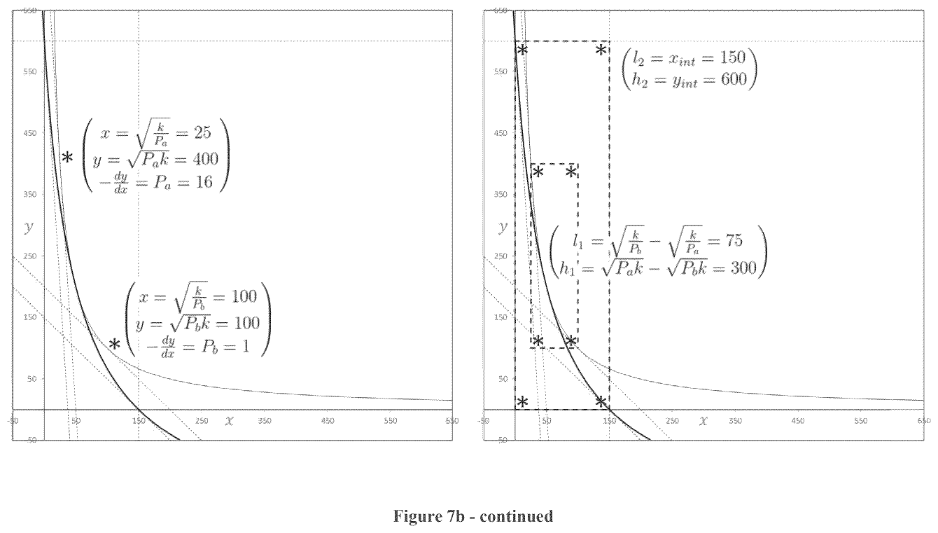

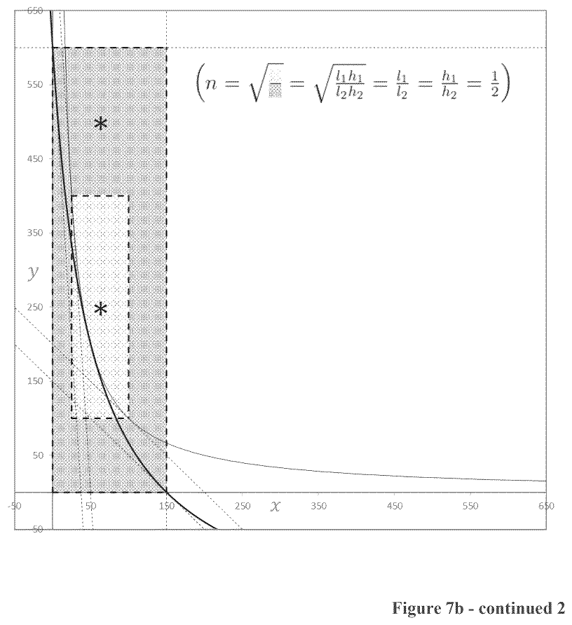

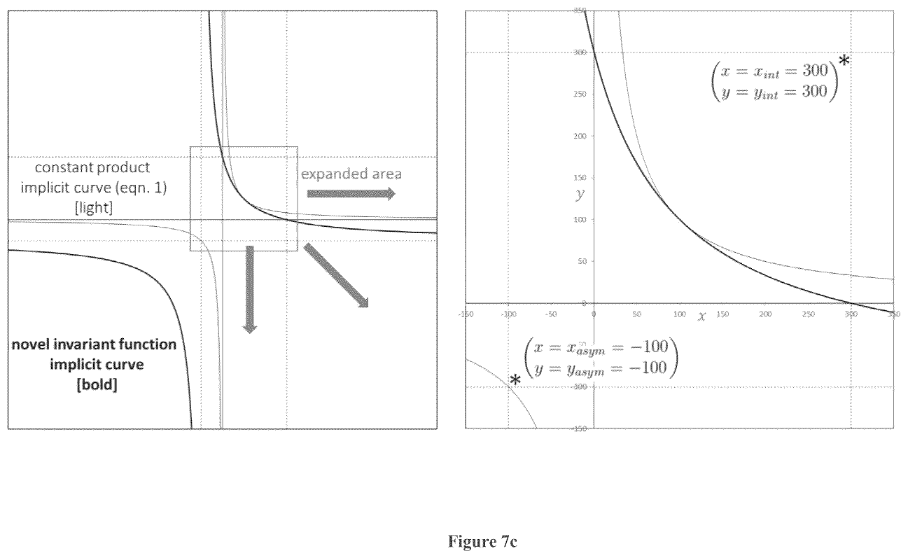

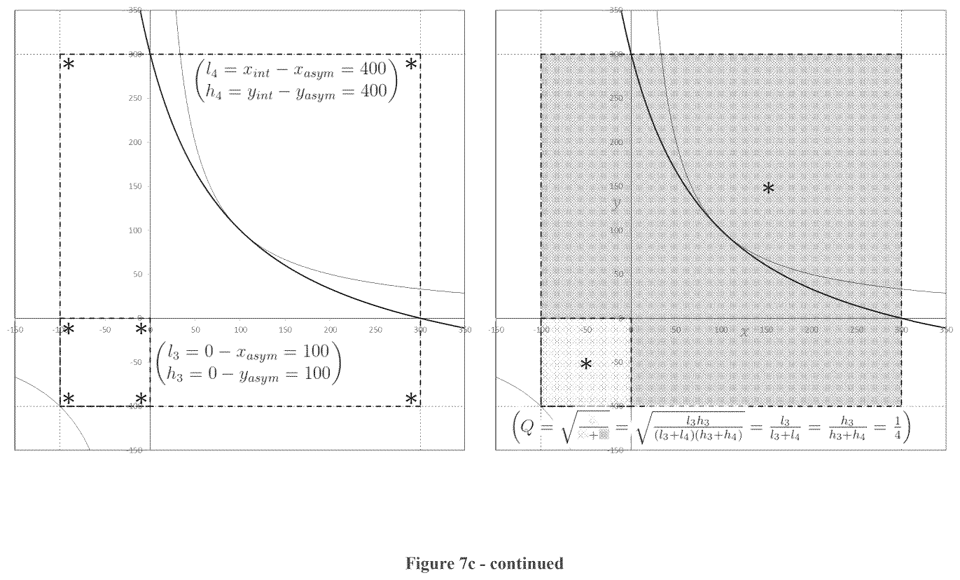

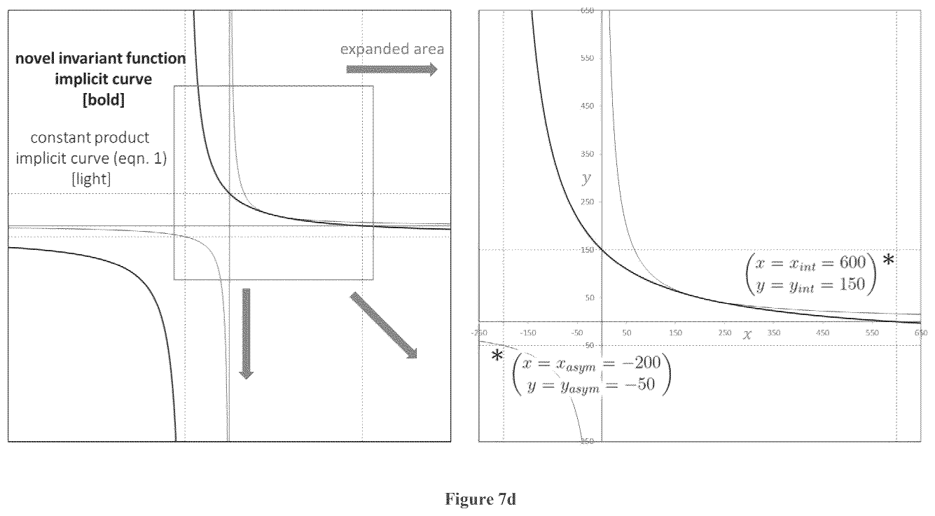

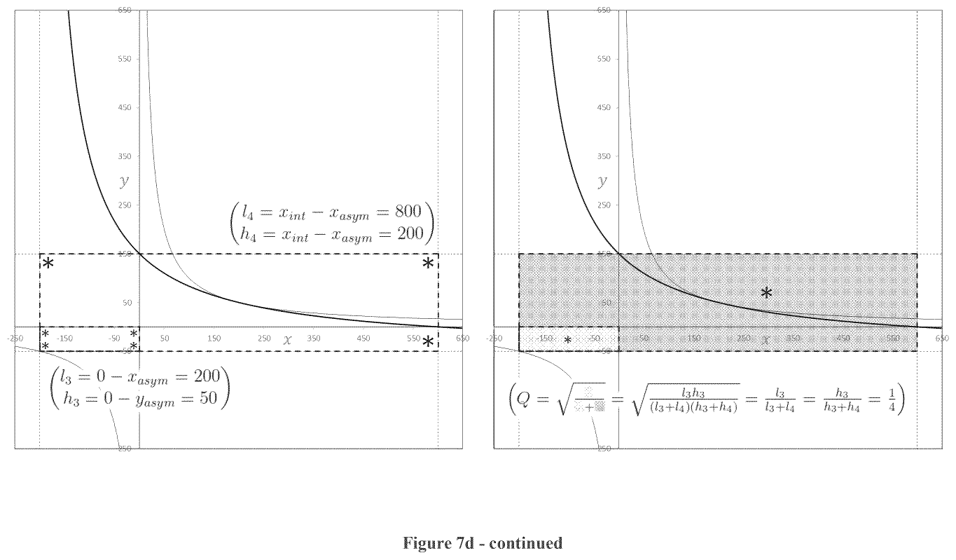

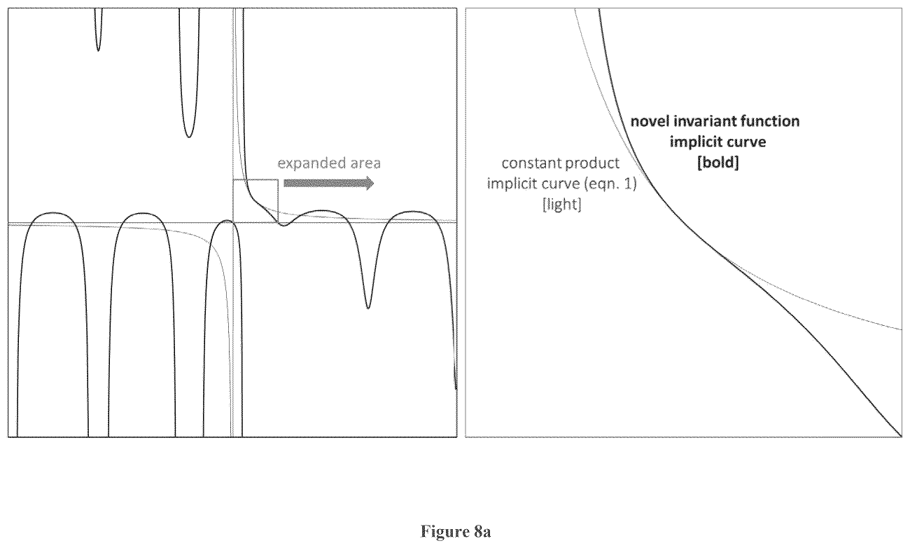

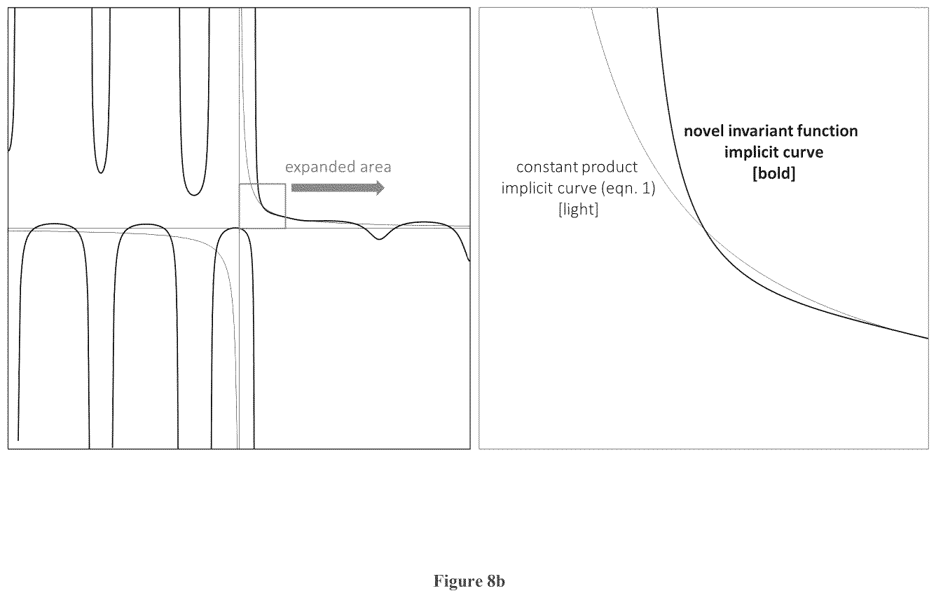

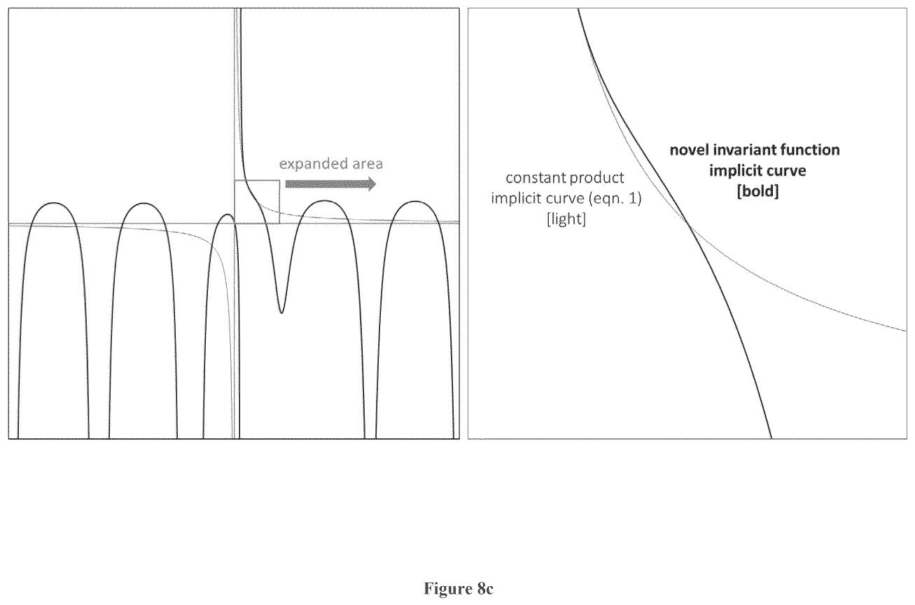

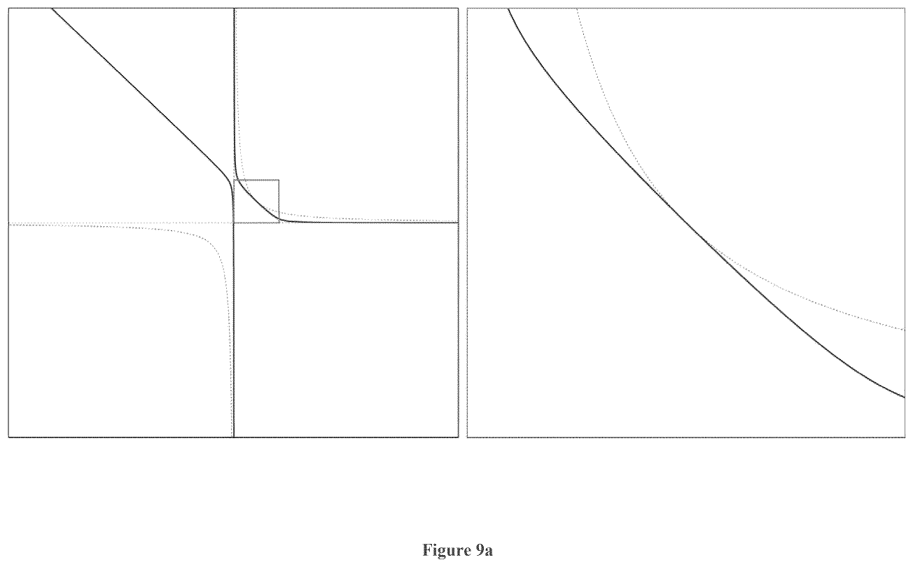

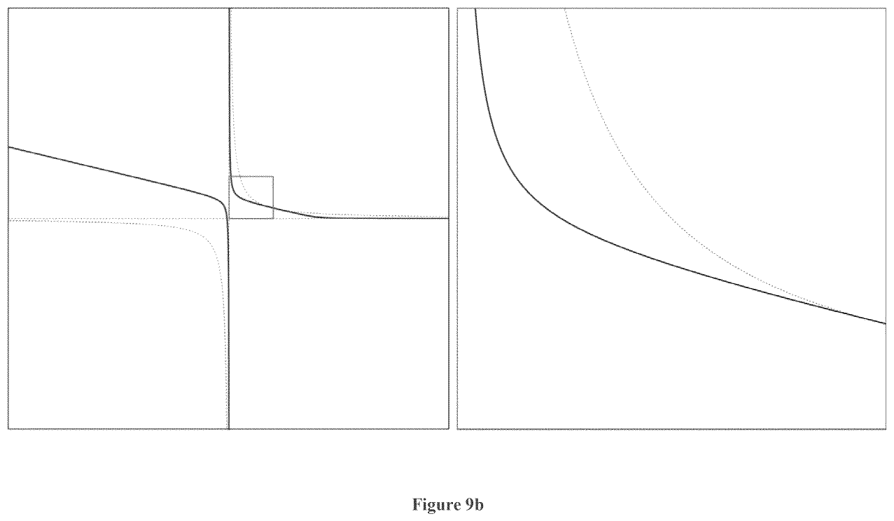

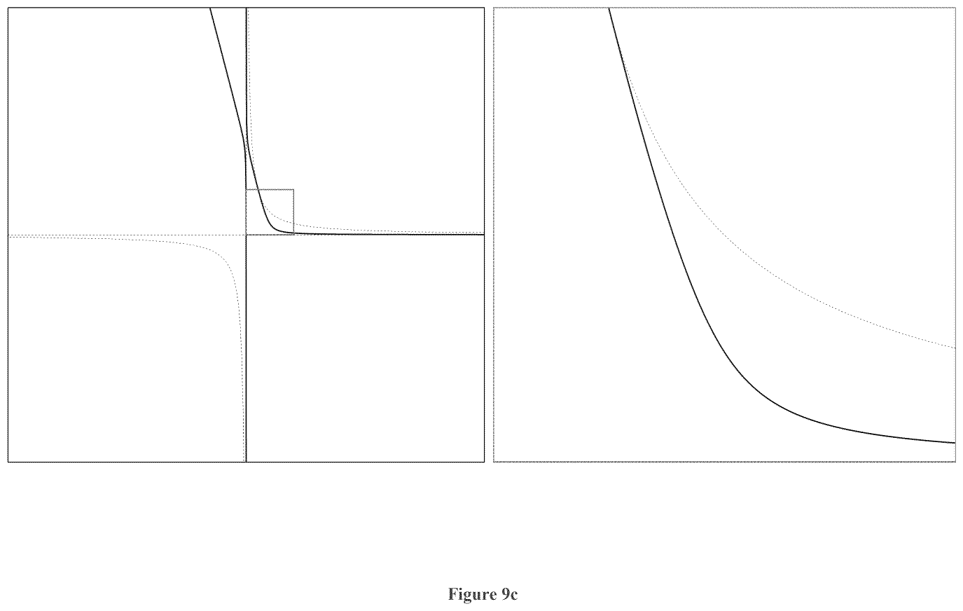

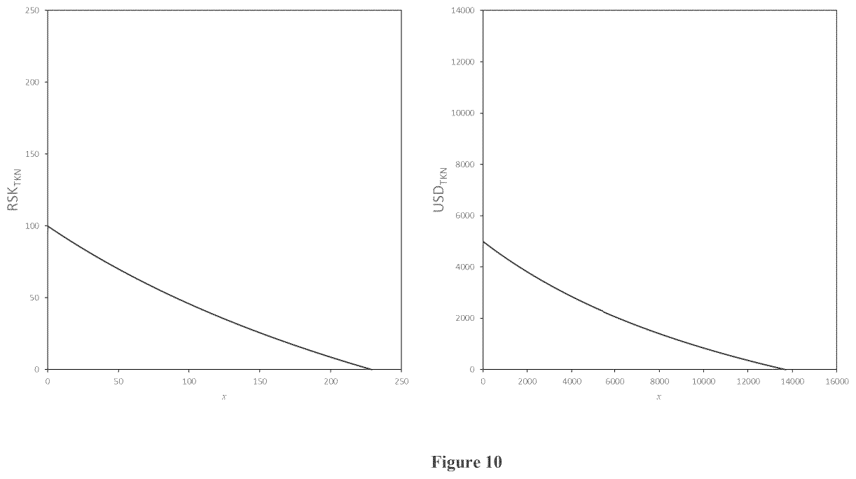

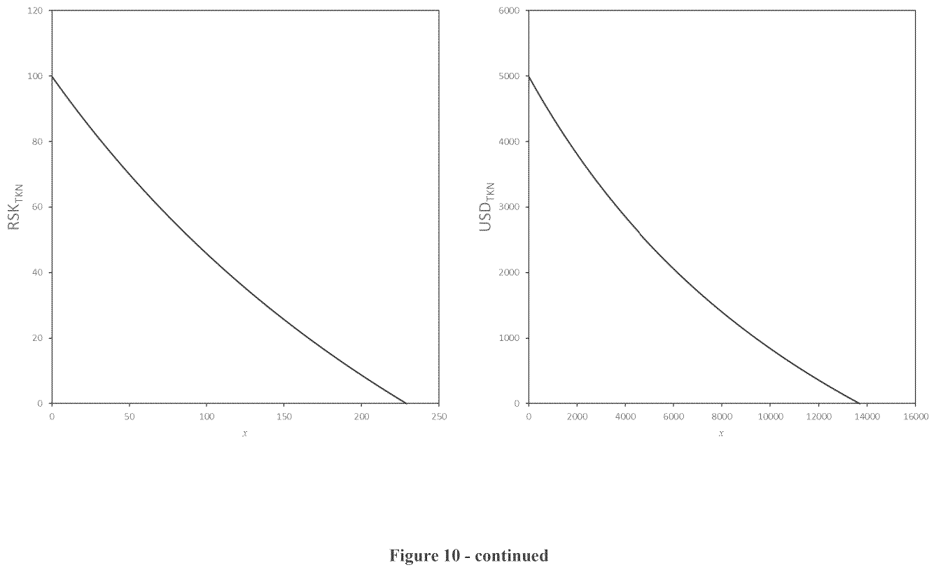

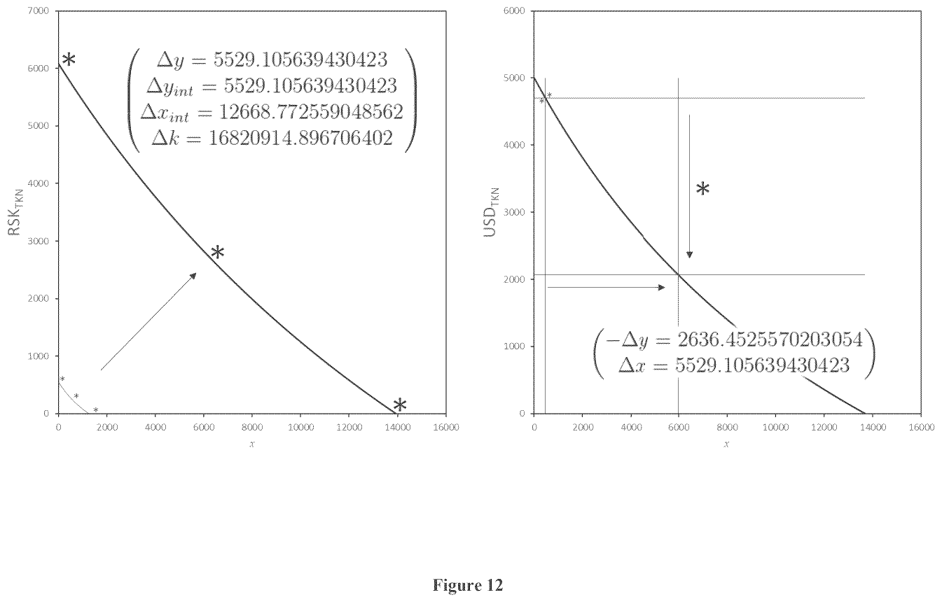

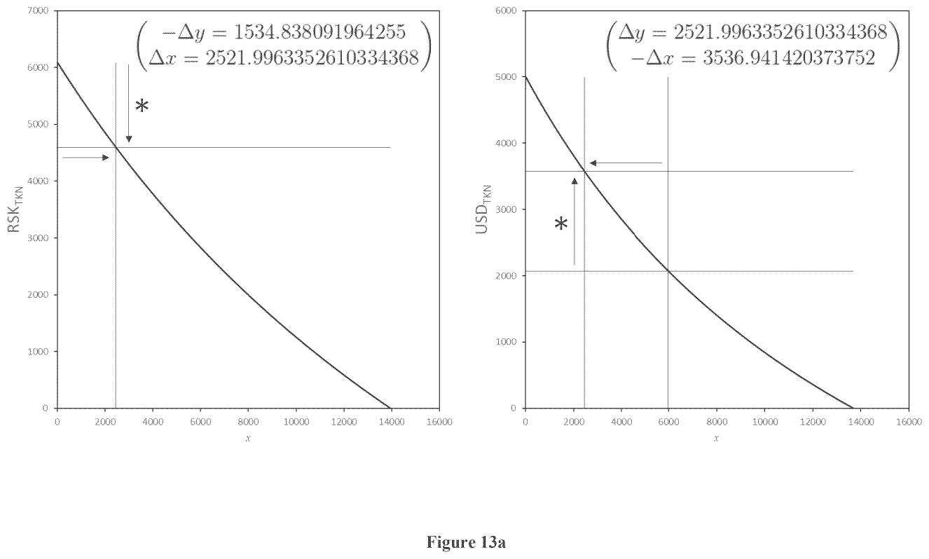

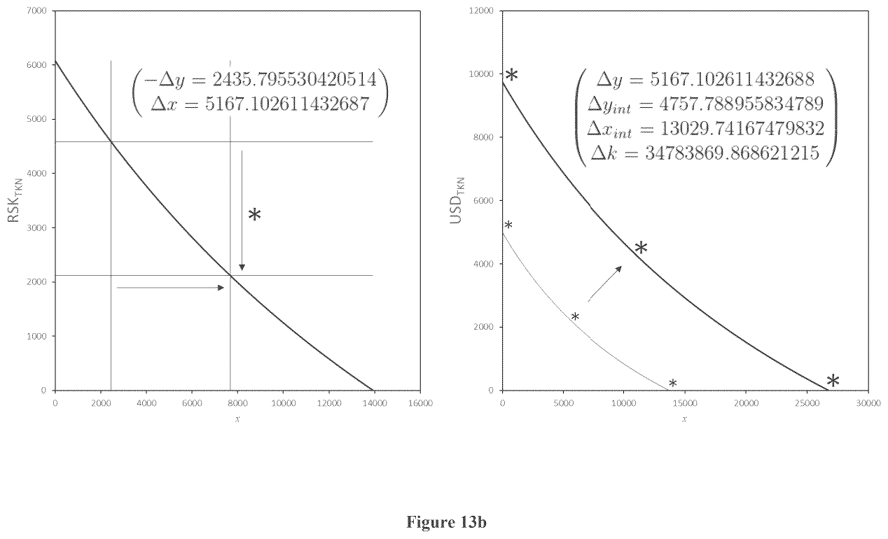

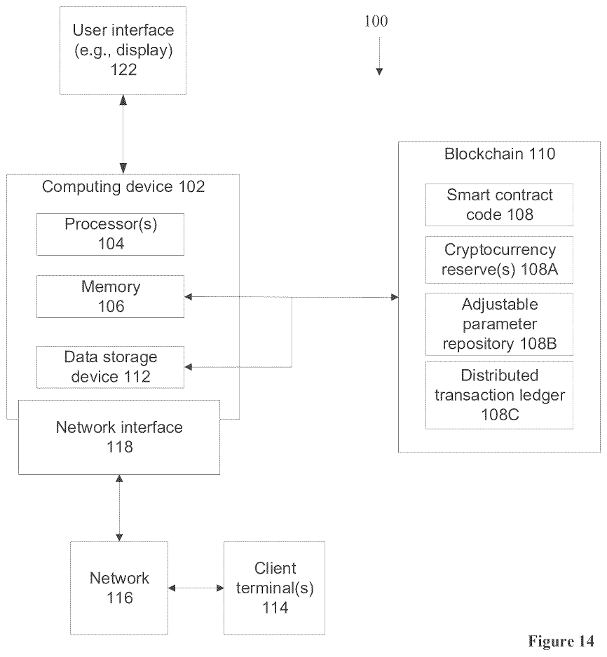

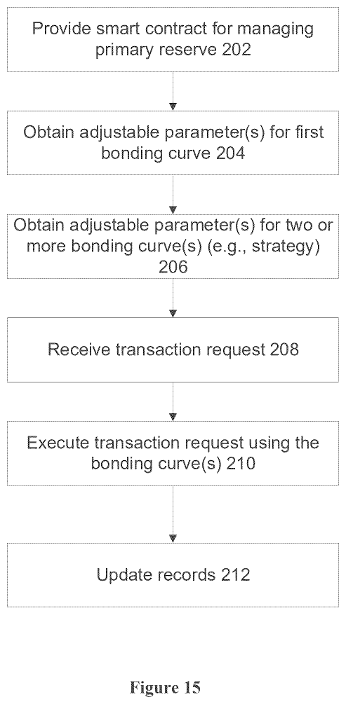

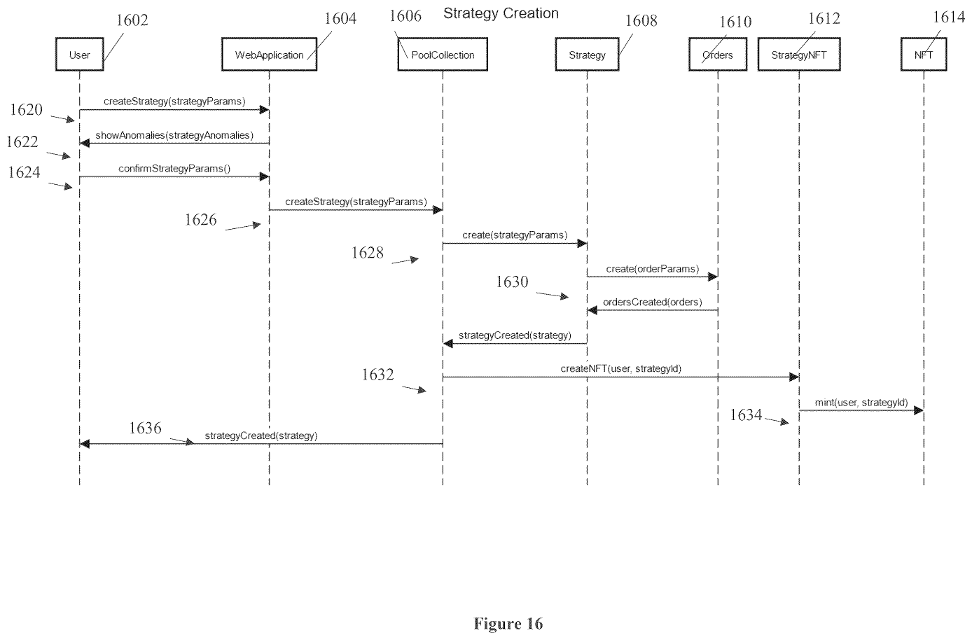

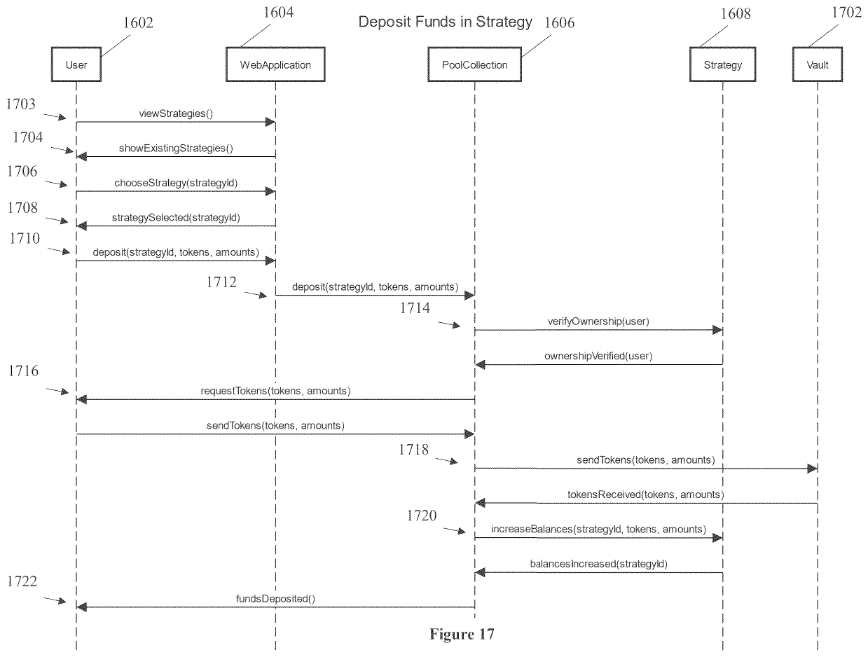

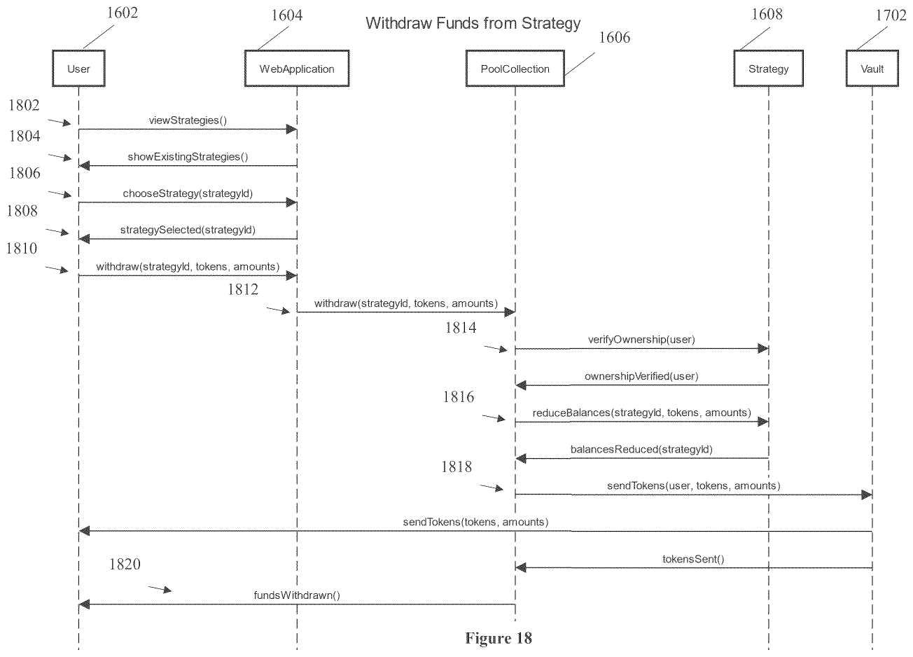

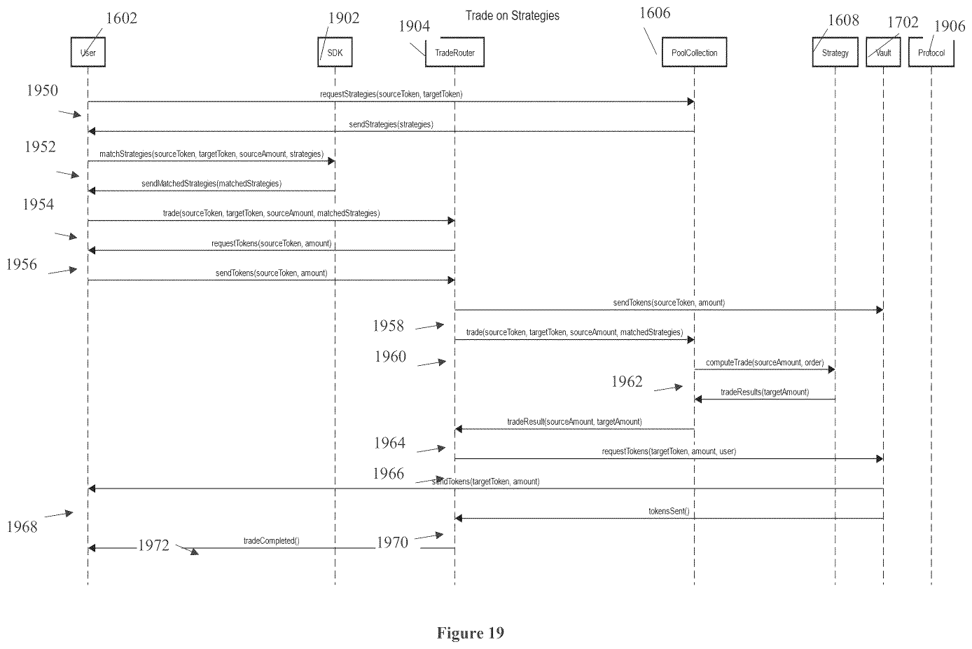

Reference is now made to FIGS. 1a-c, which are schematics depicting the invariant function characterized as having a point on its implicit curve with coordinates x=x₀, y=y₀, which coincide with the graph of eqns. 1a-c, in accordance with some embodiments of the present invention. Reference is also made to FIGS. 2a-c, which are schematics where the negated slope of the tangent line (−dy/dx) at this point is P and is equal in both implicit curves of the customizable function and eqns. 1d-e, in accordance with some embodiments of the present invention. Reference is also made to FIGS. 3a-g, which are schematics where the parameter k is the hyperbola constant of eqns. 1a-c, (i.e. xy=k), and denotes the magnitude of the constant product's implicit curve with which the implicit curve of the novel invariant function shares the coordinates x=x₀, y=y₀, in accordance with some embodiments of the present invention. Reference is also made to FIGS. 4a-1, which are schematics where the parameters x_{asym} and y_{asym} denote the “vertical” and “horizontal” asymptotes, respectively, of the novel function's implicit curve, in accordance with some embodiments of the present invention. Reference is also made to FIGS. 5a-g, which are schematics where the parameters xᵢₙₜ and yᵢₙₜ denote the x- and y-intercepts the novel function's implicit curve, in accordance with some embodiments of the present invention. Reference is also made to FIGS. 6a-f, which are schematics where the slope of the tangent lines at the y- and x-intercepts of the novel implicit curve, y=yᵢₙₜ and x=xᵢₙₜ, respectively, are denoted by the parameters Pₐ and P_{b}, respectively, in accordance with some embodiments of the present invention. Reference is also made to FIGS. 7a-b, which are schematics depicting exemplary methods of discovery of the parameters n, u that denote the relative size of two rectangles, in accordance with some embodiments of the present invention. Reference is also made to FIGS. 7c-d, which are schematics depicting an exemplary method for discovering the parameter Q, which denotes the relative size of two rectangles, in accordance with some embodiments of the present invention. Reference is also made to FIGS. 8a-c, which are schematics in which eqn. 22 substitutes n for f(x), in accordance with some embodiments of the present invention. Reference is also made to FIGS. 9a-c, which are schematics in which eqns. 23a-c substitute n for f(a, x, x₀, y, y₀), in accordance with some embodiments of the present invention. Reference is also made to FIG. 10, which is a schematic depicting a state before any exchanges are performed, of Alice's pristine strategy, in accordance with some embodiments of the present invention. Reference is also made to FIG. 11, which is a schematic depicting the difference in the relative changes to either half of Alice's strategy, in accordance with some embodiments of the present invention. Reference is also made to FIG. 12, which is a schematic depicting the difference in the relative changes to either half of Alice's strategy, in accordance with some embodiments of the present invention. Reference is also made to FIG. 13A, which is a schematic depicting accumulation of additional USD_{TKN} at the current price point that fills its cognate bonding curve from the bottom-up, slowly moving the reaccumulation target back towards the upper boundary, in accordance with some embodiments of the present invention. Reference is also made to FIG. 13B, which depicts graphs indicating the first case where Alice's balance of USD_{TKN} exceeds the yᵢₙₜ on its own curve, in accordance with some embodiments of the present invention. Reference is also made to FIG. 14, which is a diagram of components of a system for performing transactions of cryptocurrencies using one or more bonding curves with values for adjustable parameters of a function, in accordance with some embodiments of the present invention. Reference is also made to FIG. 15, which is a flowchart of a method for performing transactions of cryptocurrencies using one or more bonding curves with values for adjustable parameters of a function, in accordance with some embodiments of the present invention. Reference is also made to FIG. 16, which is a sequence diagram for creation of a strategy of two or more bonding curves for converting cryptocurrencies, in accordance with some embodiments of the present invention. Reference is also made to FIG. 17 is a sequence diagram for depositing funds using the strategy, in accordance with some embodiments of the present invention. Reference is also made to FIG. 18 is a sequence diagram for withdrawing funds using the strategy, in accordance with some embodiments of the present invention. Reference is also made to FIG. 19 is a sequence diagram for trading using the strategy, in accordance with some embodiments of the present invention.

Referring now back to FIG. 14, system 100 may implement the methods described with reference to FIGS. 1-13 and 15-19.

System 100 includes multiple computing devices 102 each acting as a respective network node (one computing device 102 acting as one network node shown for clarity and simplicity). Computing devices 102 may be geographically distributed. Exemplary implementations of computing devices 102 include, for example, a server, a computing cloud, a virtual machine, a virtual server, a client terminal, a desk top computer, a kiosk, a mobile device, a Smartphone, a Tablet computer, a laptop computer, a wearable computer, augmented reality glasses, a glasses computer, and a watch computer.

Each computing devices 102 includes one or more hardware processors 104, for example, a central processing unit(s) (CPU), a graphics processing unit(s) (GPU), field programmable gate array(s) (FPGA), digital signal processor(s) (DSP), and application specific integrated circuit(s) (ASIC). Processor(s) 104 may include one or more processors (homogenous or heterogeneous), which may be arranged for parallel processing, as clusters and/or as one or more multi core processing units.

Each computing devices 102 includes a memory 106 that stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM).

Memory 106 stores smart contract code 108 (also referred to as distributed smart contract code) that executes on a blockchain 110.

It is to be understood that the blockchain described herein in one example of a distributed application environment and/or distributed ledger, and other implementations of the distributed application environment and/or distributed ledger may be used as a directed acyclic graph.

Smart contract code 108 implements one or more features and/or acts of the method described with reference to FIGS. 1-13 and 15-19 when executed by hardware processor(s) 104. Smart contract code 108 manages one or more cryptocurrency reserves 108A, as described herein. Smart contract code 108 provides services for exchanging between the primary token and a secondary token, using a bonding curve defined by values of adjustable parameters of a function. The values for the adjustable parameters may be stored in an adjustable parameter repository 108B, which may be included in blockchain 110 and/or stored on another storage device such as off-line. Transactions executed by smart contract code 108 on reserve(s) 108A may be recorded in a distributed ledger 108C which may be stored on blockchain 110.

It is noted that different smart contracts 108 executing on the same computing device 102 and/or on different computing devices 102 may provide manage exchange services and/or deposit services and/or withdrawal services for different combinations of cryptocurrencies using different bonding curves. Optionally, each smart contract 108 manages at least a single reserve 108A that holds a single type of cryptocurrency, and exchanges between the tokens in the reserve and other tokens according to a bonding curve defined by values of adjustable parameters of a function, which may be stored in adjustable parameter repository 108B. The user may select the values of the adjustable parameters.

Optionally, a single smart contract 108 is implemented, where the reserves and bonding curves are components of the single contract. Alternatively, a set of smart contracts 108 is implemented, where the reserves and bonding curves are components of the set of smart contracts. Alternatively, each reserve and bonding curve are implemented using their own smart contract. A set of smart contracts is used for multiple reserves and related bonding curves. The single distributed smart contract executing on the blockchain may implement a different set of values for the adjustable parameters for a different instance of the function. The single distributed contract may implement each respective reserve of a certain token and a corresponding bonding curve defined by the function with the different set of values for the adjustable parameter defines a primitive for unidirectional exchange between an external token and the certain token of the respective reserve. Multiple primitives are linked to one another for defining unidirectional routes for token exchanges.

Computing devices 102 includes a data storage device 112 for storing data. Data storage device 112 may be implemented as, for example, a memory, a local hard-drive, virtual storage, a removable storage unit, an optical disk, a storage device, and/or as a remote server and/or computing cloud (e.g., accessed using a network connection). It is noted that one or more of blockchain 110, smart contract code 108, reserve 108A, adjustable parameter repository 108B, and/or ledger 108C, or portions thereof, may be stored in data storage device 112, and loaded from data storage device 112 into memory 106 for execution by processor(s) 104.

Computing devices 102 may act as network nodes which communicate with each other for updating their respective copies of blockchain 110 and/or distributed transaction ledger 108C.

Each computing device 102 provides token exchanges services, and/or token deposit services, and/or token withdrawal services to multiple client terminals 114 over a network 116.

Computing device 102 may include a network interface 118, for example, a network interface card, a wireless interface to connect to a wireless network, a physical interface for connecting to a cable for network connectivity, a virtual interface implemented in software, network communication software providing higher layers of network connectivity, and/or combinations of the aforementioned.

Network 116 may be implemented as, for example, the internet, a local area network, a virtual network, a wireless network, a cellular network, a local bus, a point-to-point link (e.g., wired), and/or combinations of the aforementioned.

Client terminal 114 may be implemented as, for example, a server, a computing cloud, a virtual machine, a virtual server, a desktop computer, a kiosk, a mobile device, a Smartphone, a Tablet computer, a laptop computer, a wearable computer, augmented reality glasses, a glasses computer, and a watch computer.

Client terminal 114, may access smart contract code 108 and/or interact with smart contract code 108 for performing transactions (e.g., exchange, deposit, withdrawal), for example, by accessible software interfaces of the smart contract function code 108, for example, using a graphical user interface (GUI), application programming interface (API), software development kit (SDK), and/or transmission of messages specifying certain functions for execution. Smart contract code 108 may be accessed directly, and/or indirectly via another application that accesses smart contract code 108 to perform transactions, for example, a wallet managing application.

Optionally, the client terminal 114 that provides the values for the adjustable parameters (e.g., stored in repository 108B) for defining the bonding curve, is different than other client terminals that use the bonding curve to perform exchanges.

Computing device 102 and/or client terminal(s) 114 include and/or are in communication with one or more physical user interfaces 122 that include a mechanism for a user to enter data (e.g., for performing a transaction with the primary and/or secondary tokens) and/or view data (e.g., view the results of the transaction). User interface 122 may present a GUI that includes the mechanism for entering data and/or viewing data. Exemplary user interfaces 122 include, for example, one or more of, a touchscreen, a display, gesture activation devices, a keyboard, a mouse, and voice activated software using speakers and microphone.

Referring now back to FIG. 15, at 202, one or more hardware processors of one or more network connected serves execute code of a distributed smart contract of a blockchain, for managing a primary reserve of tokens of a primary cryptocurrency.

It is noted that the term primary is used for clarity of explanation, for exchange between the primary tokens and secondary tokens, but is not meant to necessarily limit and/or define the primary tokens. For example, there may be multiple primary reserves, each of which may trade between an external token that may be referred to as secondary token and the respective primary token of the reserve.

Optionally, each primary reserve is managed independently without necessarily managing a secondary reserve of secondary tokens of a secondary cryptocurrency. The secondary reserve may be managed independently of the primary reserve, with a link defined between the primary reserve and the secondary reserve, for handing the transactions, as described herein. This is in contrast to standard approaches in which pairs of reserves are managed together, where trades between the two reserves are symmetrical, i.e., using the same exchange rates.

At 204, values of one or more adjustable parameters that define a function for computing an exchange rate for converting between the primary cryptocurrency and a secondary cryptocurrency, are obtained.

Optionally, a sub-set of adjustable parameters are selected from a candidate set of adjustable parameters. The selection may be done by the provided values, where adjustable parameters for which values are provided are selected, and/or adjustable parameters for which no values are provided are not selected (and/or the value may be set to zero or undefined).

As used herein, the phrases (selection of) values of the adjustable parameters and (selection of) the adjustable parameters are sometimes used interchangeably.

Optionally, multiple distributed smart contracts are executing on the blockchain. Each distributed smart contract may manage a different reserve of tokens. Each distributed smart contracts of each reserve may be associated with its own values for the adjustable parameters for defining its own bonding curves as a different instance of the function. The same adjustable parameters may be used for all related bonding curves, with different values for the different adjustable parameters.

Optionally, each respective reserve of a certain token and a corresponding bonding curve (i.e., defined by the function with the different set of values for the adjustable parameter) defines a primitive for unidirectional exchange between an external token and the certain token of the respective reserve. Multiple primitives are linked to one another for defining unidirectional routes for token exchanges. The multiple bonding curves (i.e., of multiple primitives) that are linked to one another for defining exchanges between multiple cryptocurrencies are referred to herein as a strategy.

For example, exchange between two tokens (A and B) is defined by two bonding curves-one for each token, each representing the sale of that token for the other in the pair. Essentially:
A→B
B→A

For a strategy of three different tokens (A, B and C), up to six bonding curves may be defined, where the user may define fewer than six bonding curves:
A→B
B→A
A→C
C→A
B→C
C→B

For a strategy of four different tokens (A, B, C, and D), up to twelve curves may be defined, where the user may define fewer than twelve bonding curves:
A→B
B→A
A→C
C→A
A→D
D→A
B→C
C→B
B→D
D→B
C→D
D→C

And so on. The maximal number of discrete bonding curves for any number of tokens is:
n=number of tokens
m=number of bonding curves
m=(2×n!)/(2×(n−2)!)

Selection of different values for the same adjustable parameters provides customization of the function for different users, and/or enables each user to define their own unilateral token conversion paths using the defined primitives.

For example, two different users may use different instances of the same smart contract, with the same types of tokens with different sets of adjustable parameters for the same function(s). The adjustable parameters enable the two different users to define different bonding curves, even when the same tokens are being traded. This is in contrast to prior approaches, where the two different users were restricted to using the same bonding curve, without the ability to customize adjustable parameters.

The values may be obtained, for example, from a client terminal (e.g. of a user) in communication with the network connected server, for example, via a user interface, optionally a graphical user interface (GUI), a file stored on a data storage device, and/or automatically computed.

Alternatively or additionally, the values may be automatically computed by an executing process. For example, when the parameters are for meeting hardware and/or software resource requirements, for execution of the smart contract, an executing process may automatically determine the resource requirements, and may automatically select the values for the adjustable parameters according to the determined resource requirements. The executing process may dynamically monitor performance of the executing smart contract (e.g., relative to a target performance level), and may dynamically adapt the values of the adjustable parameters in order for the executing process to meet and/or maintain the target performance level and/or the hardware and/or software resource requirements. The dynamic monitoring and/or dynamic adaptation may be performed, for example, after each transaction, after multiple transactions, after a time interval has elapsed (e.g., 1 hour, 1 day, 1 week, 1 month, and the like), and/or after an event (e.g., detecting an installation of software and/or hardware and/or other events that may affect performance).

The terms hardware and/or software resource requirements may refer to a target performance. For example the value for the adjustable parameters are computed for meeting a target performance (e.g., of the hardware and/or software resources).

Optionally, the adjustable parameters are selected for meeting hardware and/or software resource requirements (e.g., performance requirements) for execution of code of the distributed smart contract. Exemplary resource requirements include one or more of: calculation accuracy in the absence of floating-point arithmetic, overflow, underflow, unsigned integers, computational complexity, storage requirements, and memory requirements.

Optionally, each parameter is assigned to a set selected from multiple candidate sets. Each parameter of each set may be mathematically related to other parameters within the set and/or each parameter is mathematically related between sets of other parameters, which may be sufficient to unambiguously describe a unique invariant function-implicit curve pair.

The function may represent the (e.g., all) possible combinations of primary tokens and secondary tokens and exchange rates for converting between the primary token and the second token, in a single direction.

One of the x-axis and the y-axis represents a balance of the first reserve, and the other axis may be non-defined (e.g., meaningless, arbitrary). The other axis is not necessarily needed, since a marginal exchange rate for converting between the first cryptocurrency and the second cryptocurrency is computed according to a first derivative of the relevant bonding curve. The other axis is not necessarily needed for computation of the first derivative, and not necessarily needed to determine the marginal exchange rate. The bonding curve may represent (e.g., all) possible exchange rates for converting between the primary token and the second token.

The function may be defined with reference to a hyperbola with asymptotes at x=0 and y=0. The hyperbola may be represented as xy=k, where x denotes the primary token and y denotes the secondary token. The function may include one or more adjustable asymptotes. A graph of the function may shares at least one common point with a constant product bonding curve denoted as xy=k. A slope of the bonding curve at the one common point(s) may be identical with a first derivative of xy=k. Each bonding curve may be defined to have a point on its implicit curve at coordinates x=x₀ and y=y₀, where a first derivative is equal to that of the constant product bonding curve at the same coordinates.

The bonding curve may be defined as the implicit curve of the invariant function, which is used to enumerate a continuum of exchange rates between a primary cryptocurrency and a secondary cryptocurrency. Alternatively or additionally, the bonding curve may be defined as a secant line connecting two points of the function separated by a continuum of intermediate points. The bonding curve may be defined as a gradient of the secant line. The bonding curve may define multiple exchange rates for converting between the primary cryptocurrency and the secondary cryptocurrency. Each exchange rate for converting between the primary cryptocurrency and the secondary cryptocurrency may be represented as a secant line between two points of the function. A first point represents balance of the first reserve before the exchange occurred, and a second point represents balance of the first reserve after the exchange occurred.

The adjustable parameters may include a base set of adjustable parameters, for example:
n.
Pₐ denoting a start value of a range of exchange rates for converting from the primary cryptocurrency to the secondary cryptocurrency.
P_{b} denoting an end value of a range of exchange rates for converting from the primary cryptocurrency to the secondary cryptocurrency.
P denoting a gradient at x=x₀, y=y₀ indicating a geometric mean price.
Q
R
S denoting a difference of square roots of the gradients of the intercepts.
yᵢₙₜ denoting a balance of the primary tokens where the marginal exchange rate is equal to Pₐ.
xᵢₙₜ denoting, when the range commences with y=yᵢₙₜ, a balance of secondary tokens that is obtainable if the balance of the primary tokens is driven to zero.
x₀ denoting an x-coordinate at the geometric mean price.
y₀ denoting a y-coordinate at the geometric mean price.
x_{asym} denoting an x-asymptote or vertical asymptote.
y_{asym} denoting a y-asymptote or horizontal asymptote.
Geometric and/or algebraic reconstruction of the aforementioned.

The adjustable parameters are discussed herein in more detail.

Different values are assigned to the same set of the base parameters for different bonding curves implicitly defined by the function.

At 206, two or more bonding curves may be defined according to the function.

For simplicity and clarity of explanation, two bonding curves are described. However, it is to be understood that three or more bonding curves may be defined.

In the case of two bonding curves, the first bonding curve and the second bonding curve have common adjustable parameters with different values. The first bonding curve is defined by a first set of values of the adjustable parameters. The second bonding curve is defined by a second set of values of the adjustable parameters, which is different than the first set of values. Each bonding curve defines unidirectional conversion. The first bonding curve may define conversion from the primary cryptocurrency to the secondary cryptocurrency. The second bonding curve may define conversion from the secondary cryptocurrency to the primary cryptocurrency.

Once the bonding curves have been defined according to the values of the adjustable parameters, the bonding curves may be used to execute transactions.

At 208, a transaction request for converting between the primary tokens and secondary tokens of a secondary cryptocurrency is obtained, for example, from another client terminal (e.g., of another user) which may be different from the client terminal that provided the values of the adjustable parameters. The secondary tokens may be received by passive interaction with an outside market. The other client terminal may be used by another user looking to exchange tokens.

The transaction request for exchange using the function with applied parameters may be executed on the blockchain using fundamental math operations, for example: addition, subtraction, multiplication, and division. Other more complex math operations may be excluded, for example: Taylor series, polynomial approximation, and numeric methods of producing a function output. Two or more of the adjustable parameters may be computed off-blockchain. Using fundamental math rather than more complex math operations, and/or performing computations off-blockchain may improve computational efficiency of the processor, for example, reduced utilization of the processing resources, reduced memory utilization, and/or lower processing times.

At 210, the transaction request is executed using the bonding curve defined by the function with the values of the adjustable parameters. Two bonding curves may be used for execution of the full transaction request, where each bonding curve may be used independently, optionally based on feedback from the other bonding curve.

Execution of the transaction request may be performed in two stages, which may occur sequentially optionally in any order, and/or in parallel.

A case of the transaction request including an amount of secondary tokens which are to be converted to primary tokens is now considered. In a first stage, primary tokens may be automatically withdrawn from the primary reserve. The amount of primary tokens that are withdrawn in response to the provided amount of secondary tokens is computed according to the first exchange rate computed according to the first bonding curve. The primary tokens are provided, for example, to the client terminal of the user that sent the transaction request, deposited into a wallet of a user that sent the transaction request, and the like. In a second stage, the secondary tokens are automatically added to a secondary reserve according to the second bonding curve. The addition of the secondary tokens may impact a second exchange rate for converting from the secondary cryptocurrency to the primary cryptocurrency. The impact is computed according to the second bonding curve. As mentioned, the first stage and the second stage may be performed in a different order, such as the second stage followed by the first stage, and/or substantially in parallel.

Optionally, the transaction performed using the first bonding curve deterministically affects another transaction performed using the second bonding curve. The transaction performed using the first bonding curve includes the second stage, where the secondary tokens are automatically added to the secondary reserve according to the second bonding curve. The change in the amount of secondary tokens in the secondary reserve may impact the second exchange rate for future exchanges.

The secondary tokens received through via the first bonding curve are substantially immediately and automatically added to the secondary reserve according to the second bonding curve.

In another example, a case of the transaction request including an amount of primary tokens which are to be converted to secondary tokens is now considered. Since the bonding curves are directed to a specific conversion direction, the second bonding curve is used to determine the amount of secondary tokens. In the first stage, secondary tokens may be automatically withdrawn from the secondary reserve. The amount of secondary tokens that are withdrawn in response to the provided amount of primary tokens is computed according to the second exchange rate computed according to the second bonding curve. The secondary tokens are provided, for example, to the client terminal of the user that sent the transaction request, deposited into a wallet of a user that sent the transaction request, and the like. In the second stage, the primary tokens are automatically added to the primary reserve according to the primary bonding curve. The addition of the primary tokens may impact the primary exchange rate for converting from the primary cryptocurrency to the secondary cryptocurrency. The impact is computed according to the primary bonding curve. As mentioned, the first stage and the second stage may be performed in a different order, such as the second stage followed by the first stage, and/or substantially in parallel.

Optionally, the marginal exchange rate for converting between the first cryptocurrency and the second cryptocurrency is computed according to a first derivative of the relevant bonding curve.

At 212, records of the blockchain may be updated, to indicate the transaction and/or updated balances of the different tokens.

Referring now back to FIGS. 16-19, sequence diagrams for implementing embodiments described herein are depicted. FIG. 16 is a sequence diagram for creation of a strategy. FIG. 17 is a sequence diagram for depositing funds using the strategy. FIG. 18 is a sequence diagram for withdrawing funds using the strategy. FIG. 19 is a sequence diagram for trading using the strategy.

The sequence diagrams described with reference to FIGS. 16-19 may be based on methods described herein, for example, described with reference to FIG. 15 and/or implemented by components of the system described with reference to FIG. 14, and/or other features described herein. It is noted that each sequence diagram is exemplary, with optional data flows. Data flows may be adapted according to specific implementations.

With reference to FIG. 16, data flows (e.g., interactions) between a user 1602 (using a client terminal), a web application 1604 (e.g., running on a server(s)), a pool collection 1606 (smart contract), a strategy 1608, orders 1610, a strategy NFT (non-fungible token) 1612, and a NFT 1614, are described.

At 1620, strategy creation may begin with the user visiting the web application and choosing to create a (trading) strategy with a specific set of parameters. The trading strategy includes different values for the different adjustable parameters, for the different functions, where each function defines a unilateral exchange from one token to another token, as described herein.

At 1622, the application may compare the strategy parameters with existing market state that includes the existing strategies and existing market prices and attempts to identify anomalies that the user should consider when creating the strategy and presents these anomalies to the user. The user may then decide whether to proceed or not.

At 1624, once the user decides to proceed, the user may confirm the strategy creation through the web application.

At 1626, the main entry point on the blockchain for strategy creation may be the pool collection smart contract. In response to receiving a request to create a strategy for a specific user, the pool collection smart contract may validate the data and begins the strategy creation process, as follows:

At 1628, the orders defined by the strategy parameters may be created. Each order is defined with its own bonding curve, which defines a transaction in a certain direction.

At 1630, the strategy owner may be marked as the user who sent the request.

At 1632, a unique identifier for the specific strategy may be created.

At 1634, an NFT that represents the strategy and associates the strategy unique identifier with the new NFT, may be created. The new NFT may be transferred to the user who owns the new strategy.

At 1636, a confirmation that the action is complete may be provided.

With reference to FIG. 17, data flows (e.g., interactions) between user 1602 (using a client terminal), web application 1604 (e.g., running on a server(s)), pool collection 1606 (smart contract), strategy 1608, and vault 1702, are described for depositing funds according to the strategy.

At 1703, the user may view the existing strategies page on the web application.

At 1704, the web application may provide a list of the existing strategies created by the user.

At 1706, the user may select a specific strategy.

At 1708, once the user selects the strategy, the web application may open a page that allows the user to manage the strategy. One of the options on that page may be to deposit funds into the strategy.

At 1710, the user may select the deposit funds option, input the tokens/amounts to deposit, and may confirm the action.

At 1712, the main entry point on the blockchain for depositing funds into a strategy is the pool collection smart contract. In response to receiving a request to deposit funds into a strategy for a specific user, the pool collection smart contract may validate the data and may begin the depositing process as follows:

At 1714, the pool collection smart contract may verify that the user who requested the deposit is the actual owner of the strategy.

At 1716, the pool collection smart contract may withdraw the given token amounts from the user.

At 1718, the pool collection smart contract may deposit the token balances into the vault that holds all funds.

At 1720, the pool collection smart contract may increase the balances of the specific given strategy by the token amounts provided.

At 1722, pool collection smart contract may confirm that the action is complete.

With reference to FIG. 18, data flows (e.g., interactions) between user 1602 (using a client terminal), web application 1604 (e.g., running on a server(s)), pool collection 1606 (smart contract), strategy 1608, and vault 1702, are described for depositing funds according to the strategy.

At 1802, the user may view the existing strategies page on the web application.

At 1804, the web application may provide a list of the existing strategies created by the user.

At 1806, the user may select a specific strategy.

At 1808, once the user selects that strategy, the web application may open a page that allows the user to manage the strategy. One of the options on that page may be to withdraw existing funds from the strategy.

At 1810, the user may select the withdrawal option, input the tokens/amounts to withdraw, and may confirms the action.

At 1812, the main entry point on the blockchain for withdrawing funds from a strategy is the pool collection smart contract. In response to receiving a request to withdraw funds from a strategy for a specific user, the pool collection smart contract may validate the data and may begin the withdrawal process as follows:

At 1814, the pool collection smart contract may verify that the user who requested the withdrawal is the actual owner of the strategy.

At 1816, the pool collection smart contract may reduce the balances of the specific given strategy by the token amounts provided.

At 1818, the pool collection smart contract may instruct the vault, which holds all user funds, to transfer the given amounts of tokens to the user.

At 1820, the pool collection smart contract may confirm that the action is complete.

With reference to FIG. 19, data flows (e.g., interactions) between user 1602 (using a client terminal), a software develop kit (SDK) 1902, a trade router 1904, pool collection 1606 (smart contract), strategy 1608, vault 1702, and protocol 1906 are described for trading funds according to the strategy.

At 1950, the user may view the open strategies in the protocol and/or evaluate whether a trade for the required amount is possible. Existing open strategies that are relevant to the specific pair of tokens the user would like to trade may be requested.

At 1952, the user may send the list of strategies to the SDK. The user may request that the SDK attempts to match the trade requirements (e.g., source token, target token, amount) against the list of strategies. The SDK may attempt to find the ideal list of strategies that the trade can use, i.e., the list of strategies that are predicted to provide the user with the best trade outcome.

At 1954, once the list is generated, the user may request from the trade router to execute the trade. The user may provide the list of strategies received from the SDK as an input for the trade. This begins the trade process which may proceed as follows:

At 1956, the trade router may withdraw tokens used for the trade from the user.

At 1958, the trade router may deposit the tokens into the vault which holds all funds.

At 1960, the trade router may request the pool collection to execute the trade and provides the list of matched strategies.

At 1962, the pool collection may iterate through the list of strategies. For each strategy in the list of given strategies, the following may be performed: calculating the result of a trade for the specific strategy, verifying that the strategy has enough balance to accommodate the trade, updating the new balances in the strategy, and returning the trade result amount.

At 1964, once the trade is performed against all the provided strategies, the pool collection may notify the trade router with the trade result.

At 1966, the trade router may request from the vault (which holds all funds) to send the target tokens to the user, with an amount equal to the trade result.

At 1968, the vault may send the target tokens to the user.

At 1970, the vault may notify the trade router that the tokens were sent.

At 1972, the trade router may confirms that the trade is complete.

Additional exemplary details of the adjustable parameter(s) that define the function(s) described herein are now described.

The x and y terms in equations below denote balances of two assets with which an exchange will, or can, be performed. The x and y balances may be hypothetical, virtual, or real, and may represent any fungible, tokenized form of value on a distributed ledger, including but not necessarily limited to blockchains and directed acyclic graphs. The customizable function described in the following equations, and herein, is necessarily defined with reference to the constant product function-a hyperbola with asymptotes at x=0 and y=0.

The implicit curve of the constant product function, described for example with reference to Patent '923, may be written as xy=k (eqn. 1a), or via its rearrangements (eqns. 1b-c). In the context of token balances in an associated smart contract, where this function is employed to perform exchange, its first derivative (eqns. 1d-e) can be used to evaluate the instantaneous rate, or exchange value, between any two tokens under its influence. A secant line connecting two points of the implicit curve, separated by a continuum of intermediate points, determines the absolute change in the smart contract holdings of the tokens represented by x and y (eqns. 1f-g). Therefore, the realized rate of exchange between any two tokens by a user of the system may be derived (eqns. 1 h-i).

$$xy = k \qquad eqn . 1 a$$

$$y = \frac{k}{x} \qquad eqn . 1 b$$

$$x = \frac{k}{y} \qquad eqn . 1 c$$

$$- \frac{dy}{dx} = \frac{k}{{x}^{2}} \qquad eqn . 1 d$$

$$- \frac{dy}{dx} = \frac{{y}^{2}}{k} \qquad eqn . 1 e$$

$$- Δ y = \frac{Δ xk}{x ( Δ x + x )} \qquad eqn . 1 f$$

$$- Δ y = \frac{Δ {xy}^{2}}{Δ xy + k} \qquad eqn . 1 g$$

$$- \frac{Δ y}{Δ x} = \frac{{y}^{2}}{Δ xy + k} \qquad eqn . 1 h$$

$$- \frac{Δ y}{Δ x} = \frac{k}{x ( Δ x + x )} \qquad eqn . 1 i$$

At least some embodiments described herein are based on the concepts defined by the equations above. In the following sections, where the properties of the customizable invariant function are disclosed in detail, it may be appropriate to let each term be handled entirely in abstraction. Additional and more specific details with respect to the embodiments related to exchange of tokens are discussed herein.

What follows is a full mathematical elaboration of the customizable invariant function, its bonding curves, and properties. The list of terms used to describe the function appears in Table 1; the equations wherein these terms are used are presented thereafter. The equations define each of these terms in the context of the customizable function and its associated curves set; the graphical representations of these same mathematical concepts are depicted in example figures thereafter.

TABLE 1
Glossary of terms used to describe and characterize the
novel invariant function disclosed herein.

| Variable | Meaning |
|---|---|
| x | Pool state variable; virtual risk asset liquidity |
| y | Pool state variable; virtual numeraire liquidity |
| n | Curve parameter |
| u | Curve parameter |
| k | Curve parameter |
| B | Curve parameter; square root of the gradient at x = xᵢₙₜ, y = 0 |
| P | Curve parameter; gradient at x = x₀, y = y₀ (geometric mean price) |
| Q | Curve parameter |
| R | Curve parameter |
| S | Curve parameter; difference of square roots of the gradients at the |
| | intercepts. |
| x₀ | Curve parameter; x-coordinate (risk asset) at geometric mean price |
| y₀ | Curve parameter; y-coordinate (numeraire) at geometric mean price |
| x_{asym} | Curve parameter; x-asymptote, or vertical asymptote (risk asset) |
| y_{asym} | Curve parameter; y-asymptote, or horizontal asymptote (numeraire) |
| Pₐ | Curve parameter; gradient at x = 0, y = yᵢₙₜ (price at high bound) |
| P_{b} | Curve parameter; gradient at x = xᵢₙₜ, y = 0 (price at low bound) |
| xᵢₙₜ | Curve parameter; x-coordinate at y = 0 (x-intercept of the risk asset) |
| yᵢₙₜ | Curve parameter; y-coordinate at x = 0 (y-intercept of the numeraire) |

The customizable function described herein may be an improvement of the general liquidity amplification described with reference to “SMART CONTRACT OF A BLOCKCHAIN FOR MANAGEMENT OF CRYPTOCURRENCIES” (Patent '896), which describes a virtually amplified amount of token reserves obtained by multiplying the initial staked values (x₀, y₀) by an amplification value (1/n, or u), for the specific case where there are only two token reserves with reserve ratios of one-half. Therefore:
1) A function with arbitrary, or adjustable asymptotes, and
2) Where the graph of the function shares at least one common point with eqns. 1a-c., and
3) Where the slope of the curve at the common point is identical with eqns. 1d-e.

This definition is now elaborated. The relationship between x and y is under the influence of the invariant function, which can be written in many equivalent forms. The content provided herein is submitted as a representative sample that is not necessarily limiting. Therefore, the explicit forms that appear below include, but do not limit the scope of the described embodiments. A representative set of novel invariant functions appears in eqns. 2a-p, and examples of its algebraic manipulation into equivalent forms appear later in the disclosure. In addition to the two variables, x and y, the function is adequately defined with respect to a minimum of three parameters from the set n, u, k, P, Q, x₀, y₀, x_{asym}, y_{asym}, xᵢₙₜ, and yᵢₙₜ. The function may also be defined with respect to the parameters Pₐ and P_{b}, in addition to other rearrangements of these parameters, which is subject to further discussion herein.

$$k = \frac{{x}_{0} y ( nx + {x}_{0} ( 1 - n ) )}{{x}_{0} ( 2 - n ) - x ( 1 - n )} = \frac{{xy}_{0} ( ny + {y}_{0} ) ( 1 - n ) )}{{y}_{0} ( 2 - n ) - y ( 1 - n )} \qquad eqn . 2 a$$

$$P = \frac{y ( nx + {x}_{0} ( 1 - n ) )}{{x}_{0} ( {x}_{0} ( 2 - n ) - x ( 1 - n ) )} = \frac{{y}_{0} ( {y}_{0} ( 2 - n ) - y ( 1 - n ) )}{x ( ny + {y}_{0} ( 1 - n ) )} \qquad eqn . 2 b$$

$$eqn . 2 c$$

$$Q = \frac{{( xy - {x}_{0} {y}_{0} )}^{2}}{{( x - {x}_{0} )}^{2} {( y - {y}_{0} )}^{2}} = \frac{{x}_{asym} {y}_{asym}}{( x - {x}_{asym} ) ( y - {y}_{asym} )} = \frac{xy}{( x - {x}_{int} ) ( y - {y}_{int} )}$$

$${x}_{0} ( {y}_{0} ( 2 - n ) - y ( 1 - n ) ) = x ( ny + {y}_{0} ( 1 - n ) ) \qquad eqn . 2 d$$

$${y}_{0} ( {x}_{0} ( 2 - n ) - x ( 1 - n ) ) = y ( nx + {x}_{0} ( 1 - n ) ) \qquad eqn . 2 e$$

$${x}_{0} {y}_{0} = ( nx + {x}_{0} ( 1 - n ) ) ( ny + {y}_{0} ( 1 - n ) ) \qquad eqn . 2 f$$

$$xy = ( 1 - n ) ( x - {x}_{0} ) ( y - {y}_{0} ) + {x}_{0} {y}_{0} \qquad eqn . 2 g$$

$$xy = ( 1 - n ) ( x - {x}_{0} ) ( y - {y}_{0} ) + {x}_{0} {y}_{0} \qquad eqn . 2 h$$

$${x}_{asym} {y}_{asym} = {( 1 - n )}^{2} ( x - {x}_{asym} ) ( y - {y}_{asym} ) \qquad eqn . 2 i$$

$$xy = {( 1 - n )}^{2} ( x - {x}_{int} ) ( y - {y}_{int} ) \qquad eqn . 2 j$$

$${x}_{0} ( {y}_{0} ( \sqrt{Q} + 1 ) - y \sqrt{Q} ) = x ( y ( 1 - \sqrt{Q} ) + {y}_{0} \sqrt{Q} ) \qquad eqn . 2 k$$

$${y}_{0} ( {x}_{0} ( \sqrt{Q} + 1 ) - x \sqrt{Q} ) = y ( x ( 1 - \sqrt{Q} ) + {x}_{0} \sqrt{Q} ) \qquad eqn . 2 l$$

$${x}_{0} {y}_{0} = ( x ( 1 - \sqrt{Q} ) + {x}_{0} \sqrt{Q} ) ( y ( 1 - \sqrt{Q} ) + {y}_{0} \sqrt{Q} ) \qquad eqn . 2 m$$

$$xy = ( {x}_{0} ( \sqrt{Q + 1} ) - x \sqrt{Q} ) ( {y}_{0} ( \sqrt{Q} + 1 ) - {y}_{0} \sqrt{Q} ) \qquad eqn . 2 n$$

$$xy = \sqrt{Q} ( x - {x}_{0} ) ( y - {y}_{0} ) + {x}_{0} {y}_{0} \qquad eqn . 2 o$$

$$xy = Q ( x - {x}_{int} ) ( y - {y}_{int} ) \qquad eqn . 2 p$$

Other forms of the invariant function include its various rearrangements, including and especially those which force either the y- or x-coordinates to be the subject (eqns. 3a-n and 4a-n, respectively).

$$y = \frac{k ( {x}_{0} ( 2 - n ) - x ( 1 - n ) )}{{x}_{0} ( nx + {x}_{0} ( 1 - n ) )} \qquad eqn . 3 a$$

$$y = \frac{{y}_{0} ( k ( 2 - n ) - {xy}_{0} ( 1 - n ) )}{k ( 1 - n ) + {nxy}_{0}} \qquad eqn . 3 b$$

$$y = \frac{{Px}_{0} ( {x}_{0} ( 2 - n ) - x ( 1 - n ) )}{nx + {x}_{0} ( 1 - n )} \qquad eqn . 3 c$$

$$y = \frac{{y}_{0} ( {y}_{0} ( 2 - n ) - Px ( 1 - n ) )}{Pnx + {y}_{0} ( 1 - n )} \qquad eqn . 3 d$$

$$y = \frac{{y}_{0} ( {x}_{0} ( 2 - n ) - x ( 1 - n ) )}{nx + {x}_{0} ( 1 - n )} \qquad eqn . 3 e$$

$$y = \frac{{y}_{asym} ( {x}_{asym} + {( 1 - n )}^{2} ( x - {x}_{asym} ) )}{{( 1 - n )}^{2} ( x - {x}_{asym} )} \qquad eqn . 3 f$$

$$y = \frac{{{y}_{int} ( 1 - n )}^{2} ( {x}_{int} - x )}{x - {( 1 - n )}^{2} ( x - {x}_{int} )} \qquad eqn . 3 g$$

$$y = \frac{k ( {x}_{0} ( \sqrt{Q} + 1 ) - x \sqrt{Q} )}{{x}_{0} ( ( 1 - \sqrt{Q} ) x + {x}_{0} \sqrt{Q} )} \qquad eqn . 3 h$$

$$y = \frac{{y}_{0} ( k ( \sqrt{Q} + 1 ) - {xy}_{0} \sqrt{Q} )}{k \sqrt{Q} + ( 1 - \sqrt{Q} ) {xy}_{0}} \qquad eqn . 3 i$$

$$y = \frac{{Px}_{0} ( {x}_{0} ( \sqrt{Q} + 1 ) - x \sqrt{Q} )}{x ( 1 - \sqrt{Q} ) + {x}_{0} \sqrt{Q}} \qquad eqn . 3 j$$

$$y = \frac{{y}_{0} ( {y}_{0} ( \sqrt{Q} + 1 ) - Px \sqrt{Q} )}{P ( 1 - \sqrt{Q} ) x + {y}_{0} \sqrt{Q}} \qquad eqn . 3 k$$

$$y = \frac{{y}_{0} ( {x}_{0} ( \sqrt{Q} + 1 ) - x \sqrt{Q} )}{x ( 1 - \sqrt{Q} ) + {x}_{0} \sqrt{Q}} \qquad eqn . 3 l$$

$$y = \frac{{y}_{asym} ( {x}_{asym} + Q ( x - {x}_{asym} ) )}{Q ( x - {x}_{asym} )} \qquad eqn . 3 m$$

$$y = \frac{{y}_{int} Q ( {x}_{int} - x )}{x - Q ( x - {x}_{int} )} \qquad eqn . 3 n$$

$$x - \frac{{x}_{0} ( k ( 2 - n ) - {x}_{0} y ( 1 - n ) )}{k ( 1 - n ) + {nx}_{0} y} \qquad eqn . 4 a$$

$$x = \frac{k ( {y}_{0} ( 2 - n ) - y ( 1 - n ) )}{{y}_{0} ( ny + {y}_{0} ( 1 - n ) )} \qquad eqn . 4 b$$

$$x = \frac{{x}_{0} ( {Px}_{0} ( 2 - n ) - y ( 1 - n ) )}{P ( {x}_{0} - {nx}_{0} ) + ny} \qquad eqn . 4 c$$

$$x = \frac{{y}_{0} ( {y}_{0} ( 2 - n ) - y ( 1 - n ) )}{P ( ny + {y}_{0} ( 1 - n ) )} \qquad eqn . 4 d$$

$$x = \frac{{x}_{0} ( {y}_{0} ( 2 - n ) - y ( 1 - n ) )}{ny + {y}_{0} ( 1 - n )} \qquad eqn . 4 e$$

$$x = \frac{{x}_{asym} ( {y}_{asym} + {( n - 1 )}^{2} ( y - {y}_{asym} ) )}{{( n - 1 )}^{2} ( y - {y}_{asym} )} \qquad eqn . 4 f$$

$$x = \frac{{{x}_{int} ( 1 - n )}^{2} ( {y}_{int} - y )}{y - {( 1 - n )}^{2} ( y - {y}_{int} )} \qquad eqn . 4 g$$

$$x = \frac{{x}_{0} ( k ( \sqrt{Q} + 1 ) - {x}_{0} y \sqrt{Q} )}{k \sqrt{Q} + {x}_{0} y ( 1 - \sqrt{Q} )} \qquad eqn . 4 h$$

$$x = \frac{k ( {y}_{0} ( \sqrt{Q} + 1 ) - y \sqrt{Q} )}{{y}_{0} ( y ( 1 - \sqrt{Q} ) + {y}_{0} \sqrt{Q} )} \qquad eqn . 4 i$$

$$x = \frac{{x}_{0} ( {Px}_{0} ( \sqrt{Q} + 1 ) - y \sqrt{Q} )}{{Px}_{0} ( 1 - \sqrt{Q} ) ( y - {Px}_{0} )} \qquad eqn \text{.4} j$$

$$x = \frac{{y}_{0} ( {y}_{0} ( \sqrt{Q} + 1 ) - y \sqrt{Q} )}{P ( y ( 1 - \sqrt{Q} + {y}_{0} \sqrt{Q} )} \qquad eqn . 4 k$$

$$x = \frac{{x}_{0} ( {y}_{0} ( \sqrt{Q} + 1 ) - y \sqrt{Q} )}{y ( 1 - \sqrt{Q} ) + {y}_{0} \sqrt{Q}} \qquad eqn . 4 l$$

$$x = \frac{{x}_{asym} ( {y}_{asym} + Q ( y - {y}_{asym} ) )}{Q ( y - {y}_{asym} )} \qquad eqn . 4 m$$

$$x = \frac{{x}_{int} Q ( {y}_{int} - y )}{y - Q ( y - {y}_{int} )} \qquad eqn . 4 n$$

Alternatively or additionally, the novel invariant function may be defined with respect to any line tangent to its implicit curve, measured from either the x- or y-coordinates (eqns. 5a-n and 6a-n, respectively).

$$- \frac{dy}{dx} = \frac{k}{{( nx + {x}_{0} ( 1 - n ) )}^{2}} \qquad eqn . 5 a$$

$$- \frac{dy}{dx} = \frac{{ky}_{0}^{2}}{{( k ( 1 - n ) + {nxy}_{0} )}^{2}} \qquad eqn . 5 b$$

$$- \frac{dy}{dx} = \frac{{Px}_{0}^{2}}{{( nx + {x}_{0} ( 1 - n ) )}^{2}} \qquad eqn . 5 c$$

$$- \frac{dy}{dx} = \frac{{Py}_{0}^{2}}{{( Pnx + {y}_{0} ( 1 - n ) )}^{2}} \qquad eqn . 5 d$$

$$- \frac{dy}{dx} = \frac{{x}_{0} {y}_{0}}{{( nx + {x}_{0} ( 1 - n ) )}^{2}} \qquad eqn . 5 e$$

$$- \frac{dy}{dx} = \frac{{x}_{asym} {y}_{asym}}{{( 1 - n )}^{2} {( x - {x}_{asym} )}^{2}} \qquad eqn . 5 f$$

$$- \frac{dy}{dx} = \frac{{x}_{int} {{y}_{int} ( 1 - n )}^{2}}{{( x ( 2 n - {n}^{2} ) + {{x}_{int} ( 1 - n )}^{2} )}^{2}} \qquad eqn . 5 g$$

$$- \frac{dy}{dx} = \frac{k}{{x}_{0} \sqrt{Q} + x ( 1 - \sqrt{Q} )} \qquad eqn . 5 h$$

$$- \frac{dy}{dx} = \frac{{ky}_{0}^{2}}{{( k \sqrt{Q} + {xy}_{0} ( 1 - \sqrt{Q} ) )}^{2}} \qquad eqn . 5 i$$

$$- \frac{dy}{dx} = \frac{{Px}_{0}^{2}}{{( x ( 1 - \sqrt{Q} ) + {x}_{0} \sqrt{Q} )}^{2}} \qquad eqn . 5 j$$

$$- \frac{dy}{dx} = \frac{{Py}_{0}^{2}}{( {Px ( 1 - \sqrt{Q )} + {y}_{0} \sqrt{Q} )}^{2}} \qquad eqn . 5 k$$

$$- \frac{dy}{dx} = \frac{{x}_{0} {y}_{0}}{{( x ( 1 - \sqrt{Q} ) + {x}_{0} \sqrt{Q} )}^{2}} \qquad eqn . 5 l$$

$$- \frac{dy}{dx} = \frac{{x}_{asym} {y}_{asym}}{{Q ( x - {x}_{asym} )}^{2}} \qquad eqn . 5 m$$

$$- \frac{dy}{dx} = \frac{{x}_{int} {y}_{int} Q}{{( x ( 1 - Q ) + {x}_{int} Q )}^{2}} \qquad eqn . 5 n$$

$$- \frac{dy}{dx} = \frac{{nx}_{0} y + {k ( 1 - n )}^{2}}{{kx}_{0}^{2}} \qquad eqn . 6 a$$

$$- \frac{dy}{dx} = \frac{{( ny + {y}_{0} ( 1 - n ) )}^{2}}{k} \qquad eqn . 6 b$$

$$- \frac{dy}{dx} = \frac{{( P ( {nx}_{0} - {x}_{0} ) - ny )}^{2}}{{Px}_{0}^{2}} \qquad eqn . 6 c$$

$$- \frac{dy}{dx} = \frac{P {( ny + {y}_{0} ( 1 - n ) )}^{2}}{{y}_{0}^{2}} \qquad eqn . 6 d$$

$$- \frac{dy}{dx} = \frac{{( ny + {y}_{0} ( 1 - n ) )}^{2}}{{x}_{0} {y}_{0}} \qquad eqn . 6 e$$

$$- \frac{dy}{dx} = \frac{{( 1 - n )}^{2} {( y - {y}_{asym} )}^{2}}{{x}_{asym} {y}_{asym}} \qquad eqn . 6 f$$

$$- \frac{dy}{dx} = \frac{{( y ( 2 n - {n}^{2} ) + {{y}_{int} ( 1 - n )}^{2} )}^{2}}{{x}_{int} {{y}_{int} ( 1 - n )}^{2}} \qquad eqn . 6 g$$

$$- \frac{dy}{dx} = \frac{{( k \sqrt{Q} + {x}_{0} y ( 1 - \sqrt{Q} ) )}^{2}}{{kx}_{0}^{2}} \qquad eqn . 6 h$$

$$- \frac{dy}{dx} = \frac{{( y ( 1 - \sqrt{Q} ) + {y}_{0} \sqrt{Q} )}^{2}}{k} \qquad eqn . 6 i$$

$$- \frac{dy}{dx} = \frac{{( {Px}_{0} + ( 1 - \sqrt{Q} ) ( y - {Px}_{0} ) )}^{2}}{{Px}_{0}^{2}} \qquad eqn . 6 j$$

$$- \frac{dy}{dx} = \frac{P {( y ( 1 - \sqrt{Q} ) + {y}_{0} \sqrt{Q} )}^{2}}{{y}_{0}^{2}} \qquad eqn . 6 k$$

$$- \frac{dy}{dx} = \frac{{( y ( 1 - \sqrt{Q} ) + {y}_{0} \sqrt{Q} )}^{2}}{{x}_{0} {y}_{0}} \qquad eqn . 6 l$$

$$- \frac{dy}{dx} = \frac{{Q ( y - {y}_{asym} )}^{2}}{{x}_{asym} {y}_{asym}} \qquad eqn . 6 m$$

$$- \frac{dy}{dx} = \frac{{( y ( 1 - Q ) + {Qy}_{int} )}^{2}}{{Qx}_{int} {y}_{int}} \qquad eqn . 6 n$$

Alternatively or additionally, the novel invariant function may be defined with respect to any secant line connecting any two points on its implicit curve, where Δy and Δx denotes the absolute translocation in the Cartesian plane between any two points on its graph connected by a continuum of intermediate points. The secant line may be defined with respect to either the x- or y-coordinate (eqns. 7a-n and 8a-n, respectively).

$$- Δ y = \frac{Δ xk}{( nx + {x}_{0} ( 1 - n ) ) ( n ( Δ x + x ) + {x}_{0} ( 1 - n ) )} \qquad eqn . 7 a$$

$$- Δ y = \frac{Δ {xky}_{0}^{2}}{( k ( 1 - n ) + {nxy}_{0} ) ( k ( 1 - n ) + {ny}_{0} ( Δ x + x ) )} \qquad eqn . 7 b$$

$$- Δ y = \frac{P Δ {xx}_{0}^{2}}{( nx + {x}_{0} ( 1 - n ) ) ( n ( Δ x + x ) + {x}_{0} ( 1 - n ) )} \qquad eqn . 7 c$$

$$- Δ y = \frac{P Δ {xy}_{0}^{2}}{( Pnx + {y}_{0} ( 1 - n ) ) ( Pn ( Δ x + x ) + {y}_{0} ( 1 - n ) )} \qquad eqn . 7 d$$

$$- Δ y = \frac{Δ {xx}_{0} {y}_{0}}{( nx + {x}_{0} ( 1 - n ) ) ( n ( Δ x + x ) + {x}_{0} ( 1 - n ) )} \qquad eqn . 7 e$$

$$- Δ y = \frac{Δ {xx}_{asym} {y}_{asym}}{{( 1 - n )}^{2} ( x - {x}_{asym} ) ( Δ x + x - {x}_{asym} )} \qquad eqn . 7 f$$

$$- Δ y = \frac{{x}_{int} {y}_{int} Δ {x ( 1 - n )}^{2}}{\begin{matrix}( x ( 2 n - {n}^{2} ) + {{x}_{int} ( 1 - n )}^{2} ) \\ ( n ( 2 - n ) ( x + Δ x ) + {{x}_{int} ( 1 - n )}^{2} )\end{matrix}} \qquad eqn . 7 g$$

$$- Δ y = \frac{Δ xk}{( ( 1 - \sqrt{Q} ) x + {x}_{0} \sqrt{Q} ) ( ( 1 - \sqrt{Q} ) ( Δ x + x ) + {x}_{0} \sqrt{Q} ) )} \qquad eqn . 7 h$$

$$- Δ y = \frac{Δ {xky}_{0}^{2}}{( k \sqrt{Q} + ( 1 - \sqrt{Q} ) {xy}_{0} ) ( k \sqrt{Q} + {y}_{0} ( 1 - \sqrt{Q} ) ( Δ x + x ) )} \qquad eqn . 7 i$$

$$- Δ y = \frac{P Δ {xx}_{0}^{2}}{( ( 1 - \sqrt{Q} ) x + {x}_{0} \sqrt{Q} ) ( ( 1 - \sqrt{Q} ) ( Δ x + x ) + {x}_{0} \sqrt{Q} )} \qquad eqn . 7 j$$

$$- Δ y = \frac{P Δ {xy}_{0}^{2}}{\begin{matrix}( P ( 1 - \sqrt{Q} ) x + {y}_{0} \sqrt{Q} ) \\ ( P ( 1 - \sqrt{Q} ) ( ( Δ x + x ) + {y}_{0} \sqrt{Q} )\end{matrix}} \qquad eqn . 7 k$$

$$- Δ y = \frac{Δ {xx}_{0} {y}_{0}}{( ( 1 - \sqrt{Q} ) x + {x}_{0} \sqrt{Q} ) ( ( 1 - \sqrt{Q} ) ( Δ x + x ) + {x}_{0} \sqrt{Q} )} \qquad eqn . 7 l$$

$$- Δ y = \frac{Δ {xx}_{asym} {y}_{asym}}{Q ( x - {x}_{asym} ) ( Δ x + x - {x}_{asym} )} \qquad eqn . 7 m$$

$$- Δ y = \frac{Q Δ {xx}_{int} {y}_{int}}{( {Qx}_{int} + x ( 1 - Q ) ) ( {Qx}_{int} + ( 1 - Q ) ( x + Δ x ) )} \qquad eqn . 7 n$$

$$- Δ y = \frac{Δ {x ( k ( 1 - n ) + {nx}_{0} y )}^{2}}{{x}_{0} ( Δ xn ( k ( 1 - n ) + {nx}_{0} y ) + {kx}_{0} )} \qquad eqn . 8 a$$

$$- Δ y = \frac{Δ {x ( ny + {y}_{0} ( 1 - n ) )}^{2}}{Δ xn ( ny + {y}_{0} ( 1 - n ) ) + k} \qquad eqn . 8 b$$

$$- Δ y = \frac{Δ {x ( {Px}_{0} ( 1 - n ) + ny )}^{2}}{{Px}_{0}^{2} + Δ xn ( {Px}_{0} ( 1 - n ) + ny )} \qquad eqn . 8 c$$

$$- Δ y = \frac{P Δ {x ( ny + {y}_{0} ( 1 - n ) )}^{2}}{P Δ xn ( ny + {y}_{0} ( 1 - n ) ) + {y}_{0}^{2}} \qquad eqn . 8 d$$

$$- Δ y = \frac{Δ {x ( ny + {y}_{0} ( 1 - n ) )}^{2}}{Δ xn ( ny + {y}_{0} ( 1 - n ) ) + {x}_{0} {y}_{0}} \qquad eqn . 8 e$$

$$- Δ y = \frac{Δ {x ( 1 - n )}^{2} {( y - {y}_{asym} )}^{2}}{Δ {x ( 1 - n )}^{2} ( y - {y}_{asym} ) + {x}_{asym} {y}_{asym}} \qquad eqn . 8 f$$

$$- Δ y = \frac{Δ {x ( y ( 2 n - {n}^{2} ) + {{y}_{int} ( 1 - n )}^{2} )}^{2}}{{n}^{2} y Δ {x ( 2 - n )}^{2} + {{y}_{int} ( 1 - n )}^{2} ( {x}_{int} + Δ x ( 2 n - {n}^{2} ) )} \qquad eqn . 8 g$$

$$- Δ y = \frac{Δ {x ( k \sqrt{Q} + {x}_{0} y ( 1 - \sqrt{Q} ) )}^{2}}{{x}_{0} ( Δ x ( 1 - \sqrt{Q} ) ( k \sqrt{Q} + {x}_{0} y ( 1 - \sqrt{Q} ) ) + {kx}_{0} )} \qquad eqn . 8 h$$

$$- Δ y = \frac{Δ {x ( ( 1 - \sqrt{Q} ) y + {y}_{0} \sqrt{Q} )}^{2}}{Δ x ( 1 - \sqrt{Q} ) ( y ( 1 - \sqrt{Q} ) + {y}_{0} \sqrt{Q} ) + k} \qquad eqn . 8 i$$

$$- Δ y = \frac{Δ {x ( {Px}_{0} \sqrt{Q} + ( 1 - \sqrt{Q} ) y )}^{2}}{{Px}_{0}^{2} + Δ x ( 1 - \sqrt{Q} ) ( {Px}_{0} \sqrt{Q} + y ( 1 - \sqrt{Q} ) )} \qquad eqn . 8 j$$

$$- Δ y = \frac{P Δ {x ( y ( 1 - \sqrt{Q} ) + {y}_{0} \sqrt{Q} )}^{2}}{P Δ x ( 1 - \sqrt{Q} ) ( y ( 1 - \sqrt{Q} ) + {y}_{0} \sqrt{Q} ) + {y}_{0}^{2}} \qquad eqn . 8 k$$

$$- Δ y = \frac{Δ {x ( y ( 1 - \sqrt{Q} ) + {y}_{0} \sqrt{Q} )}^{2}}{Δ x ( 1 - \sqrt{Q} ) ( y ( 1 - \sqrt{Q} ) + {y}_{0} \sqrt{Q} ) + {x}_{0} {y}_{0}} \qquad eqn . 8 l$$

$$- Δ y = \frac{Δ {xQ ( y - {y}_{asym} )}^{2}}{Δ xQ ( y - {y}_{asym} ) + {x}_{asym} {y}_{asym}} \qquad eqn . 8 m$$

$$- Δ y = \frac{Δ {x ( {Qy}_{int} + y ( 1 - Q ) )}^{2}}{{Qy}_{int} ( {x}_{int} + Δ x ( 1 - Q ) ) + y Δ {x ( 1 - Q )}^{2}} \qquad eqn \text{.8} n$$

Alternatively or additionally, the novel invariant function may be defined with respect to the gradient of said secant lines, denoted here as Δy/Δx, and can be defined with respect to either the x- or y-coordinate (eqns. 9a-n and 10a-n). As Δx approaches zero, Δy/Δx approaches the instantaneous rate of change at any point on its implicit curve and forms an equality with eqns. 5a-n and 6a-n.

$$- \frac{Δ y}{Δ x} = \frac{k}{( nx + {x}_{0} ( 1 - n ) ) ( n ( Δ x + x ) + {x}_{0} ( 1 - n ) )} \qquad eqn . 9 a$$

$$- \frac{Δ y}{Δ x} = \frac{{ky}_{0}^{2}}{( k ( 1 - n ) + {nxy}_{0} ) ( k ( 1 - n ) + {ny}_{0} ( Δ x + x ) )} \qquad eqn . 9 b$$

$$- \frac{Δ y}{Δ x} = \frac{{Px}_{0}^{2}}{( nx + {x}_{0} ( 1 - n ) ) ( n ( Δ x + x ) + {x}_{0} ( 1 - n ) )} \qquad eqn . 9 c$$

$$- \frac{Δ y}{Δ x} = \frac{{Py}_{0}^{2}}{( Pnx + {y}_{0} ( 1 - n ) ) ( Pn ( Δ x + x ) + {y}_{0} ( 1 - n ) )} \qquad eqn . 9 d$$

$$- \frac{Δ y}{Δ x} = \frac{{x}_{0} {y}_{0}}{( nx + {x}_{0} ( 1 - n ) ) ( n ( Δ x + x ) + {x}_{0} ( 1 - n ) )} \qquad eqn . 9 e$$

$$- \frac{Δ y}{Δ x} = \frac{{x}_{asym} {y}_{asym}}{{( 1 - n )}^{2} ( x - {x}_{asym} ) ( Δ x + x - {x}_{asym} )} \qquad eqn . 9 f$$

$$- \frac{Δ y}{Δ x} = \frac{{x}_{int} {{y}_{int} ( 1 - n )}^{2}}{\begin{matrix}( x ( 2 n - {n}^{2} ) + {x}_{int} {( 1 - n )}^{2} ) \\ ( ( 2 n - {n}^{2} ) ( x + Δ x ) + {{x}_{int} ( 1 - n )}^{2} )\end{matrix}} \qquad eqn . 9 g$$

$$- \frac{Δ y}{Δ x} = \frac{k}{( x ( 1 - \sqrt{Q} ) + {x}_{0} \sqrt{Q} ) ( ( 1 - \sqrt{Q} ) ( Δ x + x ) + {x}_{0} \sqrt{Q} )} \qquad eqn . 9 h$$

$$- \frac{Δ y}{Δ x} = \frac{{ky}_{0}^{2}}{\begin{matrix}( k \sqrt{Q} + {xy}_{0} ( 1 - \sqrt{Q} ) ) \\ ( k \sqrt{Q} + {y}_{0} ( 1 - \sqrt{Q} ) ( Δ x + x ) )\end{matrix}} \qquad eqn . 9 i$$

$$- \frac{Δ y}{Δ x} = \frac{{Px}_{0}^{2}}{( x ( 1 - \sqrt{Q} ) + {x}_{0} \sqrt{Q} ) ( ( 1 - \sqrt{Q} ) ( Δ x + x ) + {x}_{0} \sqrt{Q} )} \qquad eqn . 9 j$$

$$- \frac{Δ y}{Δ x} = \frac{{Py}_{0}^{2}}{\begin{matrix}( Px ( 1 - \sqrt{Q} ) + {y}_{0} \sqrt{Q} ) \\ ( P ( 1 - \sqrt{Q} ) ( Δ x + x ) + {y}_{0} \sqrt{Q} )\end{matrix}} \qquad eqn . 9 k$$

$$- \frac{Δ y}{Δ x} = \frac{{x}_{0} {y}_{0}}{( x ( 1 - \sqrt{Q} ) + {x}_{0} \sqrt{Q} ) ( ( 1 - \sqrt{Q} ) ( Δ x + x ) + {x}_{0} \sqrt{Q} )} \qquad eqn . 9 l$$

$$- \frac{Δ y}{Δ x} = \frac{{x}_{asym} {y}_{asym}}{Q ( x - {x}_{asym} ) ( Δ x + x - {x}_{asym} )} \qquad eqn . 9 m$$

$$- \frac{Δ y}{Δ x} = \frac{{x}_{int} {y}_{int} Q}{( x ( 1 - Q ) + {x}_{int} Q ) ( ( 1 - Q ) ( x + Δ x ) + {x}_{int} Q )} \qquad eqn . 9 n$$

$$- \frac{Δ y}{Δ x} = \frac{{( k ( 1 - n ) + {nx}_{0} y )}^{2}}{{x}_{0} ( Δ xn ( k ( 1 - n ) + {nx}_{0} y ) + {kx}_{0} )} \qquad eqn . 10 a$$

$$- \frac{Δ y}{Δ x} = \frac{{( ny + {y}_{0} ( 1 - n ) )}^{2}}{Δ xn ( ny + {y}_{0} ( 1 - n ) ) + k} \qquad eqn . 10 b$$

$$- \frac{Δ y}{Δ x} = \frac{{( {Px}_{0} ( 1 - n ) + ny )}^{2}}{{Px}_{0}^{2} + Δ xn ( {Px}_{0} ( 1 - n ) + ny )} \qquad eqn . 10 c$$

$$- \frac{Δ y}{Δ x} = \frac{P {( ny + {y}_{0} ( 1 - n ) )}^{2}}{P Δ xn ( ny + {y}_{0} ( 1 - n ) ) + {y}_{0}^{2}} \qquad eqn . 10 d$$

$$- \frac{Δ y}{Δ x} = \frac{{( ny + {y}_{0} ( 1 - n ) )}^{2}}{Δ xn ( ny + {y}_{0} ( 1 - n ) ) + {x}_{0} {y}_{0}} \qquad eqn . 10 e$$

$$- \frac{Δ y}{Δ x} = \frac{{( 1 - n )}^{2} {( y - {y}_{asym} )}^{2}}{Δ x {( 1 - n )}^{2} ( y - {y}_{asym} ) + {x}_{asym} {y}_{asym}} \qquad eqn . 10 f$$

$$- \frac{Δ y}{Δ x} = \frac{{( y ( 2 n - {n}^{2} ) + {y}_{int} {( 1 - n )}^{2} )}^{2}}{{n}^{2} y Δ x {( 2 - n )}^{2} + {y}_{int} {( 1 - n )}^{2} ( {x}_{int} + Δ x ( 2 n - {n}^{2} ) )} \qquad eqn . 10 g$$

$$- \frac{Δ y}{Δ x} = \frac{{( k \sqrt{Q} + {x}_{0} y ( 1 - \sqrt{Q} ) )}^{2}}{{x}_{0} ( Δ x ( 1 - \sqrt{Q} ) ( k \sqrt{Q} + {x}_{0} y ( 1 - \sqrt{Q} ) ) + {kx}_{0} )} \qquad eqn . 10 h$$

$$- \frac{Δ y}{Δ x} = \frac{{( y ( 1 - \sqrt{Q} ) + {y}_{0} \sqrt{Q} )}^{2}}{Δ x ( 1 - \sqrt{Q} ) ( y ( 1 - \sqrt{Q} ) + {y}_{0} \sqrt{Q} ) + k} \qquad eqn . 10 i$$

$$- \frac{Δ y}{Δ x} = \frac{{( {Px}_{0} \sqrt{Q} + y ( 1 - \sqrt{Q} ) )}^{2}}{{Px}_{0}^{2} + Δ x ( 1 - \sqrt{Q} ) ( {Px}_{0} \sqrt{Q} + y ( 1 - \sqrt{Q} ) )} \qquad eqn . 10 j$$

$$- \frac{Δ y}{Δ x} = \frac{P {( y ( 1 - \sqrt{Q} ) + {y}_{0} \sqrt{Q} )}^{2}}{P Δ x ( 1 - \sqrt{Q} ) ( y ( 1 - \sqrt{Q} ) + {y}_{0} \sqrt{Q} + {y}_{0}^{2}} \qquad eqn . 10 k$$

$$- \frac{Δ y}{Δ x} = \frac{{( y ( 1 - \sqrt{Q} ) + {y}_{0} \sqrt{Q} )}^{2}}{Δ x ( 1 - \sqrt{Q} ) ( y ( 1 - \sqrt{Q} ) + {y}_{0} ( 1 - n ) ) + {x}_{0} {y}_{0}} \qquad eqn . 10 l$$

$$- \frac{Δ y}{Δ x} = \frac{Q {( y - {y}_{asym} )}^{2}}{Δ xQ ( y - {y}_{asym} ) + {x}_{asym} {y}_{asym}} \qquad eqn . 10 m$$

$$- \frac{Δ y}{Δ x} = \frac{{( {Qy}_{int} + y ( 1 - Q ) )}^{2}}{{Qy}_{int} ( {x}_{int} + Δ x ( 1 - Q ) ) + y Δ x {( 1 - Q )}^{2}} \qquad eqn . 10 n$$

The equations depicted above are non-exhaustive, and/or not necessarily limiting. Each parameter belongs to a set and may have an explicit relationship to other parameters within its own set, and between sets of other parameters. These relationships include important equivalences between fundamental parameters, and explicit pairs of other parameters, including but are not necessarily limited to those defined in eqns. 11a-d and 12.

$$k = {x}_{0} {y}_{0} = {Px}_{0}^{2} = \frac{{y}_{0}^{2}}{P} \qquad eqn . 11 a$$

$$P = \sqrt{{P}_{a} {P}_{b}} = \frac{{y}_{0}}{{x}_{0}} = \frac{k}{{x}_{0}^{2}} = \frac{{y}_{0}^{2}}{k} = \frac{{y}_{asym}}{{x}_{asym}} = \frac{{y}_{int}}{{x}_{int}} \qquad eqn . 11 b$$

$$Q = \sqrt{\frac{{P}_{b}}{{P}_{a}}} = \frac{P}{{P}_{a}} = \frac{{P}_{b}}{P} = \frac{{y}_{asym}}{{y}_{asym} - {y}_{int}} = \frac{{x}_{asym}}{{x}_{asym} - {x}_{int}} = {( 1 - n )}^{2} \qquad eqn . 11 c$$

$$n = 1 - \sqrt[4]{\frac{{P}_{b}}{{P}_{a}}} = \frac{{y}_{0}}{{y}_{0} - {y}_{asym}} = \frac{{x}_{0}}{{x}_{0} - {x}_{asym}} = \frac{2 {y}_{0} - {y}_{int}}{{y}_{0} - {y}_{int}} = \frac{2 {x}_{0} - {x}_{int}}{{x}_{0} - {x}_{int}} \qquad eqn . 11 d$$

The parameter n is redundant with the parameter u; the two are the reciprocal of each other (eqn. 12).

nu=1 eqn. 12

From the established theory, an expanded network of algebraic identities can be defined. The totality of the geometric relationships is too vast to list in its entirety; however, a representative set is provided with eqns. 13a-s.

$$P = \frac{{y}_{asym} - {y}_{0}}{{x}_{asym} - {x}_{0}} = \frac{{y}_{asym} + {y}_{0}}{{x}_{asym} + {x}_{0}} = \frac{{y}_{int} - {y}_{0}}{{x}_{int} - {x}_{0}} = \frac{{y}_{int} + {y}_{0}}{{x}_{int} + {x}_{0}} \qquad eqn . 13 a$$

$${P}_{a} = \frac{k}{{{x}_{0}^{2} ( 1 - n )}^{2}} = \frac{{y}_{0}^{2}}{{k ( 1 - n )}^{2}} = \frac{P}{{( 1 - n )}^{2}} = \frac{{y}_{0}}{{{x}_{0} ( 1 - n )}^{2}} = \frac{{y}_{asym}}{{{x}_{asym} ( 1 - n )}^{2}} \qquad eqn . 13 b$$

$${P}_{a} = \frac{{y}_{0} {( {x}_{0} - {x}_{int} )}^{2}}{{x}_{0}^{3}} = \frac{{( {y}_{0} - {y}_{int} )}^{2}}{k} = \frac{k}{{( {nx}_{int} - \sqrt{\frac{k}{{P}_{b}}} )}^{2}} = \frac{{( {ny}_{int} + \sqrt{{P}_{b} k} )}^{2}}{k} \qquad eqn . 13 c$$

$${P}_{b} = \frac{k {( 1 - n )}^{2}}{{x}_{0}^{2}} = \frac{{y}_{0}^{2} {( 1 - n )}^{2}}{k} = P {( 1 - n )}^{2} = \frac{{y}_{0} {( 1 - n )}^{2}}{{x}_{0}} = \frac{{y}_{asym} {( 1 - n )}^{2}}{{x}_{asym}} \qquad eqn . 13 d$$

$${P}_{b} = \frac{{y}_{0}^{3}}{{x}_{0} {( {y}_{0} - {y}_{int} )}^{2}} = \frac{k}{{( {x}_{0} - {x}_{int} )}^{2}} = \frac{k}{{( {nx}_{int} + \sqrt{\frac{k}{{P}_{a}}} )}^{2}} = \frac{{( {ny}_{int} - \sqrt{{P}_{a} k} )}^{2}}{k} \qquad eqn . 13 e$$

$${y}_{int} = \frac{k ( 2 - n )}{{x}_{0} ( 1 - n )} = \frac{{y}_{0} ( 2 - n )}{1 - n} = \frac{{Px}_{0} ( 2 - n )}{1 - n} = {y}_{asym} - \frac{{y}_{asym}}{{( n - 1 )}^{2}} \qquad eqn . 13 f$$

$${x}_{int} = \frac{k ( 2 - n )}{{y}_{0} ( 1 - n )} = \frac{{x}_{0} ( 2 - n )}{1 - n} = \frac{{y}_{0} ( 2 - n )}{P ( 1 - n )} = {x}_{asym} - \frac{{x}_{asym}}{{( 1 - n )}^{2}} \qquad eqn . 13 g$$

$$k = {P}_{a} {{x}_{0}^{2} ( 1 - n )}^{2} = \frac{{y}_{0}^{2}}{{{P}_{a} ( 1 - n )}^{2}} = \frac{{P}_{b} {x}_{0}^{2}}{{( 1 - n )}^{2}} = \frac{{y}_{0}^{2} {( 1 - n )}^{2}}{{P}_{b}} \qquad eqn . 13 h$$

$$k = \frac{{x}_{0} {y}_{int} ( 1 - n )}{2 - n} = \frac{{x}_{int} {y}_{0} ( 1 - n )}{2 - n} = \frac{{y}_{int}^{2} {( 1 - n )}^{2}}{{P ( 2 - n )}^{2}} = \frac{{Px}_{int}^{2} {( 1 - n )}^{2}}{{( 2 - n )}^{2}} \qquad eqn . 13 i$$

$$k = \frac{{x}_{int} {{y}_{int} ( 1 - n )}^{2}}{{( 2 - n )}^{2}} = \frac{{n}^{2} {x}_{asym} {y}_{asym}}{{( 1 - n )}^{2}} \qquad eqn . 13 j$$

$${x}_{0} = \frac{\sqrt{\frac{k}{{P}_{a}}}}{( 1 - n )} = \sqrt{\frac{k}{{P}_{b}}} ( 1 - n ) = \frac{{y}_{0}}{{{P}_{a} ( 1 - n )}^{2}} = \frac{{{y}_{0} ( 1 - n )}^{2}}{{P}_{b}} \qquad eqn . 13 k$$

$${x}_{0} = \frac{k ( 2 - n )}{{y}_{int} ( 1 - n )} = \frac{{y}_{int} ( 1 - n )}{P ( 2 - n )} = \frac{{x}_{int} ( 1 - n )}{2 - n} = \frac{{x}_{asym} {y}_{0}}{{y}_{asym}} \qquad eqn . 13 l$$

$${y}_{0} = \sqrt{{P}_{a} k} ( 1 - n ) = \frac{\sqrt{{P}_{b} k}}{1 - n} = {P}_{a} {{x}_{0} ( 1 - n )}^{2} = \frac{{P}_{b} {x}_{0}}{{( 1 - n )}^{2}} \qquad eqn . 13 m$$

$${y}_{0} = \frac{{y}_{int} ( 1 - n )}{2 - n} = \frac{k ( 2 - n )}{{x}_{int} ( 1 - n )} = \frac{{Px}_{int} ( 1 - n )}{2 - n} = \frac{{y}_{asym} {x}_{0}}{{x}_{asym}} \qquad eqn . 13 n$$

$${y}_{asym} = \frac{{{y}_{int} ( 1 - n )}^{2}}{{( 1 - n )}^{2} - 1} = \frac{{{Px}_{int} ( 1 - n )}^{2}}{{( 1 - n )}^{2} - 1} = \frac{{y}_{0} ( n - 1 )}{n} \qquad eqn . 13 o$$

$${x}_{asym} = \frac{{{x}_{int} ( 1 - n )}^{2}}{{( 1 - n )}^{2} - 1} = \frac{{{y}_{int} ( 1 - n )}^{2}}{P ( {( 1 - n )}^{2} - 1 )} = \frac{{x}_{0} ( n - 1 )}{n} \qquad eqn . 13 p$$

$${( 1 - n )}^{2} = Q = \frac{{x}_{asym} {y}_{asym} - \sqrt{{x}_{asym} {y}_{asym}} \sqrt{{x}_{int} {y}_{int}}}{{x}_{asym} {y}_{asym} - {x}_{int} {y}_{int}} \qquad eqn . 13 q$$

$$1 - n = \sqrt{Q} = \frac{k}{\sqrt{{x}_{int} {y}_{int}} - \sqrt{k}} \qquad eqn . 13 r$$

$$n = 1 - \sqrt{Q} = \frac{\sqrt{k} ( \sqrt{{P}_{a}} - \sqrt{{P}_{b}} )}{{y}_{int}} = \frac{\sqrt{k} ( \sqrt{\frac{1}{{P}_{b}}} - \sqrt{\frac{1}{{P}_{a}}} )}{{x}_{int}} \qquad eqn . 13 s$$

The equalities presented above are summarized in eqns. 14a-c and give precise identities for the fundamental parameters n, P, Q, k, x_{asym}, y_{asym}, xᵢₙₜ, and yᵢₙₜ with respect to each other.

$${n}^{2} = {( 1 - \sqrt{Q} )}^{2} = \frac{k ( {P}_{a} + {P}_{b} - 2 P )}{{Px}_{int} {y}_{int}} \qquad eqn . 14 a$$

$$\frac{{( 1 - n )}^{4}}{{{n}^{4} ( 2 - n )}^{2}} = \frac{{Q}^{2}}{{( 1 - Q )}^{4} {( 1 + Q )}^{2}} = \frac{P {x}_{asym} {y}_{asym}}{k ( {P}_{a} + {P}_{b} - 2 P )} \qquad eqn . 14 b$$

$$\frac{{( 1 - n )}^{2}}{{{n}^{2} ( 2 - n )}^{2}} = \frac{{Q}^{2}}{{( 1 - Q )}^{2}} = \frac{P}{{P}_{a} + {P}_{b} - 2 P} \qquad eqn . 14 c$$

The parameters algebraically defined above are now elaborated in the context of their geometric meaning. The descriptions provided here are for illustrative and explanatory purposes to aid the reader's understanding and should not be conflated with any specific use case, and/or be considered a constraint, and/or necessarily limiting, and/or boundary in any manner to the generality of the embodiments described herein.

Reference is now made back to FIGS. 1a-c, which are schematics depicting the invariant function characterized as having a point on its implicit curve with coordinates x=x₀, y=y₀, which coincide with the graph of eqns. 1a-c, in accordance with some embodiments of the present invention. Reference is now made back to FIGS. 2a-c, which are schematics where the negated slope of the tangent line (−dy/dx) at this point is P and is equal in both implicit curves of the customizable function and eqns. 1d-e, in accordance with some embodiments of the present invention. Reference is now made back to FIGS. 3a-g, which are schematics where the parameter k is the hyperbola constant of eqns. 1a-c, (i.e. xy=k), and denotes the magnitude of the constant product's implicit curve with which the implicit curve of the novel invariant function shares the coordinates x=x₀, y=y₀, in accordance with some embodiments of the present invention. Reference is now made back to FIGS. 4a-1, which are schematics where the parameters x_{asym} and y_{asym} denote the “vertical” and “horizontal” asymptotes, respectively, of the novel function's implicit curve, in accordance with some embodiments of the present invention. It is noted that the designations “vertical” and/or “horizontal” should not be misconstrued as perpendicular lines, and/or straight lines in embodiments described herein; these terms are used for ease of communication, and/or the divergence of their meaning from the status quo is discussed elsewhere. Reference is now made back to FIGS. 5a-g, which are schematics where the parameters xᵢₙₜ and yᵢₙₜ denote the x- and y-intercepts the novel function's implicit curve, in accordance with some embodiments of the present invention. Reference is now made back to FIGS. 6a-f, which are schematics where the slope of the tangent lines at the y- and x-intercepts of the novel implicit curve, y=yᵢₙₜ and x=xᵢₙₜ, respectively, are denoted by the parameters Pₐ and P_{b}, respectively, in accordance with some embodiments of the present invention. Reference is now made back to FIGS. 7a-b, which are schematics depicting exemplary methods of discovery of the parameters n, u that denote the relative size of two rectangles, in accordance with some embodiments of the present invention. One exemplary method is described herein. Assume both rectangles have edges parallel to the x- and y-axis. Let the first of the two rectangles have one corner at the origin (x=0, y=0), one corner at the x-intercept (y=0, x=xᵢₙₜ), one corner at the y-intercept (x=0, y=yᵢₙₜ), and one corner at the junction of the lines emanating from both intercepts (x=xᵢₙₜ, y=yᵢₙₜ) and converging at a right angle. The second rectangle has one corner at the point on the implicit curve of eqns. 1a-c where a tangent line at this point is parallel to P_{b} (x=\sqrt{k}/\sqrt{P_{b}}, y=\sqrt{kP_{b}}), and one corner at the point on the implicit curve of eqns. 1a-c where a tangent line at this point is parallel to Pₐ (x=\sqrt{k}/\sqrt{Pₐ}, y=\sqrt{kPₐ}), and the other corners at the junctions of the lines emanating from both other points and converging at right angles, as depicted in FIGS. 7a-b. The square root of the quotient of the rectangles' areas, or the quotient of the rectangles' lengths, or the quotient of the rectangles' heights, can be used to calculate to n and its reciprocal, u.

Reference is now made back to FIGS. 7c-d, which are schematics depicting an exemplary method for discovering the parameter Q, which denotes the relative size of two rectangles, in accordance with some embodiments of the present invention. Assume both rectangles have edges parallel to the x- and y-axis. Let both rectangles have one corner at junction of the horizontal and vertical asymptotes of the implicit curve of the novel invariant function (x=x_{asym}, y=y_{asym}). Then, let the first of the two rectangles have a corner at the convergence of the lines emanating from the x- and y-intercepts (x=xᵢₙₜ, y=yᵢₙₜ), and the other corners at the junctions of the lines emanating from both other points and converging at right angles. The second rectangle has one corner at the origin (x=0, y=0), and the other corners at the junctions of the lines emanating from both other points and converging at right angles, as depicted in FIGS. 7c-d. The quotient of the square root of the area of the one rectangle to the square root of the sum of the areas of both rectangles, or the quotient of the length of one rectangle to the sum of the lengths of both rectangles, or the quotient of the height of one rectangle to the sum of the heights of both rectangles, can be used to calculate Q. The parameters n, u and Q report the relative scaling of the transformation of the novel invariant function's implicit curve with respect to the constant product implicit curve, and vice versa.

The dimensions of the graphs in relevant Figures described herein hold no special significance and are chosen for the sake of demonstration; the disclosed function is effectively unbounded and can be applied to any plane or hyperplane, regardless of its size.

A vast expanse of additional rearrangements of the equations presented above can be generated from the geometric identities contained within the scope of embodiments described herein, and their implicit curves comprise a specific set of possible exchange processes. For all positive values of x and y, which may represent the balances of tokens in a smart contract, or any similar arrangement on a distributed ledger, the application of the invariant function provides a map of exchange rates, for example, that encompasses a novel DEX technology.

The overparameterization described herein enables the creation of subsets of new parameters that reference those defined above, from which specific forms of the invariant function can be explicitly derived. This concept is exemplified as follows with reference to specific examples, which represent a subset of a much larger collection of possible groupings of curve parameters and associated rearrangements of the general formula. Such flexibility allows for application-specific considerations to be addressed, including but not necessarily limited to: calculation accuracy in the absence of floating-point arithmetic, overflow and underflow, unsigned integers, computational complexity, storage and memory requirements, or other limitation imposed either directly or indirectly by the hardware or software on which the outputs of the function are determined. This aspect is technically significant and/or provides technical advantages, and is demonstrated with specific examples below.

The general theory can be understood heuristically. One set of implicit curves encompassed by embodiments described herein is comprised of those which can be selected with reference to a coordinate of the implicit curve of eqns. 1a-c, and some scaling factor. While the parameters n, u and Q are the natural expression of the scaling factor, it is possible to construct forms of the invariant function that feature none of these. For example, the invariant functions described by eqn. 15, 16a-c, and 17a-c are perfectly serviceable despite their lack of direct reference to n, u or Q, as demonstrated by their elaboration into the marginal exchange formulas (eqns. 16d-e and 17d-e), their swap formulas (eqns. 16f-g and 17f-g), and gross exchange rate formulas (eqns. 16h-i and 17h-i). Such a construction is possible because the three parameters (x₀, y₀, and either yᵢₙₜ or xᵢₙₜ) each contribute partial positional and scaling information with respect to each other.

$$\frac{( {x}_{int} - {x}_{0} )}{{x}_{0}} = \frac{( {y}_{int} - {y}_{0} )}{{y}_{0}} = \frac{( x - {x}_{0} ) ( {y}_{0} - y )}{{x}_{0} {y}_{0} - xy} \qquad eqn . 15$$

$$( {y}_{int} - {y}_{0} ) ( {x}_{0} {y}_{0} - xy ) = {y}_{0} ( x - {x}_{0} ) ( {y}_{0} - y ) \qquad eqn . 16 a$$

$$y = \frac{{y}_{0} ( {x}_{0} {y}_{int} - {xy}_{0} )}{{x}_{0} {y}_{0} - x ( 2 {y}_{0} - {y}_{int} )} \qquad eqn . 16 b$$

$$x = \frac{{x}_{0} {y}_{0} ( {y}_{int} - y )}{{y}_{0}^{2} - y ( 2 {y}_{0} - {y}_{int} )} \qquad eqn . 16 c$$

$$- \frac{dy}{dx} = \frac{{x}_{0} {y}_{0} ( {y}_{0}^{2} + {y}_{int} ( {y}_{int} + 2 {y}_{0} ) )}{{( x ( {y}_{int} - 2 {y}_{0} ) + {x}_{0} {y}_{0} )}^{2}} \qquad eqn . 16 d$$

$$- \frac{dy}{dx} = \frac{{( y ( {y}_{int} - 2 {y}_{0} ) + {y}_{0}^{2} )}^{2}}{{x}_{0} {{y}_{0} ( {y}_{int} - {y}_{0} )}^{2}} \qquad eqn . 16 e$$

$$- Δ y = \frac{Δ x {x}_{0} {{y}_{0} ( {y}_{int} - {y}_{0} )}^{2}}{( {xy}_{int} + {y}_{0} ( {x}_{0} - 2 x ) ) ( {xy}_{int} + {y}_{0} ( {x}_{0} - 2 x ) - Δ x ( 2 {y}_{0} - {y}_{int} ) )} \qquad eqn . 16 f$$

$$- Δ y = \frac{Δ {x ( y ( {y}_{int} - 2 {y}_{0} ) + {y}_{0}^{2} )}^{2}}{Δ x ( {y}_{int} - 2 {y}_{0} ) ( y ( {y}_{int} - 2 {y}_{0} ) - {y}_{0}^{2} ) + {x}_{0} {{y}_{0} ( {y}_{int} - {y}_{0} )}^{2}} \qquad eqn . 16 g$$

$$- \frac{Δ y}{Δ x} = \frac{{x}_{0} {{y}_{0} ( {y}_{int} - {y}_{0} )}^{2}}{( {xy}_{int} + {y}_{0} ( {x}_{0} - 2 x ) ) ( {xy}_{int} + {y}_{0} ( {x}_{0} - 2 x ) - Δ x ( 2 {y}_{0} - {y}_{int} ) )} \qquad eqn . 16 h$$

$$- \frac{Δ y}{Δ x} = \frac{{( y ( {y}_{int} - 2 {y}_{0} ) + {y}_{0}^{2} )}^{2}}{Δ x ( {y}_{int} - 2 {y}_{0} ) ( y ( {y}_{int} - 2 {y}_{0} ) - {y}_{0}^{2} ) + {x}_{0} {{y}_{0} ( {y}_{int} - {y}_{0} )}^{2}} \qquad eqn . 16 i$$

$$( {x}_{int} - {x}_{0} ) ( {x}_{0} {y}_{0} - xy ) = {x}_{0} ( x - {x}_{0} ) ( {y}_{0} - y ) \qquad eqn . 17 a$$

$$y = \frac{{x}_{0} {y}_{0} ( {x}_{int} - x )}{x ( {x}_{int} - 2 {x}_{0} ) + {x}_{0}^{2}} \qquad eqn . 17 b$$

$$x = \frac{{x}_{0} ( {x}_{int} {y}_{0} - {x}_{0} y )}{{x}_{0} {y}_{0} + y ( {x}_{int} - 2 {x}_{0} )} \qquad eqn . 17 c$$

$$- \frac{dy}{dx} = \frac{{x}_{0} {y}_{0} {( {x}_{int} - {x}_{0} )}^{2}}{{( x ( {x}_{int} - 2 {x}_{0} ) + {x}_{0}^{2} )}^{2}} \qquad eqn . 17 d$$

$$- \frac{dy}{dx} = \frac{{( {x}_{0} {y}_{0} + y ( {x}_{int} - 2 {x}_{0} ) )}^{2}}{{x}_{0} {y}_{0} {( {x}_{int} - {x}_{0} )}^{2}} \qquad eqn . 17 e$$

$$- Δ y = \frac{Δ {xx}_{0} {y}_{0} {( {x}_{int} - {x}_{0} )}^{2}}{( {x}_{0}^{2} + ( Δ x + x ) ( {x}_{int} - 2 {x}_{0} ) ) ( x ( {x}_{int} - 2 {x}_{0} ) + {x}_{0}^{2} )} \qquad eqn . 17 f$$

$$- Δ y = \frac{Δ x {( {x}_{0} {y}_{0} + y ( {x}_{int} - 2 {x}_{0} ) )}^{2}}{\begin{matrix}{x}_{0} {y}_{0} {( {x}_{int} - {x}_{0} )}^{2} - Δ x ( {x}_{int} - 2 {x}_{0} ) ( y ( {x}_{int} - 2 {x}_{0} ) - \\ {x}_{0} {y}_{0} )\end{matrix}} \qquad eqn . 17 g$$

$$- \frac{Δ y}{Δ x} = \frac{{x}_{0} {y}_{0} {( {x}_{int} - {x}_{0} )}^{2}}{( {x}_{0}^{2} + ( Δ x + x ) ( {x}_{int} - 2 {x}_{0} ) ) ( x ( {x}_{int} - 2 {x}_{0} ) + {x}_{0}^{2} )} \qquad eqn . 17 h$$

$$- \frac{Δ y}{Δ x} = \frac{{( {x}_{0} {y}_{0} + y ( {x}_{int} - 2 {x}_{0} ) )}^{2}}{\begin{matrix}{x}_{0} {y}_{0} ( {x}_{int} - {x}_{0} ) - Δ x ( {x}_{int} - 2 {x}_{0} ) ( y ( {x}_{int} - 2 {x}_{0} ) - \\ {x}_{0} {y}_{0} )\end{matrix}} \qquad eqn . 17 i$$

Therefore, it is possible to define new fundamental scaling constants from the algebraic and geometric identities described herein for the invariant function. This is an important advance from a technological perspective, as it allows for discrete forms of the general theory to be created to suit specific implementation constraints. For the two cases considered for the set resulting from the elaboration of eqn. 15, it is trivial to define the new scaling term, R, and demonstrate its congruence with the general theory (eqns. 18a-b). The explicit forms of this simplification are presented in eqns. 19a-i.

Invariant functions of this kind may be easily demonstrated as belonging to the same superset and are contained within the scope of embodiments described herein.

$$R = \frac{( {x}_{int} - {x}_{0} )}{{x}_{0}} = \frac{( {y}_{int} - {y}_{0} )}{{y}_{0}} \qquad eqn . 18 a$$

$$\frac{{( 1 - n )}^{2}}{{{n}^{2} ( 2 - n )}^{2}} = \frac{P}{{P}_{a} + {P}_{b} - 2 P} = \frac{Q}{{( 1 - Q )}^{2}} = \frac{{R}^{2}}{{( R - 1 )}^{2} {( R + 1 )}^{2}} \qquad eqn . 18 b$$

$$R ( {x}_{0} {y}_{0} - xy ) = ( x - {x}_{0} ) ( {y}_{0} - y ) \qquad eqn . 19 a$$

$$y = \frac{{y}_{0} ( {x}_{0} ( R + 1 ) - x )}{x ( R - 1 ) + {x}_{0}} \qquad eqn . 19 b$$

$$x = \frac{{x}_{0} ( {y}_{0} ( R + 1 ) - y )}{y ( R - 1 ) + {x}_{0}} \qquad eqn . 19 c$$

$$- \frac{dy}{dx} = \frac{{R}^{2} {x}_{0} {y}_{0}}{{( x ( R - 1 ) + {x}_{0} )}^{2}} \qquad eqn . 19 d$$

$$- \frac{dy}{dx} = \frac{{( y ( R - 1 ) + {y}_{0} )}^{2}}{{R}^{2} {x}_{0} {y}_{0}} \qquad eqn . 19 e$$

$$- Δ y = \frac{Δ {xR}^{2} {x}_{0} {y}_{0}}{( {x}_{0} + ( Δ x + x ) ( R - 1 ) ) ( x ( R - 1 ) + {x}_{0} )} \qquad eqn . 19 f$$

$$- Δ y = \frac{Δ x {( y ( R - 1 ) + {y}_{0} )}^{2}}{Δ x ( R - 1 ) ( y ( R - 1 ) + {y}_{0} ) + {R}^{2} {x}_{0} {y}_{0}} \qquad eqn . 19 g$$

$$- \frac{Δ y}{Δ x} = \frac{{R}^{2} {x}_{0} {y}_{0}}{( {x}_{0} + ( Δ x + x ) ( R - 1 ) ) ( x ( R - 1 ) + {x}_{0} )} \qquad eqn . 19 h$$

$$- \frac{Δ y}{Δ x} = \frac{{( y ( R - 1 ) + {y}_{0} )}^{2}}{Δ x ( R - 1 ) ( y ( R - 1 ) + {y}_{0} ) + {R}^{2} {x}_{0} {y}_{0}} \qquad eqn . 19 i$$

Trivial combinations of the parameters described herein are also within the scope of embodiments described herein. For example, in some embodiments, let the parameter S be defined as the difference between the square roots of the gradients at the y- and x-intercepts, which through algebraic manipulation is shown to have equivalence with other fundamental parameters P, Q, and n (eqn. 20a-b). Then, redefinition of P_{b} as B² (eqns. 20c) allows for the construction of a new equation set (eqns. 21a-i).

$$S = \sqrt{{P}_{a}} - \sqrt{{P}_{b}} = \sqrt{\frac{P}{Q}} ( 1 - Q ) = \frac{\sqrt{P} n ( 2 - n )}{1 - n} \qquad eqn . 20 a$$

$$\frac{{( 1 - n )}^{2}}{{{n}^{2} ( 2 - n )}^{2}} = \frac{P}{{P}_{a} + {P}_{b} - 2 P} = \frac{Q}{{( 1 - Q )}^{2}} = \frac{{R}^{2}}{{( R - 1 )}^{2} {( R + 1 )}^{2}} = \frac{P}{{S}^{2}} \qquad eqn . 20 b$$

$${B}^{2} = {P}_{b} \qquad eqn . 20 c$$

$$y ( x ( BR + {R}^{2} ) + {y}_{int} ) = {y}_{int} ( {y}_{int} - x ( BR + {B}^{2} ) ) \qquad eqn . 21 a$$

$$y = \frac{{y}_{int} ( {y}_{int} - Bx ( B + S ) )}{x ( BS + {S}^{2} ) + {y}_{int}} \qquad eqn . 21 b$$

$$x = \frac{{y}_{int} ( {y}_{int} - y )}{( B + S ) ( {By}_{int} + Sy )} \qquad eqn . 21 c$$

$$- \frac{dy}{dx} = \frac{{y}_{int}^{2} {( B + S )}^{2}}{{( x ( BS + {S}^{2} ) + {y}_{int} )}^{2}} \qquad eqn . 21 d$$

$$- \frac{dy}{dx} = \frac{{( {By}_{int} + Sy )}^{2}}{{y}_{int}^{2}} \qquad eqn . 21 e$$

$$- Δ y = \frac{Δ {{xy}_{int}^{2} ( B + S )}^{2}}{( x ( BS + {S}^{2} ) + {y}_{int} ) ( S ( B + S ) ( Δ x + x ) + {y}_{int} )} \qquad eqn . 21 f$$

$$- Δ y = \frac{Δ {x ( {By}_{int} + Sy )}^{2}}{S Δ x ( {By}_{int} + Sy ) + {y}_{int}^{2}} \qquad eqn . 21 g$$

$$- \frac{Δ y}{Δ x} = \frac{{y}_{int}^{2} {( B + S )}^{2}}{( x ( BS + {S}^{2} ) + {y}_{int} ) ( S ( B + S ) ( Δ x + x ) + {y}_{int} )} \qquad eqn . 21 h$$

$$- \frac{Δ y}{Δ x} = \frac{{y}_{int}^{2} {( {By}_{int} + Sy )}^{2}}{Δ x ( {BSy}_{int} + {S}^{2} y ) + {y}_{int}^{2}} \qquad eqn . 21 i$$

This set is included to emphasize the brevity and computational tractability of its forms, especially its swap formula, eqn. 21g, and its marginal price formula eqn. 21e, which showcases the technical advantages afforded by the overparameterization described herein and/or specific algebraic, and/or geometric elaboration of the general theory. This set is adopted to illustrate another aspect described herein, referred to as, asymmetric liquidity pools.

The examples provided hitherto are for a discrete case where fundamental parameters of the invariant function are assumed to be fixed values, which is not a necessary requirement. Any function parameter may also be functions of internal variables including but not necessarily limited to the x- or y-coordinates, and/or any combination of the x- and y-coordinates and/or other parameters, and/or functions of external variables including but not necessarily limited to data delivered by another smart contract, application programmable interface (API), and/or a system or network of oracles.

Reference is now made back to FIGS. 8a-c, which are schematics in which eqn. 22 substitutes n for f(x), in accordance with some embodiments of the present invention. The invariant function maintains a point on its graph with coordinates (x₀, y₀) coincident with the implicit curve of eqn. 1, and the slope of the tangent line at this point is equal in both, as depicted with reference to FIGS. 8a-c.

$$n = cos ( \frac{π x}{200} ) + 1 \qquad eqn . 22$$

Reference is now made to back FIGS. 9a-c, which are schematics in which eqns. 23a-c substitute n for f(a, x, x₀, y, y₀), in accordance with some embodiments of the present invention. Consistent with its definition, and as has been observed for examples examined herein, the novel function maintains a point on its graph with coordinates x=x₀, y=y₀ coincident with the graph of eqn. 1, and where the slope at this point is equal to P in both graphs, as depicted in FIGS. 9a-c. Whereas the demonstration via eqn. 22 is included for no other reason than to demonstrate the scope of the invariant function disclosed herein, eqns. 23a-c have special significance. It is a unique variation, and close homologue of the “stableswap” function currently in use by several DeFi protocols. The a term of eqn. 23a determines the degree to which the function is flattened around the point x=x₀, y=y₀. Higher values of a extend the flattened region, and at a=0 the graph of the function is identical to that of eqn. 1.

$$n = \{ \begin{matrix}\frac{{x}_{0}^{3}}{{x}_{0}^{3} - ax ( x - 2 {x}_{0} )} & x \leq {x}_{0} ; y \geq {y}_{0} \\ \frac{{y}_{0}^{3}}{{y}_{0}^{3} - ay ( y - 2 {y}_{0} )} & x \geq {x}_{0} ; y \leq {y}_{0}\end{matrix} \qquad eqn . 23 a$$

$$y = \{ \frac{k ( {x}_{0} ( 2 - n ) - x ( 1 - n ) )}{{x}_{0} ( nx + {x}_{0} ( 1 - n ) )} x \leq {x}_{0} ; y \geq {y}_{0} \qquad eqn . 23 b$$

$$x = \{ \frac{{x}_{0} ( k ( 2 - n ) - {x}_{0} y ( 1 - n ) )}{k ( 1 - n ) + {nx}_{0} y} x \geq {x}_{0} ; y \leq {y}_{0} \qquad eqn . 23 c$$

Additional details related to the asymmetric liquidity pools are now described, where each bonding curve defines a unidirectional trade from a first cryptocurrency to a second cryptocurrency.

The application of the novel invariant function in the context of AMMs and DEXes is now elaborated. The fundamental purpose of a DEX is to exchange tokens according to a preset pricing process; the balances x and y are coordinates on the graph of the invariant function and represent all possible compositions of tokens and exchange rates. Therefore, an exchange may be represented as a secant line between two coordinates in the positive domain, that describe the balance of x and y at two points in time, before and after the exchange occurred. Typically, the numeraire asset is assigned the y-axis, and the risk asset is assigned the x-axis, and this convention will be observed herein.

In some embodiments, the customizable function described herein may be used to create a price range through which one user can programmatically exchange their tokens for another of their choosing in a decentralized marketplace. In the common vernacular, an AMM position whereby tokens are exchanged within predefined bounds of exchange rates is termed concentrated liquidity. In such a concentrated liquidity model, the graph of the invariant function in the positive domain necessarily intersects the x- and y-axis, and the slope of the graph at these intercepts defines the bounds of exchange rates. For any graph of the novel invariant function with asymptotes x_{asym}<0 and y_{asym}<0, the slope of the graph at x=0, (i.e. the y-intercept, yᵢₙₜ) defines the highest exchange rate of the risk asset relative to its numeraire, and the slope of the graph at y=0, (i.e. the x-intercept, xᵢₙₜ) defines the lowest exchange rate of the risk asset relative to its numeraire. For any graph of the novel invariant function where n, x_{asym} and y_{asym} are constant values, x_{asym}<0 and y_{asym}<0 if n<1.

The following discussion expands on the application of the invariant function under this pretense; however, this comprises a subset of a wider scope of possible utilizations of embodiments described herein. Let the slope of the graph of the customizable function at the y-intercept be −Pₐ and the slope at the slope of the graph of the novel function at the x-intercept be −P_{b}. As with any permutation of the invariant function, the slope at the point coincident with eqn. 1, (i.e. x=x₀, y=y₀) is defined as −P. In some embodiments, any three of the parameters Pₐ, P_{b}, yᵢₙₜ and xᵢₙₜ can be user-provided, where Pₐ and P_{b} are the user's chosen range of exchange rates, yᵢₙₜ represents the numeraire liquidity the user is committing to this same range, and xᵢₙₜ represents the sum total of the risk asset the user has announced their intention to obtain via exchange with said numeraire.

The following illustrations refer to eqns. 21a-i; however they should be considered as an example implementation. For completeness, eqns. 24a-l demonstrate how any parameter discussed thus far can be computed from the example user inputs, Pₐ, P_{b}, and yᵢₙₜ, although a subset, B, S, and yᵢₙₜ, are required for the remainder of this illustration.

$${x}_{int} = \frac{{y}_{int}}{\sqrt{{P}_{a} {P}_{b}}} \qquad eqn . 24 a$$

$$B = \sqrt{{P}_{b}} \qquad eqn . 24 b$$

$$P = \sqrt{{P}_{a} {P}_{b}} \qquad eqn . 24 c$$

$$Q = \sqrt{\frac{{P}_{b}}{{P}_{a}}} \qquad eqn . 24 d$$

$$R = \sqrt[4]{\frac{{P}_{a}}{{P}_{b}}} \qquad eqn . 24 e$$

$$S = \sqrt{{P}_{a}} - \sqrt{{P}_{b}} \qquad eqn . 24 f$$

$${y}_{asym} = \frac{\sqrt{{P}_{b}} {y}_{int}}{\sqrt{{P}_{b}} - \sqrt{{P}_{a}}} \qquad eqn . 24 g$$

$${x}_{asym} = \frac{\sqrt{{P}_{b}} {y}_{int}}{\sqrt{{P}_{a} {P}_{b}} ( \sqrt{{P}_{b}} - \sqrt{{P}_{a}} )} \qquad eqn . 24 h$$

$$k = \frac{{y}_{int}^{2} {( \sqrt[4]{{P}_{a}} - \sqrt[4]{{P}_{b}} )}^{2}}{\sqrt{{P}_{a}} {( \sqrt{{P}_{a}} - \sqrt{{P}_{b}} )}^{2}} \qquad eqn . 24 i$$

$${x}_{0} = \frac{{y}_{int} ( \sqrt[4]{{P}_{a} {P}_{b}} - \sqrt{{P}_{b}} )}{\sqrt{{P}_{a} {P}_{b}} ( \sqrt{{P}_{a}} - \sqrt{{P}_{b}} )} \qquad eqn . 24 j$$

$${y}_{0} = \frac{{y}_{int} ( \sqrt[4]{{P}_{a} {P}_{b}} - \sqrt{{P}_{b}} )}{\sqrt{{P}_{a}} - \sqrt{{P}_{b}}} \qquad eqn . 24 k$$

$$n = 1 - \sqrt[4]{\frac{{P}_{b}}{{P}_{a}}} \qquad eqn . 24 l$$

A user strategy includes two or more sets of token balances, including token balances of zero, and two or more instances of the invariant function described herein. For clarity of communication, the present discussion will be restricted to circumstances where a user has defined a strategy comprised of two tokens, and with two asymmetric bonding curves which determine their rate of exchange. However, embodiments described herein are not necessarily limited as such.

To illustrate the emergent behavior of a user's strategy as a function of two asymmetric liquidity pools, cryptocurrency tokens designated as USD_{TKN} and RSK_{TKN} are used as a generic case. USD_{TKN} is used a stand-in for a “stablecoin”, a cryptocurrency token that maintains an approximate 1:1 exchange value with the United States Dollar. The choice of a stable token was made for its intuitive properties which assist with the forthcoming explanations; however, embodiments described herein are not necessarily limited to such tokens to operate. Similarly, the fictional characters Alice is used as a generic placeholder for any user with whom the protocol is interacting.

Assume that RSK_{TKN} is currently trading at a value of $1.00, and therefore a precise 1:1 exchange value with TKN_{USD}. Alice is a blockchain user who owns 100 RSK_{TKN} and 5000 USD_{TKN} and has ambitions to improve her overall quantity of both tokens over time by trading them against each other in an open marketplace. In its most elemental articulation, Alice is seeking to obtain additional RSK_{TKN} when its exchange rate versus USD_{TKN} is low, and then exchange it back for USD_{TKN} when its exchange rate is high. Depending on her confidence, skills, knowledge, biases, predilections and other factors, Alice may have precise target rates of exchange with which she is comfortable replacing some quantity of USD_{TKN} with RSK_{TKN}, and vice versa. In a conventional AMM, Alice has limited agency to exercise this most fundamental of economic activities. The issue arises from the fact that traditional AMM systems are symmetrical in their ability to facilitate exchange; if USD_{TKN} is exchanged for some quantity of RSK_{TKN}, then the opposite exchange can also occur, regardless of Alice's pretension as a liquidity provider.

In at least some embodiments described herein, the exchange of USD_{TKN} for RSK_{TKN}, and RSK_{TKN} for USD_{TKN}, is prescribed by Alice, rather than the protocol. The exchange rate in each direction is determined by discrete instances of the invariant function, giving rise to a pair of bonding curves that allow for both tokens to be exchanged with participants in the marketplace at rates entirely independent of system state. In one aspect, Alice's liquidity position can represent a formal limit order, which in contrast to its counterpart in traditional finance, can be executed continuously over a premeditated range of exchange rates, as opposed to “all or nothing” given a single target rate at which the order executes. The tokens with which Alice is executing her strategy are automatically available on its companion curve, at a different exchange rate to that with which they were acquired. The expression of Alice's objective occurs without her intervention or active management and represents a substantive improvement over existing DEX technologies.

The characteristic behavior of Alice's liquidity position (aka her user strategy) in the context of at least some embodiments described herein is now explored with reference to the customizable invariant function described herein. First, consider the instance of the general formula where Alice is seeking to exchange her RSK_{TKN} for USD_{TKN} as its exchange rate moves towards Alice's targets. From the current market position of 1 USD_{TKN} per RSK_{TKN} (i.e. $1.00), Alice wishes to begin exchanging her RSK_{TKN} for USD_{TKN} starting at a rate of 1½ USD_{TKN} per RSK_{TKN}, up to a target of 3½ USD_{TKN} per RSK_{TKN}, for which she is willing to contribute 100 RSK_{TKN} to this range. By convention, let the y-axis of Alice's bonding curve for this half of her strategy be represented by the quantity of RSK_{TKN} she has remaining in said position. At the time she creates it, the first infinitesimal of RSK_{TKN} is available to the market at an exchange rate of 1½ USD_{TKN} per RSK_{TKN}. In some embodiments, the balance of RSK_{TKN} at the time the position is created may define the yᵢₙₜ parameter of the instance of the invariant function associated with Alice's strategy. Therefore, Pₐ, the negated gradient of the tangent line (−dy/dx) at yᵢₙₜ, defines the initial exchange rate. Since Pₐ represents a change in y relative to x, where y denotes a true quantity of RSK_{TKN}, then Pₐ is the reciprocal of Alice's chosen starting rate, assuming it was denominated in USD_{TKN} as in the present example. In other words, the first infinitesimal change in y with respect to x, concordant with Alice's mandate, is −dy/dx=1 RSK_{TKN}/1½ USD_{TKN}. Therefore Pₐ=⅔, as USD_{TKN} is worth ⅔ of RSK_{TKN} at the first instance of exchange against Alice's liquidity. Thus, two of Alice's required inputs are Pₐ=⅔ and yᵢₙₜ=100.

The final input for the first half of Alice's strategy, P_{b}, can be deduced via the same method as for Pₐ. The last infinitesimal amount of RSK_{TKN}, concordant with Alice's mandate, is to be exchanged at a rate of 3½ USD_{TKN} per RSK_{TKN}, as her bonding curve for this range comes to rest at x=xᵢₙₜ, y=0, thus fulfilling her order. Recall that P_{b} is the gradient of the tangent line at this exact point on the curve, and represents a change in y with respect to x. Therefore, its value is −dy/dx=1 RSK_{TKN}/3½ USD_{TKN}, or P_{b}= 2/7. With the third and final input in hand, Alice's bonding curve where RSK_{TKN} is exchanged with the external market for USD_{TKN} can be defined completely. From an implementation perspective, these three parameters are sufficient to define this half of the strategy; however, all previously discussed parameters have been calculated and are presented here for redundancy's sake, as presented in Table 2.

TABLE 2
The full parameter set describing one half of Alice's
strategy, whereby her RSK_{TKN} is exchanged
with the external market for USD_{TKN}.
RSK_{TKN} Curve Parameters and State

| Variable | Value |
|---|---|
| x | 0.0000000000000000 |
| y | 100.0000000000000000 |
| n | 0.1908932884297788 |
| u | 5.2385288567536827 |
| k | 4583.1375273971680144 |
| B | 0.5345224838248488 |
| P | 0.4364357804719848 |
| Q | 0.6546536707079772 |
| R | 1.2359309170224471 |
| S | 0.2819740971028772 |
| x₀ | 102.4757889447313914 |
| y₀ | 44.7241009275762309 |
| x_{asym} | −434.3465885608439976 |
| y_{asym} | −189.5643923738959984 |
| Pₐ | 0.6666666666666666 |
| P_{b} | 0.2857142857142857 |
| xᵢₙₜ | 229.1287847477919968 |
| yᵢₙₜ | 100.0000000000000000 |

For the second half of Alice's strategy, assume she is motivated to exchange her USD_{TKN} with the rest of the market for RSK_{TKN} as its exchange rate approaches a value where she believes there is an opportunity.

From the current market position of 1 USD_{TKN} per RSK_{TKN} (i.e. $1.00), Alice wishes to begin exchanging her USD_{TKN} for RSK_{TKN} starting at a rate of ⅔ USD_{TKN} per RSK_{TKN}, down to a target of ⅕ USD_{TKN} per RSK_{TKN}, for which she is willing to contribute 5000 USD_{TKN} to this range. The same convention applies to this bonding curve; let the y-axis of Alice's bonding curve for this half of her strategy be represented by the quantity of USD_{TKN} she has remaining in said position. Note that both bonding curves have the true liquidity on the y-axis; the x-axis in both cases is just a coordinate, and not a token balance. At the time she creates her strategy, the first infinitesimal of USD_{TKN} is available to the market at an exchange rate of 1 USD_{TKN} per RSK_{TKN}. As before, assume the balance of USD_{TKN} at the time the position is created defines the yᵢₙₜ parameter for the instance of the invariant function associated with this half of Alice's strategy. The Pₐ parameter of this half of the strategy, as was the case for the other curve, is the gradient of the tangent line at yᵢₙₜ, which defines the initial exchange rate in its cognate direction. Identical logic applies to the calculation of the curve parameters; however, note the flipped numeraire results in a more intuitive result in the case of USD_{TKN} half of the strategy; there is no need to take a reciprocal in this case. Since Pₐ represents a change in y relative to x, where y denotes a true quantity of USD_{TKN}, then Pₐ is Alice's chosen rate as-is. The first infinitesimal change in y with respect to x is −dy/dx=⅔ USD_{TKN}/1 RSK_{TKN}. Therefore Pₐ=⅔, as RSK_{TKN} is worth ⅔ of USD_{TKN} at the first instance of exchange against Alice's liquidity. Thus, two of Alice's required inputs are Pₐ=⅔ and yᵢₙₜ=5000. As an aside, it is worth acknowledging that both curves now have identical Pₐ values. However, their intrinsic meaning is reversed. In the first curve, Pₐ denotes the initial rate at which RSK_{TKN} is exchanged for USD_{TKN}; in the second curve, Pₐ denotes the initial rate at which USD_{TKN} is exchanged for RSK_{TKN}. In cash basis, Pₐ on the first curve give rise to an initial valuation of RSK_{TKN} $1.50, whereas on the second curve the same Pₐ value gives rise to an initial valuation of RSK_{TKN} of $0.66. In one embodiment, these and other impish nuances are hidden from the user through a front end interface, where inputs are collected in terms more aligned with their visceral understanding. The full description provided here should not be conflated with the user experience, but rather a detailed exploration of the application of the invariant function described previously.

The final input for the second half of Alice's strategy, P_{b}, can be deduced via the same method as for Pₐ. The last infinitesimal amount of USD_{TKN} is to be exchanged at a rate of ⅕ USD_{TKN} per RSK_{TKN}. Therefore, the P_{b} value is −dy/dx=⅕ USD_{TKN}/1 RSK_{TKN}, and P_{b}=⅕. It is also worth observing that Pₐ→P_{b} on both curves, which is expected, but not necessarily a requirement. This concludes the collection of the user inputs and allows the second half of Alice's strategy to be defined, completing the creation of the strategy overall, as presented in Table 3.

TABLE 3
The full parameter set describing one half of
Alice's strategy, whereby her USD_{TKN} is
exchanged with the external market for RSK_{TKN}.
USD_{TKN} Curve Parameters and State

| Variable | Value |
|---|---|
| x | 0.0000000000000000 |
| y | 5000.0000000000000000 |
| n | 0.2599171955077147 |
| u | 3.8473791549136593 |
| k | 12384869.5652039740234613 |
| B | 0.4472135954999579 |
| P | 0.3651483716701107 |
| Q | 0.5477225575051661 |
| R | 1.3512001548070345 |
| S | 0.3692829854277681 |
| x₀ | 5823.8614477945020553 |
| y₀ | 2126.5735244944962687 |
| x_{asym} | −16582.7416875553499267 |
| y_{asym} | −6055.1611250369005575 |
| Pₐ | 0.6666666666666666 |
| P_{b} | 0.2000000000000000 |
| xᵢₙₜ | 13693.0639376291528606 |
| yᵢₙₜ | 5000.0000000000000000 |

Depending on the environment, any subset or the complete set of values in Tables 2 and 3 can be stored in a smart contract. In some embodiments, a frugal deployment makes use of (optionally only) three parameters and a single x or y coordinate. For the example described here, and with reference to eqns. 21a-i, assume that (optionally only) yᵢₙₜ, B, S, and the y-coordinate are used. Note that these choices reflect modest computational burden compared with the other parameters (eqns. 24a-l). Moreover, after the initial calculations of B and S during the creation of the strategy, which can be performed with the assistance of off-chain resources, all on-chain calculations performed during swaps use (optionally only) the fundamental math operations addition, subtraction, multiplication, and division. This is true of equations described herein relating to the computation of marginal exchange rates and swaps, thus precluding the need for Taylor series and/or other polynomial approximations, and/or numeric methods of producing a function output. The freedom of choice to select appropriate parameters, and/or customized equation sets to fit the virtual machine on which the decentralized application is running addresses the technical problem of reducing use of computation resources for executing the smart contract.

Alice's strategy is now represented by two discrete bonding curves. In one embodiment, and in contrast to the conventional interpretation, (optionally only) only the y-axis of these curves has any intrinsic meaning; i.e., the x-axis does not denote a balance of tokens of any kind, virtual or otherwise. At the highest level of abstraction, the x-coordinate is a remnant of taking the antiderivative of Alice's desired exchange rate profile as a function of her true token balance, represented by y, implicit in the swap equations (eqn. 21e). The projection onto the x-axis gives rise to an additional dimension and creates the familiar looking bonding curve, but for the remaining demonstrations it should be stressed that the x-axis is effectively meaningless. It is noted that Alice has provided nonzero quantities of both USD_{TKN} and RSK_{TKN} tokens in the present example and has active nonzero balances in both tokens at this stage in the illustration, and yet the x-coordinate on both curves is nil. It is noted that other equations described herein, including marginal exchange and effective exchange rates, and the swap equations themselves, make no reference to the x-coordinate. However, this is not a requirement, but rather a nuance of some embodiments as it is being described in the present context. In other embodiments, both axes may represent actual or virtual balances. Regardless, the familiarity of treating both axes as representing real token balances in a smart contract associated with a user's position has heuristic value, and despite its implicit irrelevance, still benefits the communication of more important concepts. As a compromise, the x-axis will be named only as x in the forthcoming figures.

Reference is now made back to FIG. 10, which is a schematic depicting a state before any exchanges are performed, of Alice's pristine strategy, in accordance with some embodiments of the present invention. The top and bottom sets of curves are identical, but the axes have been rescaled in the latter from its square arrangement to allow for more prudent observation of changes to their structure during exchange. During the following discussion, changes in scale are necessary to make clear how each side of the strategy evolves under an asymmetric liquidity paradigm. At this stage in the discussion, the most important features of the curves are their intercepts and the y-coordinates. In the absence of any activity, both y-coordinates are at their starting points, their yᵢₙₜ values, respectively. The x-intercepts are not incidental; these represent the number of tokens that will be acquired should the liquidity on the y-axis be completely depleted. The overall rate of exchange of the whole position-meaning the entire y-balance for its target, is equal to the geometric mean of the curve, which is the parameter P.

Assume the market rate of RSK_{TKN} declines with respect to USD_{TKN} as Alice predicted, and market participants begin to interact with her strategy. Since Alice has an active strategy in USD_{TKN}, this is the liquidity source that supports market activity; her RSK_{TKN} component is simply not attractive while quoting an exchange rate above that which the market is actively trading. To simplify this part of the discussion, the examples simulate a single bulk trade and sudden, violent changes in the accepted market rate; however, this obfuscates the time dimension, where many different actors may have interacted with Alice's strategy.

During a downturn in the market appraisal of RSK_{TKN}, assume its exchange rate versus USD_{TKN} arrives at 12/19, or $0.63, which is inside of Alice's target. During this time, through arbitrage and other mechanisms, it can be assumed Alice's USD_{TKN} liquidity will deplete to such a point where the exchange rate quoted by her bonding curve largely agrees with the rest of the market. To simulate this condition, the precise y-coordinate on the USD_{TKN} curve can be computed from the marginal rate (eqn 21e). The x-coordinate can also be computed and is used in the following figures to indicate the overall progress towards fulfilling the order in its entirety. For the USD_{TKN} curve, the (optionally only) change that is apparent is the shift in the y-coordinate, as presented in Table 4.

TABLE 4
The full parameter set describing one half of Alice's strategy, whereby her USD_{TKN} is
exchanged with the external market for RSK_{TKN}. The numbers on the left side are those the
position was commenced with at a time when the market appraisal of USD_{TKN} to RSK_{TKN} was at
unity; the values on the right side represent the state of the strategy after a market downturn in
the exchange rate of RSK_{TKN} to USD_{TKN} to 12/19 ($0.63). The (optionally only) changed value
is that corresponding to the y-coordinate, and by extension, also the x-coordinate.
USD_{TKN} Curve Parameters and State

| Variable | Value | |
|---|---|---|
| x | 0.0000000000000000 | 454.4058235085825004 |
| y | 5000.0000000000000000 | 4705.1425661613729972 |
| n | 0.2599171955077147 | 0.2599171955077147 |
| u | 3.8473791549136593 | 3.8473791549136593 |
| k | 12384869.5652039740234613 | 12384869.5652039740234613 |
| B | 0.4472135954999579 | 0.4472135954999579 |
| P | 0.3651483716701107 | 0.3651483716701107 |
| Q | 0.5477225575051661 | 0.5477225575051661 |
| R | 1.3512001548070345 | 1.3512001548070345 |
| S | 0.3692829854277681 | 0.3692829854277681 |
| x₀ | 5823.8614477945020553 | 5823.8614477945020553 |
| y₀ | 2126.5735244944962687 | 2126.5735244944962687 |
| x_{asym} | −16582.7416875553499267 | −16582.7416875553499267 |
| y_{asym} | −6055.1611250369005575 | −6055.1611250369005575 |
| Pₐ | 0.6666666666666666 | 0.6666666666666666 |
| P_{b} | 0.2000000000000000 | 0.2000000000000000 |
| xᵢₙₜ | 13693.0639376291528606 | 13693.0639376291528606 |
| yᵢₙₜ | 5000.0000000000000000 | 5000.0000000000000000 |

Inspection of the results above reveal an overall Δx of 454.4058, representing a gain of RSK_{TKN} to Alice's strategy, and −Δy of 294.8574, corresponding to a loss of USD_{TKN} from Alice's strategy, culminating in a cost base average of approximately $0.64 per RSK_{TKN} acquired. Before examining the effect of the acquired RSK_{TKN} on the state of Alice's strategy, it is noted that this exchange is permanent. In standard AMMs, if market sentiment recovered after a sudden drawdown, Alice's liquidity position would rebalance, and thus the opportunity afforded to her by acquiring her target tokens at an attractive rate is rescinded (unless she is fast and attentive enough to respond appropriately). This is a significant change from the status quo. Alice's USD_{TKN} curve (optionally only) performs exchange in its forwards direction and not in the reverse direction. Thus, the fate of the acquired RSK_{TKN} provokes a justified curiosity.

The RSK_{TKN} is absorbed by the strategy on its dedicated liquidity curve. More importantly, it is added to its y-axis. Since the balance of RSK_{TKN} was already at parity with its y-intercept, the y-intercept is moved to accommodate the newfound liquidity. The parametrization of the novel invariant function comprising the first half of the present disclosure is such that the yᵢₙₜ value can be used as a type of container size; it can be moved without affecting the user's chosen exchange profile. In more explicit terms, the gradients at the x- and y-intercepts can remain constant, thus allowing the RSK_{TKN} acquired at a low exchange rate to accumulate at the same price interval defined when the strategy was created. In the implementation considered for the present discussion, this effect can be achieved while (optionally only) updating a single variable, the yᵢₙₜ value, and therefore represents no significant computational overhead. Depending on the environment, if it is economical to maintain a dictionary of all parameters describing the pair of liquidity curves comprising Alice's strategy then such dictionary may be implemented. The results of Alice's accumulation of RSK_{TKN} in this example is summarized in Table 5. In contrast to the situation for the USD_{TKN} curve, significant changes are apparent, particularly with respect to the natural scaling parameters, whereas the curvature parameters have remained unchanged.

TABLE 5
The full parameter set describing one half of Alice's strategy, whereby her RSK_{TKN} is
exchanged with the external market for USD_{TKN}. The numbers on the left side are those the
position was commenced with at a time when the market appraisal of USD_{TKN} to RSK_{TKN} was at
unity; the values on the right side represent the state of the strategy after a market downturn in
the exchange rate of RSK_{TKN} to USD_{TKN} to 12/19 ($0.63). The interval of exchange rates has not
been affected, but (optionally only) the relative size of this side of Alice's strategy.
RSK_{TKN} Curve Parameters and State

| Variable | Value | |
|---|---|---|
| x | 0.0000000000000000 | 0.0000000000000000 |
| y | 100.0000000000000000 | 554.4058235085825572 |
| n | 0.1908932884297788 | 0.1908932884297788 |
| u | 5.2385288567536827 | 5.2385288567536827 |
| k | 4583.1375273971680144 | 140869.9811174481583294 |
| B | 0.5345224838248488 | 0.5345224838248488 |
| P | 0.4364357804719848 | 0.4364357804719848 |
| Q | 0.6546536707079772 | 0.6546536707079772 |
| R | 1.2359309170224471 | 1.2359309170224471 |
| S | 0.2819740971028772 | 0.2819740971028772 |
| x₀ | 102.4757889447313914 | 568.1317415959550772 |
| y₀ | 44.7241009275762309 | 247.9530200543385945 |
| x_{asym} | −434.3465885608439976 | −2408.0427811921817920 |
| y_{asym} | −189.5643923738959984 | −1050.9560306195387511 |
| Pₐ | 0.6666666666666666 | 0.6666666666666666 |
| P_{b} | 0.2857142857142857 | 0.2857142857142857 |
| xᵢₙₜ | 229.1287847477919968 | 1270.3033259762037233 |
| yᵢₙₜ | 100.0000000000000000 | 554.4058235085825572 |

Reference is now made back to FIG. 11, which is a schematic depicting the difference in the relative changes to either half of Alice's strategy, in accordance with some embodiments of the present invention. As seen in FIG. 11, the difference is dramatic. The reason for this is that Alice's strategy is very top-heavy, culminating in what is often referred to as a “buy wall” on conventional order books. However, unlike a conventional orderbook, the tokens received through passive interaction with the outside market via one bonding curve are immediately and automatically added to its counterpart. Thus, a fully automated system for precise execution of premediated trading strategies is realized.

As the exchange rate of RSK_{TKN} continues to fall against USD_{TKN}, Alice's strategy will continue to part with its USD_{TKN} in return for RSK_{TKN}. Assume the downturn continues to the point where the exchange rate of RSK_{TKN} approaches 9/25, or $0.36, which remains inside of Alice's target range. The effects of the changing market can be easily modelled by assuming the y-coordinate of the USD_{TKN} side of her position comes to rest at the point where the gradient of its tangent line is precisely − 9/25. This point can be computed from either the x- or y-coordinate via any of the marginal rate equations presented herein. As before, the USD_{TKN} curve changes (optionally only) with respect to the y-coordinate, which drags the x-coordinate behind it. The simulated drawdown is considerably more severe than what was considered in the previous example, consuming a more significant fraction of Alice's active limit order, as presented in Table 6.

The tremendous change in scale resulting from the accumulation of additional RSK_{TKN} by its cognate curve, is noted. This is trivial to achieve, as the parameter k has the same intrinsic meaning as in eqns. 1a-c. Comparing \sqrt{k} for the RSK_{TKN} curve from the instant of its creation up to the present moment reveals a 5.5×, followed by an 11.0× increase, culminating in an overall 60.8× increase in relative terms. Arbitrary changes in size are trivial, and do not give rise to performance or accuracy problems in the specific parametrization considered in this hypothetical. In part, this resiliency is owed to the fact that when a curve is expanding to accommodate additional liquidity, it can (optionally only) do so such that y=yᵢₙₜ, precisely. Infinite relative growth in the value of k can also be achieved by allowing users to commence strategies containing (optionally only) a single token balance, and therefore featuring an empty curve at its creation. Strategies created with an empty curve (i.e. y=yᵢₙₜ=0) must still contain information about the exchange interval, Pₐ and P_{b}. Empty curves can begin to fill via the use of its companion's liquidity, in a manner identical to that demonstrated by Alice's RSK_{TKN} curve. Moreover, users may wish to adjust the token balances on their strategies over time, including completely emptying one or both curves. None of these considerations present a problem for the embodiment of the invention presently under examination. The results of Alice's accumulation of RSK_{TKN} in this example is summarized in Table 7.

Reference is now made back to FIG. 12, which is a schematic depicting the difference in the relative changes to either half of Alice's strategy, in accordance with some embodiments of the present invention.

TABLE 6
The full parameter set describing one half of Alice's strategy, whereby her USD_{TKN} is
exchanged with the external market for RSK_{TKN}. The values on the left side represent the state of
the strategy after a market downturn in the exchange rate of RSK_{TKN} to USD_{TKN} to 12/19 ($0.63);
the values on the right side represent the state of the strategy after a market downturn in the
exchange rate of RSK_{TKN} to USD_{TKN} to 9/25 ($0.36).
USD_{TKN} Curve Parameters and State

| Variable | Value | |
|---|---|---|
| x | 454.4058235085825004 | 5983.5114629390054688 |
| y | 4705.1425661613729972 | 2068.6900091410675486 |
| n | 0.2599171955077147 | 0.2599171955077147 |
| u | 3.8473791549136593 | 3.8473791549136593 |
| k | 12384869.5652039740234613 | 12384869.5652039740234613 |
| B | 0.4472135954999579 | 0.4472135954999579 |
| P | 0.3651483716701107 | 0.3651483716701107 |
| Q | 0.5477225575051661 | 0.5477225575051661 |
| R | 1.3512001548070345 | 1.3512001548070345 |
| S | 0.3692829854277681 | 0.3692829854277681 |
| x₀ | 5823.8614477945020553 | 5823.8614477945020553 |
| y₀ | 2126.5735244944962687 | 2126.5735244944962687 |
| x_{asym} | −16582.7416875553499267 | −16582.7416875553499267 |
| y_{asym} | −6055.1611250369005575 | −6055.1611250369005575 |
| Pₐ | 0.6666666666666666 | 0.6666666666666666 |
| P_{b} | 0.2000000000000000 | 0.2000000000000000 |
| xᵢₙₜ | 13693.0639376291528606 | 13693.0639376291528606 |
| yᵢₙₜ | 5000.0000000000000000 | 5000.0000000000000000 |

TABLE 7
The full parameter set describing one half of Alice's strategy, whereby her RSK_{TKN} is
exchanged with the external market for USD_{TKN}. The values on the left side represent the state of
the strategy after a market downturn in the exchange rate of RSK_{TKN} to USD_{TKN} to 12/19 ($0.63);
the values on the right side represent the state of the strategy after a market downturn in the
exchange rate of RSK_{TKN} to USD_{TKN} to 9/25 ($0.36).
RSK_{TKN} Curve Parameters and State

| Variable | Value | |
|---|---|---|
| x | 0.0000000000000000 | 0.0000000000000000 |
| y | 554.4058235085825572 | 6083.5114629390054688 |
| n | 0.1908932884297788 | 0.1908932884297788 |
| u | 5.2385288567536827 | 5.2385288567536827 |
| k | 140869.9811174481583294 | 16961784.8778238520026207 |
| B | 0.5345224838248488 | 0.5345224838248488 |
| P | 0.4364357804719848 | 0.4364357804719848 |
| Q | 0.6546536707079772 | 0.6546536707079772 |
| R | 1.2359309170224471 | 1.2359309170224471 |
| S | 0.2819740971028772 | 0.2819740971028772 |
| x₀ | 568.1317415959550772 | 6234.1263671899168912 |
| y₀ | 247.9530200543385945 | 2720.7958066255100675 |
| x_{asym} | −2408.0427811921817920 | −26423.5245039834626368 |
| y_{asym} | −1050.9560306195387511 | −11532.1715397166371986 |
| Pₐ | 0.6666666666666666 | 0.6666666666666666 |
| P_{b} | 0.2857142857142857 | 0.2857142857142857 |
| xᵢₙₜ | 1270.3033259762037233 | 13939.0758850247657392 |
| yᵢₙₜ | 554.4058235085825572 | 6083.5114629390054688 |

Continuing with the examination of the asymmetric liquidity pools, assume that the local bottom in the exchange rate of RSK_{TKN} to USD_{TKN} was 9/25 ($0.36), after which its appraisal begins to improve. After an arbitrary period, a market rally carries the valuation of RSK_{TKN} into Alice's target range. First, consider a moment in time where the exchange rate approached 1⅘ USD_{TKN} per RSK_{TKN}, or 5/9 RSK_{TKN} per USD_{TKN} (i.e. $1.80). The point on Alice's RSK_{TKN} curve corresponding to ⅖ can computed from the marginal rate (eqn 21e). For the first time in the present study, the RSK_{TKN} curve has experienced at least one interaction with market participants, who have exchanged their USD_{TKN} for Alice's RSK_{TKN}.

As anticipated, the y-coordinate (i.e. the true token balance) of Alice's RSK_{TKN} curve has diminished, as presented in Table 8; while USD_{TKN} has accumulated on its counterpart, as presented in Table 9. However, since Alice's USD_{TKN} curve has ample space to move its y-coordinate without exceeding yᵢₙₜ, no changes are made to its capacity parameters. Rather, the y-coordinate is simply moved to reflect the new USD_{TKN} liquidity balance, which has a subsequent effect on the quoted instantaneous exchange rate for the first available infinitesimal within the curve. This is expected behavior. The exchange rate can (optionally only) move within the bounds determined by Alice.

Reference is now made back to FIG. 13A, which is a schematic depicting accumulation of additional USD_{TKN} at the current price point that fills its cognate bonding curve from the bottom-up, slowly moving the reaccumulation target back towards the upper boundary, in accordance with some embodiments of the present invention.

TABLE 8
The full parameter set describing one half of Alice's strategy, whereby her RSK_{TKN} is
exchanged with the external market for USD_{TKN}. The values on the left side represent the state of
the strategy after a market downturn in the exchange rate of RSK_{TKN} to USD_{TKN} to 9/25 ($0.36);
the values on the right side represent the state of the strategy after a market rally in the
exchange rate of RSK_{TKN} to USD_{TKN} to 5/9 ($1.80).
RSK_{TKN} Curve Parameters and State

| Variable | Value | |
|---|---|---|
| x | 0.0000000000000000 | 2521.9963352610334368 |
| y | 6083.5114629390054688 | 4548.6733709747504690 |
| n | 0.1908932884297788 | 0.1908932884297788 |
| u | 5.2385288567536827 | 5.2385288567536827 |
| k | 16961784.8778238520026207 | 16961784.8778238520026207 |
| B | 0.5345224838248488 | 0.5345224838248488 |
| P | 0.4364357804719848 | 0.4364357804719848 |
| Q | 0.6546536707079772 | 0.6546536707079772 |
| R | 1.2359309170224471 | 1.2359309170224471 |
| S | 0.2819740971028772 | 0.2819740971028772 |
| x₀ | 6234.1263671899168912 | 6234.1263671899168912 |
| y₀ | 2720.7958066255100675 | 2720.7958066255100675 |
| x_{asym} | −26423.5245039834626368 | −26423.5245039834626368 |
| y_{asym} | −11532.1715397166371986 | −11532.1715397166371986 |
| Pₐ | 0.6666666666666666 | 0.6666666666666666 |
| P_{b} | 0.2857142857142857 | 0.2857142857142857 |
| xᵢₙₜ | 13939.0758850247657392 | 13939.0758850247657392 |
| yᵢₙₜ | 6083.5114629390054688 | 6083.5114629390054688 |

TABLE 9
The full parameter set describing one half of Alice's strategy, whereby her USD_{TKN} is
exchanged with the external market for RSK_{TKN}. The values on the left side represent the state of
the strategy after a market downturn in the exchange rate of RSK_{TKN} to USD_{TKN} to 9/25 ($0.36);
the values on the right side represent the state of the strategy after a market rally in the
exchange rate of RSK_{TKN} to USD_{TKN} to 5/9 ($1.80).
USD_{TKN} Curve Parameters and State

| Variable | Value | |
|---|---|---|
| x | 5983.5114629390054688 | 2446.5700425652537078 |
| y | 2068.6900091410675486 | 4590.6863444021009854 |
| n | 0.2599171955077147 | 0.2599171955077147 |
| u | 3.8473791549136593 | 3.8473791549136593 |
| k | 12384869.5652039740234613 | 12384869.5652039740234613 |
| B | 0.4472135954999579 | 0.4472135954999579 |
| P | 0.3651483716701107 | 0.3651483716701107 |
| Q | 0.5477225575051661 | 0.5477225575051661 |
| R | 1.3512001548070345 | 1.3512001548070345 |
| S | 0.3692829854277681 | 0.3692829854277681 |
| x₀ | 5823.8614477945020553 | 5823.8614477945020553 |
| y₀ | 2126.5735244944962687 | 2126.5735244944962687 |
| x_{asym} | −16582.7416875553499267 | −16582.7416875553499267 |
| y_{asym} | −6055.1611250369005575 | −6055.1611250369005575 |
| Pₐ | 0.6666666666666666 | 0.6666666666666666 |
| P_{b} | 0.2000000000000000 | 0.2000000000000000 |
| xᵢₙₜ | 13693.0639376291528606 | 13693.0639376291528606 |
| yᵢₙₜ | 5000.0000000000000000 | 5000.0000000000000000 |

Finally, assume that at its local high, RSK_{TKN} achieved an exchange rate of 2½ USD_{TKN} per RSK_{TKN}, or ⅖ RSK_{TKN} per USD_{TKN} (i.e. $2.50), before capitulating back to a point outside of (i.e. between) both of Alice's designated price ranges, thus marking the completion of a market cycle from her perspective. For ease of analysis, let the final exchange rate of RSK_{TKN} and USD_{TKN} be 1:1, thus having returned to the state whence this hypothetical began.

During the local top for RSK_{TKN}, the point on Alice's RSK_{TKN} curve corresponding to ⅖ can be computed as demonstrated previously. As per the routine, the y-coordinate (i.e., the true token balance) of Alice's RSK_{TKN} curve has further diminished due its valuation against USD_{TKN} climbing farther into her range, as presented in Table 10; while USD_{TKN} has accumulated on its counterpart curve, as presented in Table 11. Notably, this is the first case where Alice's balance of USD_{TKN} exceeds the yᵢₙₜ on its own curve; therefore, the capacity of the curve is increased to accommodate the new liquidity, as shown with reference to FIG. 13B.

TABLE 10
The full parameter set describing one half of Alice's strategy, whereby her RSK_{TKN} is
exchanged with the external market for USD_{TKN}. The values on the left side represent the state
of the strategy after a market rally in the exchange rate of RSK_{TKN} to USD_{TKN} to 5/9
($1.80); the values on the right side represent the state of the strategy after a market
rally in the exchange rate of RSK_{TKN} to USD_{TKN} to ⅖ ($2.50).
RSK_{TKN} Curve Parameters and State

| Variable | Value | |
|---|---|---|
| x | 2521.9963352610334368 | 7689.0989466937198813 |
| y | 4548.6733709747504690 | 2112.8778405542366272 |
| n | 0.1908932884297788 | 0.1908932884297788 |
| u | 5.2385288567536827 | 5.2385288567536827 |
| k | 16961784.8778238520026207 | 16961784.8778238520026207 |
| B | 0.5345224838248488 | 0.5345224838248488 |
| P | 0.4364357804719848 | 0.4364357804719848 |
| Q | 0.6546536707079772 | 0.6546536707079772 |
| R | 1.2359309170224471 | 1.2359309170224471 |
| S | 0.2819740971028772 | 0.2819740971028772 |
| x₀ | 6234.1263671899168912 | 6234.1263671899168912 |
| y₀ | 2720.7958066255100675 | 2720.7958066255100675 |
| x_{asym} | −26423.5245039834626368 | −26423.5245039834626368 |
| y_{asym} | −11532.1715397166371986 | −11532.1715397166371986 |
| Pₐ | 0.6666666666666666 | 0.6666666666666666 |
| P_{b} | 0.2857142857142857 | 0.2857142857142857 |
| xᵢₙₜ | 13939.0758850247657392 | 13939.0758850247657392 |
| yᵢₙₜ | 6083.5114629390054688 | 6083.5114629390054688 |

TABLE 11
The full parameter set describing one half of Alice's strategy, whereby her USD_{TKN} is
exchanged with the external market for RSK_{TKN}. The values on the left side represent
the state of the strategy after a market rally in the exchange rate of RSK_{TKN} to USD_{TKN}
to 5/9 ($1.80); the values on the right side represent the state of the strategy after a
market rally in the exchange rate of RSK_{TKN} to USD_{TKN} to ⅖ ($2.50).
USD_{TKN} Curve Parameters and State

| Variable | Value | |
|---|---|---|
| x | 2446.5700425652537078 | 0.0000000000000000 |
| y | 4590.6863444021009854 | 9757.7889558347887942 |
| n | 0.2599171955077147 | 0.2599171955077147 |
| u | 3.8473791549136593 | 3.8473791549136593 |
| k | 12384869.5652039740234613 | 47168739.4338251873850822 |
| B | 0.4472135954999579 | 0.4472135954999579 |
| P | 0.3651483716701107 | 0.3651483716701107 |
| Q | 0.5477225575051661 | 0.5477225575051661 |
| R | 1.3512001548070345 | 1.3512001548070345 |
| S | 0.3692829854277681 | 0.3692829854277681 |
| x₀ | 5823.8614477945020553 | 11365.6021831202397152 |
| y₀ | 2126.5735244944962687 | 4150.1311302166113819 |
| x_{asym} | −16582.7416875553499267 | −32362.1787392577498395 |
| y_{asym} | −6055.1611250369005575 | −11816.9968703370450385 |
| Pₐ | 0.6666666666666666 | 0.6666666666666666 |
| P_{b} | 0.2000000000000000 | 0.2000000000000000 |
| xᵢₙₜ | 13693.0639376291528606 | 26722.8056124274735339 |
| yᵢₙₜ | 5000.0000000000000000 | 9757.7889558347887942 |

Consider that Alice began with 100 RSK_{TKN} and 5000 USD_{TKN}, at a price point where both were stated to be worth precisely $1, totaling $5,100 in value. Despite the absence of fee earnings of any kind, and without interacting with her position at all after instantiating it, Alice has improved her holdings of RSK_{TKN} and USD_{TKN} to 2112.88 and 9757.79, respectively, totaling $11,870.67.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant smart contracts and cryptocurrencies will be developed and the scope of the terms smart contract and cryptocurrency is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A computing device for exchanging tokens by a distributed smart contract executing on a blockchain, comprising:
at least one hardware processor of a network connected server executing a code of the distributed smart contract executing on the blockchain, the code for:
managing a primary reserve of a plurality of tokens of a primary cryptocurrency;
obtaining, from a client terminal in communication with the network connected server, a plurality of values of a plurality of adjustable parameters that define a function for computing an exchange rate for converting between the primary cryptocurrency and a secondary cryptocurrency; and
in response to a transaction request for converting between the primary tokens and a secondary token of a secondary cryptocurrency, executing the transaction request using a bonding curve defined by the function with the plurality of values of the plurality of adjustable parameters,
wherein the bonding curve comprises a first bonding curve and further comprising a second bonding curve defined by the function, wherein the first bonding curve and the second bonding curve have common adjustable parameters with different values,
wherein the first bonding curve and the second bonding curve are asymmetrical for unidirectional trading, the first bonding curve for converting from the primary cryptocurrency to the secondary cryptocurrency at a first exchange rate and excludes conversion from the secondary cryptocurrency to the primary cryptocurrency, and the second bonding curve for converting from the secondary cryptocurrency to the primary cryptocurrency at a second exchange rate different than the first exchange rate and excludes conversion from the primary cryptocurrency to the secondary cryptocurrency.

2. The computing device of claim 1, wherein the primary reserve is managed without managing a secondary reserve of secondary tokens of the secondary cryptocurrency.

3. The computing device of claim 1, wherein the plurality of adjustable parameters are selected for meeting hardware and/or software resource requirements for execution of code of the distributed smart contract, and further comprising code for dynamically monitoring the execution of the code of the distributed smart contract, and dynamically adapting the plurality of adjustable parameters for meeting the hardware and/or software resource requirements.

4-6. (canceled)

7. The computing device of claim 1, wherein one of the x-axis and the y-axis represents a balances of the primary reserve, and the other axis is non-defined, and the function represents all possible exchange rates for converting between the primary token and the second token.

8. The computing device of claim 1, wherein the transaction request for exchange using the function with applied parameters is executed on blockchain using fundamental math operations selected from: addition, subtraction, multiplication, and division, and excludes all of: Taylor series, polynomial approximation, and numeric methods of producing a function output, wherein at least two of the plurality of adjustable parameters are computed off-blockchain.

9-10. (canceled)

11. The computer device of claim 1, wherein a first exchange rate for converting from the primary cryptocurrency to the secondary cryptocurrency is computed according to the first bonding curve, a second exchange rate for converting from the secondary cryptocurrency to the primary cryptocurrency is computed according to the second bonding curve, wherein the first bonding curve is different than the second bonding curve and the first exchange rate is different than the second exchange rate.

12. The computing device of claim 11, wherein the transaction comprises receiving secondary tokens, and automatically adding the secondary tokens to a secondary reserve according to the second bonding curve, and automatically withdrawing primary tokens from the primary reserve according to the first bonding curve.

13. The computing device of claim 11, wherein a transaction performed using the first bonding curve deterministically affects another transaction performed using the second bonding curve.

14. The computing device of claim 11, further comprising obtaining a strategy from the client terminal, the strategy defining the values of the parameters for the first bonding curve and the second bonding curve.

15. The computing device of claim 1, wherein the plurality of adjustable parameters include a base set of adjustable parameters, selected from the group comprising:
n,
Pₐ denoting a start value of a range of exchange rates for converting from the primary cryptocurrency to the secondary cryptocurrency,
P_{b} denoting an end value of a range of exchange rates for converting from the primary cryptocurrency to the secondary cryptocurrency,
P denoting a gradient at x=x₀, y=y₀ indicating a geometric mean price,
Q,
R,
S denoting a difference of square roots of the gradients of the intercepts,
yᵢₙₜ denoting a balance of the primary tokens where the marginal exchange rate is equal to Pₐ,
xᵢₙₜ denoting, when the range commences with y=yᵢₙₜ, a balance of secondary tokens that is obtainable if the balance of the primary tokens is driven to zero
x₀ denoting an x-coordinate at the geometric mean price,
y₀ denoting a y-coordinate at the geometric mean price,
x_{asym} denoting an x-asymptote or vertical asymptote,
y_{asym} denoting a y-asymptote or horizontal asymptote, and
geometric and/or algebraic reconstruction of the aforementioned,
wherein different values are assigned to a same set of the base parameters for different bonding curves implicitly defined by the function.

16. (canceled)

17. The computing device of claim 1, wherein a single distributed smart contract executing on the blockchain implements a different set of values for the adjustable parameters for a different instance of the function, and the single distributed contract implements each respective reserve of a certain token and a corresponding bonding curve defined by the function with the different set of values for the adjustable parameter defines a primitive for unidirectional exchange between an external token and the certain token of the respective reserve, wherein multiple primitives are linked to one another for defining unidirectional routes for token exchanges.

18. The computing device of claim 1, wherein the function is defined with reference to a hyperbola with asymptotes at x=0 and y=0 represented as xy=k wherein one of the x-axis and the y-axis represents a balances of the primary reserve, and the other axis is non-defined.

19. The computing device of claim 18, wherein the function includes at least one adjustable asymptote; and
the function is defined as a transformation of an xy=k hyperbola such that a graph of the transformed function shares at least one fixed point with the xy=k hyperbola at coordinates x=x₀ and y=y₀ which remain stationary with respect to the transformation; and
where a first derivative of the transformed function is equal to a first derivative of the xy=k hyperbola at the same coordinates.

20. (canceled)

21. The computing device of claim 1, wherein the bonding curve is defined as the implicit curve of the invariant function, which is used to enumerate a continuum of exchange rates between a primary cryptocurrency and a secondary cryptocurrency.

22. The computer device of claim 1, wherein each exchange rate of a plurality of exchange rates for converting between the primary cryptocurrency and the secondary cryptocurrency is represented as a secant line between two points of the function, wherein a first point represents the balance of the primary reserve before the exchange occurred, and a second point represents the balance of the primary reserve after the exchange occurred.

23. The computer device of claim 1, wherein each parameter is assigned to a set of a plurality of sets, each parameter of each set is mathematically related to other parameters within the set and each parameter is mathematically related between sets of other parameters, sufficient to unambiguously describe a unique invariant function-implicit curve pair.

24. The computing device of claim 1, wherein a marginal exchange rate for converting between the primary cryptocurrency and the secondary cryptocurrency is computed according to a first derivative of the bonding curve implicitly defined by the function with applied adjustable parameters.

25. A computing device for exchanging tokens by a distributed smart contract executing on a blockchain, comprising:
at least one hardware processor of a network connected server executing a code of the distributed smart contract executing on the blockchain, the code for:
managing a primary reserve of a plurality of primary tokens of a primary cryptocurrency and managing a secondary reserve of a plurality of secondary tokens of a secondary cryptocurrency;
obtaining a transaction request for converting between the primary token and a secondary token of a secondary cryptocurrency;
in response to the transaction request being for converting from the primary token to the secondary token, executing the transaction request using a first bonding curve implicitly defined by a function and a first set of a plurality of values of a plurality of adjustable parameters; and
in response to the transaction request being for converting from the secondary token to the primary token, executing the transaction request using a second bonding curve different from the first bonding curve, the second bonding curve implicitly defined by the function and a second set the plurality of values of adjustable parameters that is different from the first set,
wherein the first bonding curve and the second bonding curve are asymmetrical for unidirectional trading, the first bonding curve for converting from the primary cryptocurrency to the secondary cryptocurrency at a first exchange rate and excludes conversion from the secondary cryptocurrency to the primary cryptocurrency, and the second bonding curve for converting from the secondary cryptocurrency to the primary cryptocurrency at a second exchange rate different than the first exchange rate and excludes conversion from the primary cryptocurrency to the secondary cryptocurrency.

26. The computing device of claim 25, wherein the primary reserve and the secondary reserve are linked, wherein when the transaction request includes an amount of secondary tokens, an amount of primary tokens are obtained from the primary reserve according to the first bonding curves, and the secondary tokens are deposited into the secondary reserve according to the second bonding curve.

27. A method of exchanging tokens by a distributed smart contract executing on a blockchain, comprising:
managing a primary reserve of a plurality of tokens of a primary cryptocurrency;
obtaining, from a client terminal in communication with the network connected server, a plurality of values of a plurality of adjustable parameters that define a function for computing an exchange rate for converting between the primary cryptocurrency and a secondary cryptocurrency; and
in response to a transaction request for converting between the primary tokens and a secondary token of a secondary cryptocurrency, executing the transaction request using a bonding curve defined by the function with the plurality of values of the plurality of adjustable parameters,
wherein the bonding curve comprises a first bonding curve and further comprising a second bonding curve defined by the function, wherein the first bonding curve and the second bonding curve have common adjustable parameters with different values,
wherein the first bonding curve and the second bonding curve are asymmetrical for unidirectional trading, the first bonding curve for converting from the primary cryptocurrency to the secondary cryptocurrency at a first exchange rate and excludes conversion from the secondary cryptocurrency to the primary cryptocurrency, and the second bonding curve for converting from the secondary cryptocurrency to the primary cryptocurrency at a second exchange rate different than the first exchange rate and excludes conversion from the primary cryptocurrency to the secondary cryptocurrency.
